(19) United States
(12) Patent Application Publication
(10) Pub. No.: US 2025/0031116 A1
(43) Pub. Date: Jan. 23, 2025

(54) METHOD AND APPARATUS FOR L1 AND L2 TRIGGERED MOBILITY IN WIRELESS COMMUNICATION SYSTEM

(71) Applicant: SAMSUNG ELECTRONICS CO., LTD., Suwon-si (KR)

(72) Inventor: Donggun KIM, Staines (GB)

(21) Appl. No.: 18/777,213

(22) Filed: Jul. 18, 2024

(30) Foreign Application Priority Data
Jul. 18, 2023 (GB) 2310967.1
Jun. 14, 2024 (GB) 2408591.2

(51) Int. Cl. H04W 36/08; H04W 36/00

(52) U.S. Cl. CPC H04W 36/08; H04W 36/0069

(57) ABSTRACT

The disclosure relates to a 5G or 6G communication system for supporting a higher data transmission rate. Disclosed is a method of performing L1/L2 triggered mobility (LTM) in a user equipment (UE), communicatively coupled to a telecommunication network, wherein if the UE receives RRCReconfiguration containing LTM target cell information, RRCReconfigurationComplete is sent to a source cell, and upon receipt of a MAC control element (CE) from the source cell, the target cell information is applied, a handover is performed, and a further RRCReconfigurationComplete is generated and sent to the target cell upon completion of the handover.

### CROSS-REFERENCE TO RELATED APPLICATIONS

This application is based on and claims priority under 35 U.S.C. § 119 to United Kingdom Patent Application Nos. 2310967.1 and 2408591.2 filed on Jul. 18, 2023, and Jun. 14, 2024, in the United Kingdom Intellectual Property Office, the disclosure of which are incorporated by reference herein in their entirety.

### BACKGROUND

### 1. Field

This disclosure relates to layer 1(L1)/layer 2(L2) triggered mobility (LTM) in a wireless communication network. In particular the disclosure relates to radio resource control (RRC) configuration in relation to such mobility.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Recently, there are needs to enhance an LTM procedure with regard to development of the communication network.

This disclosure provides methods and apparatuses for LTM.

According to an embodiment of the disclosure, a method performed by a terminal is provided. The method comprises: receiving, from a base station, a radio resource control (RRC) reconfiguration message including a layer 1/layer2 triggered mobility (LTM) configuration information on an LTM candidate cell; transmitting, to the base station, a first RRC reconfiguration complete message based on the RRC reconfiguration message; receiving, from the base station, a cell switch command medium access control (MAC) control element (CE) for triggering a cell switch to the LTM candidate cell; and transmitting, to the base station, a second RRC reconfiguration complete message after the cell switch to the LTM candidate cell.

According to an embodiment of the disclosure, a method performed by a base station is provided. The method comprises: transmitting, to a terminal, a radio resource control (RRC) reconfiguration message including a layer 1/layer2 triggered mobility (LTM) configuration information on an LTM candidate cell; receiving, from the terminal, a first RRC reconfiguration complete message based on the RRC reconfiguration message; transmitting, to the terminal, a cell switch command medium access control (MAC) control element (CE) for triggering a cell switch to the LTM candidate cell; and receiving, from the terminal, a second RRC reconfiguration complete message after the cell switch to the LTM candidate cell.

According to an embodiment of the disclosure, a terminal is provided. The terminal comprises: a transceiver; and a controller coupled with the transceiver and configured to: receive, from a base station, a radio resource control (RRC) reconfiguration message including a layer 1/layer2 triggered mobility (LTM) configuration information on an LTM candidate cell, transmit, to the base station, a first RRC reconfiguration complete message based on the RRC reconfiguration message, receive, from the base station, a cell switch command medium access control (MAC) control element (CE) for triggering a cell switch to the LTM candidate cell, and transmit, to the base station, a second RRC reconfiguration complete message after the cell switch to the LTM candidate cell.

According to an embodiment of the disclosure, a base station is provided. The base station comprises: a transceiver; and a controller coupled with the transceiver and configured to: transmit, to a terminal, a radio resource control (RRC) reconfiguration message including a layer 1/layer2 triggered mobility (LTM) configuration information on an LTM candidate cell, receive, from the terminal, a first RRC reconfiguration complete message based on the RRC reconfiguration message, transmit, to the terminal, a cell switch command medium access control (MAC) control element (CE) for triggering a cell switch to the LTM candidate cell, and receive, from the terminal, a second RRC reconfiguration complete message after the cell switch to the LTM candidate cell.

According to various embodiments of the disclosure, LTM procedure can be efficiently enhanced.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a better understanding of the disclosure, and to show how embodiments of the same may be carried into effect, reference will now be made, by way of example only, to the accompanying diagrammatic drawings in which:

FIG. 1 illustrates an example of a signalling procedure for LTM according to various embodiments of the present disclosure;

FIG. 2 illustrates an example of a UE state machine showing state transitions in NR according to various embodiments of the present disclosure;

FIG. 3 illustrates an example of the structure of an LTE system according to various embodiments of the present disclosure;

FIG. 4 illustrates an example of a radio protocol structure in an LTE system according to various embodiments of the present disclosure;

FIG. 5 illustrates an example of the structure of a next generation system according to various embodiments of the present disclosure;

FIG. 6 illustrates an example of a radio protocol structure of a next-generation mobile communication system according to various embodiments of the present disclosure;

FIG. 7 illustrates an example of an RRC a successful reconfiguration according to various embodiments of the present disclosure;

FIG. 8 illustrates an example of an RRC reconfiguration failure according to various embodiments of the present disclosure;

FIG. 9 illustrates an example of SCell activation/deactivation MAC CE of one octet according to various embodiments of the present disclosure;

FIG. 10 illustrates an example of SCell activation/deactivation MAC CE of four octets according to various embodiments of the present disclosure;

FIG. 11 illustrates an example of enhanced SCell activation/deactivation MAC CE with one octet Cᵢ field according to various embodiments of the present disclosure;

FIG. 12 illustrates an example of enhanced SCell activation/deactivation MAC CE with four octet Cᵢ field according to various embodiments of the present disclosure;

FIG. 13 illustrates an example of an example of a DL MAC PDU according to various embodiments of the present disclosure;

FIG. 14 illustrates an example of an example of a UL MAC PDU according to various embodiments of the present disclosure;

FIG. 15 illustrates an example of a flowchart of a method according to various embodiments of the present disclosure;

FIG. 16 illustrates a structure of a terminal according to various embodiments of the present disclosure; and

FIG. 17 illustrates a structure of a terminal according to various embodiments of the present disclosure.

### DETAILED DESCRIPTION

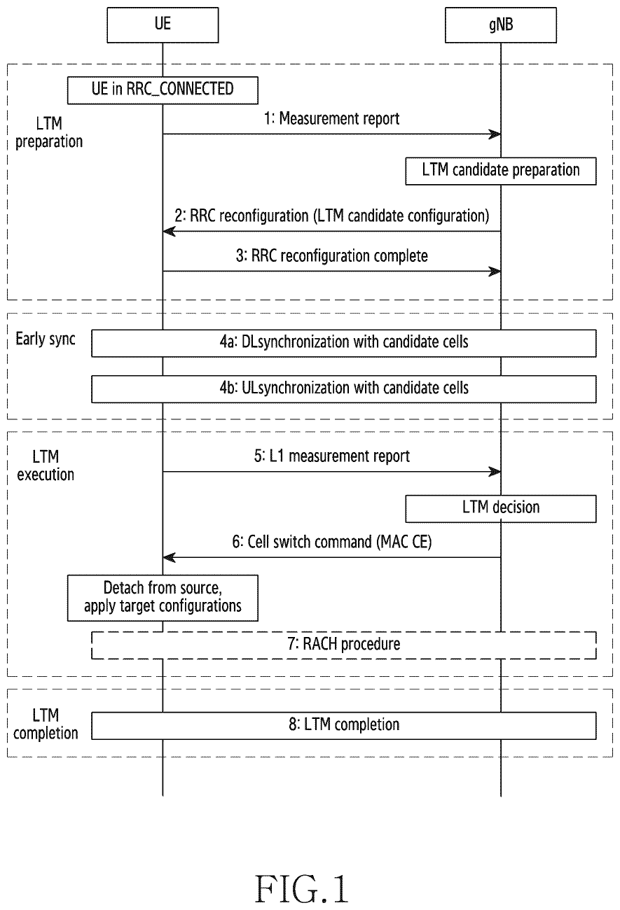

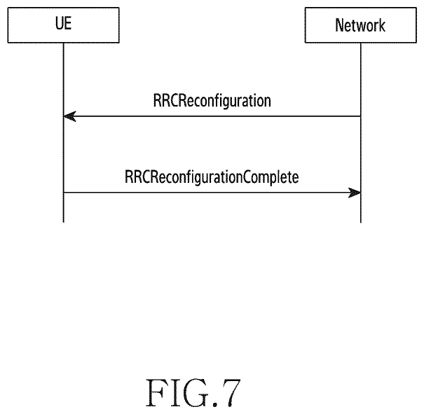

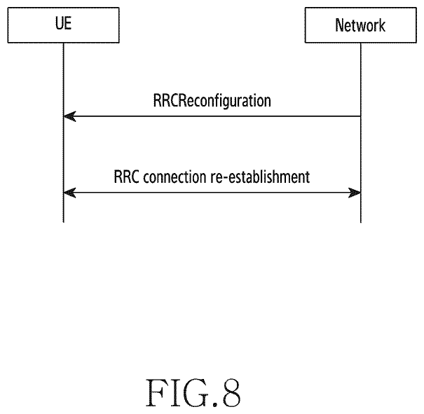

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this disclosure, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,” “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,” “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, embodiments of the disclosure will be described in detail with reference to the accompanying drawings. It should be noted that the same reference numerals in different drawings will be used to refer to the same elements already described.

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

FIGS. 1 through 17, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

Certain terms are used throughout this disclosure and these are defined here, for ease of reference:

LTM: L1/L2-triggered mobility: a PCell (or PSCell) cell switch procedure that the network triggers via MAC CE based on L1 measurements. RACH-less LTM indicates that a UE skips the random access procedure at LTM cell switch. Subsequent LTM indicates LTM between candidate cells without RRC reconfiguration in between. Note that LTM is also referred to lower-layer triggered mobility.

A physical downlink control channel (PDCCH) occasion: a time duration (i.e., one or a consecutive number of symbols) during which the MAC entity is configured to monitor the PDCCH.

Serving cell: A Pcell (primary cell), a PSCell (primary SCG (secondary cell group) cell), or an SCell (secondary cell).

Special cell (SpCell): For dual connectivity operation the term special cell refers to the PCell of the master cell group (MCG) or the PSCell of the SCG depending on if the MAC entity is associated to the MCG or the SCG, respectively. Otherwise, the term special cell refers to the PCell. A special cell supports physical uplink control channel (PUCCH) transmission and contention-based random access, and is always activated.

Timing advance group: a group of serving cells that is configured by RRC and that, for the cells with a UL configured, using the same timing reference cell and the same timing advance value. A timing advance group containing the SpCell of a MAC entity is referred to as primary timing advance group (PTAG), whereas the term secondary timing advance group (STAG) refers to other TAGs.

Msg3: message transmitted on uplink shared channel (UL-SCH) containing a cell radio network temporary identifier (C-RNTI) MAC CE or common control channel (CCCH) service data unit (SDU), submitted from upper layer and associated with the UE Contention Resolution Identity, as part of a random access procedure.

LTM candidate cell: a candidate cell configured to the UE as specified by LTM candidate cell configuration (i.e., LTM-CandidateConfig) for LTM in RRC layer.

Multi-radio dual connectivity (MR-DC) is a generalization of the Intra-E-UTRA dual connectivity (DC), where a multiple Rx/Tx capable UE may be configured to utilize resources provided by two different nodes connected via non-ideal backhaul, one providing NR access and the other one providing either E-UTRA or NR access. One node acts as the master node (MN) or master cell group (MCG) and the other as the secondary node (SN) or secondary cell group (SCG). The MN and SN are connected via a network interface and at least the MN is connected to the core network.

MR-DC with the EPC: E-UTRAN supports MR-DC via E-UTRA-NR dual connectivity (EN-DC), in which a UE is connected to one eNB that acts as a MN and one en-gNB that acts as a SN. The eNB is connected to the EPC via the S1 interface and to the en-gNB via the X2 interface. The en-gNB might also be connected to the EPC via the S1-U interface and other en-gNBs via the X2-U interface.

MR-DC with the 5GC: NG-RAN supports NG-RAN E-UTRA-NR dual connectivity (NGEN-DC), in which a UE is connected to one ng-eNB that acts as a MN and one gNB that acts as a SN. NG-RAN supports NR-E-UTRA dual connectivity (NE-DC), in which a UE is connected to one gNB that acts as a MN and one ng-eNB that acts as a SN. NG-RAN supports NR-NR dual connectivity (NR-DC), in which a UE is connected to one gNB that acts as a MN and another gNB that acts as a SN. In addition, NR-DC can also be used when a UE is connected to a single gNB, acting both as a MN and as a SN, and configuring both MCG and SCG.

In this disclosure, the term “cell switch” is used for the procedure of triggering change of cells via the LTM feature and the term “Subsequent LTM” for the case when cell switch between L1/L2 mobility candidates is done without RRC reconfiguration in between.

It is an aim of embodiments of the present disclosure to address shortcomings in the prior art to overcome or at least ameliorate them.

According to the present disclosure there is provided an apparatus and method as set forth in the appended claims. Other features of the disclosure will be apparent from the dependent claims, and the description which follows.

According to a first aspect of the present disclosure, there is provided a method of performing L1/L2 triggered mobility, LTM, in a user equipment, UE, communicatively coupled to a telecommunication network, wherein if the UE receives RRCReconfiguration containing LTM target cell information, RRCReconfigurationComplete is sent to a source cell, and upon receipt of a MAC control element, CE, from the source cell, the target cell information is applied, a handover is performed, and a further RRCReconfigurationComplete is generated and sent to the target cell upon completion of the handover.

In an embodiment, if dual connectivity (DC) is enabled for the UE, then LTM configuration information can be set for either master cell group (MCG) or secondary cell group (SCG), respectively, and can be set to signaling radio bearer 1 (SRB1) or signaling radio bearer 3 (SRB3).

In an embodiment, if an LTM cell change is instructed for SCG, and if SRB1 is included in nr-SCG and instructed to set LTM for the SCG, a second RRCReconfigurationComplete message is generated after LTM is executed, SCG LTM settings are applied, and sent to SRB1 as part of the ULInformationTransferMRDC message or if the LTM settings for the SCG are instructed by SRB3, and if it is not received as a DLInformationTransferMRDC message, a second RRCReconfigurationComplete message is generated after LTM is executed, the SCG LTM settings are applied, and sent to SRB3.

According to a second aspect of the present disclosure, there is provided apparatus arranged to perform the method of the first aspect. Embodiments of the disclosure provide several solutions to support LTM (L1/L2-triggered mobility) with low latency, low complexity and no user plane data loss. Embodiments also consider the impact on legacy. Moreover, embodiments support LTM cell switch for a UE configured with dual connectivity (DC), e.g., LTM cell switch for Secondary cell group.

Although a few preferred embodiments of the present disclosure have been shown and described, it will be appreciated by those skilled in the art that various changes and modifications might be made without departing from the scope of the disclosure, as defined in the appended claims.

LTM is a procedure in which a gNB receives L1 measurement reports from UEs, and on their basis the gNB changes UEs' serving cell(s) by a cell switch command through a MAC CE, which indicates an LTM candidate cell configuration that the gNB previously prepared and provided to the UE through RRC signalling. Then cell switch is triggered, by selecting the indicated LTM candidate cell configuration as the target configuration by the gNB. An LTM candidate cell configuration can only be added, modified and released by a network via RRC signaling. The LTM procedure can be used to reduce the mobility.

A network may request the UE to perform early TA acquisition (or TA acquisition) of a candidate cell (i.e., LTM candidate cell) before a cell switch. The early TA acquisition (or TA acquisition) is triggered by PDCCH order or through UE-based TA measurement.

The network indicates in the cell switch command whether the UE may access the target cell with a random access (RA) procedure or with physical uplink shared channel (PUSCH) transmission using the indicated TA value. For RACH-less LTM, the UE either monitors PDCCH for dynamic scheduling from the target cell upon LTM cell switch, or the UE selects the configured grant occasion associated with the beam indicated in the cell switch command (e.g., the first MAC CE or RRC configuration).

The following principles apply to LTM:
Each LTM candidate cell configuration can be provided as delta configuration on top of a reference configuration, which is used to form a complete candidate cell configuration. The reference configuration can be managed separately, and a UE stores the reference configuration as a separate configuration. The LTM candidate cell configuration can be configured in RRCReconfiguration message via SRB1 (e.g., Signaling Radio Bearer), i.e., it can be configured after SRB1 establishment.
When a complete candidate cell configuration is applied, it replaces the current UE configuration at the time of cell switch. Although the reconfiguration procedure makes replacement, it does not necessarily reset medium access control (MAC), radio link control (RLC) or packet data convergence protocol (PDCP) layer.
A user plane is continued without reset to support lossless delivery of user plane data (e.g., intra-DU LTM), if it is configured in RRC signaling, with the target to avoid data loss and the additional delay of data recovery. Specifically, indicators for RLC re-establishment or MAC reset (or Partial MAC reset) or PDCP re-establishment or PDCP data recovery or SDU discard can be included in RRCReconfiguration message as listed below, which can be included with LTM candidate cell configuration together:
an indicator for MAC reset or Partial MAC reset included in RRCReconfiguration message (e.g., in Cell group (or Cell) configuration);
an indicator for RLC re-establishment (e.g., reestablishRLC) included in RRCReconfiguration message (e.g., in Cell group (or Cell) configuration);
an indicator for PDCP re-establishment (e.g., reestablishPDCP) included in RRCReconfiguration message (e.g., in radio bearer configuration, i.e., RadioBearerConfig IE);
an indicator for PDCP data recovery (e.g., recoverPDCP) included in RRCReconfiguration message (e.g., in radio bearer configuration, i.e., RadioBearerConfig IE); and
an indicator for SDU discard (e.g., discardOnPDCP) for SRBs (e.g., SRB1 or SRB3) included in RRCReconfiguration message (e.g., in radio bearer configuration, i.e., RadioBearerConfig IE), which can be called PDCP SDU discard.

The above indicators can be included in RRCReconfiguration message (e.g., in Cell group configuration or LTM candidate cell configuration) including candidate cell configurations for LTM. Upon the reception of the RRCReconfiguration message, a UE can store the cell configuration and the indicators and does not apply them to UE configuration. When the UE successfully completes it after triggering the LTM procedure (or cell switch) by a cell switch command through a MAC CE indicating the target cell(s) (e.g., identifier(s)), beam index, or, TA (timing advance) value, the UE can apply the LTM candidate cell configuration and the indicators corresponding to the target cell (or indicated cell in MAC CE). The following conditions are considered as successful completion of the LTM procedure (i.e., cell switch):
For RACH-based LTM procedure (cell switch), the UE considers that LTM execution procedure is successfully completed when the RACH is successfully completed; and
For RACH-less LTM procedure (cell switch), the UE considers that LTM execution procedure is successfully complete when the UE determines the NW has successfully received the first UL data;

When the above condition for successful completion of LTM cell switch is met (or the LTM cell candidate configuration is complete, i.e., if the LTM cell candidate configuration is indicated to be applied by an indicator), the UE can apply the LTM candidate cell configuration and the indicators corresponding to the target cell (or indicated cell in MAC CE) to a UE configuration. This approach can avoid UE's early application and reverting it back when it fails, which eases UE implementation. Moreover, the UE cannot know the time when the network sends MAC CE indicating LTM cell switch to UE.

For example, when the above condition is met, the UE performs MAC reset (or partial MAC reset) if the indicator is configured in the stored configuration (e.g., LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate MAC reset (or partial MAC reset) to MAC layer, if configured.

For example, when the above condition is met, the UE performs RLC re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate RLC re-establishment to RLC layer, if configured.

For example, when the above condition is met, the UE performs PDCP re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate PDCP re-establishment to PDCP layer, if configured.

For example, when the above condition is met, the UE performs PDCP data recovery if the indicator is configured in the stored configuration (e.g., LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with acknowledged mode (AM) mode). When the condition is met, the MAC layer can indicate the successful completion of LTM cell switch to the RRC layer. The RRC layer can indicate PDCP data recovery to PDCP layer, if configured.

For example, when the above condition is met, the UE performs SDU discard in PDCP entity (i.e., PDCP SDU discard) if the indicator is configured in the stored configuration (e.g., LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with AM mode). When the condition is met, the MAC layer can indicate the successful completion of LTM cell switch to the RRC layer. The RRC layer can indicate SDU discard to PDCP layer, if configured. For SRBs, when upper layers (e.g., RRC layer) request a PDCP SDU discard, the PDCP entity may discard all stored PDCP SDUs and PDCP PDUs. It is beneficial to discard old RRC messages of SRBs to prevent unnecessary (re-)transmission to the target cell. The PDCP SDU discard for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to). The RLC re-establishment for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to). When the above condition is met, the UE can stop the supervisor timer as the LTM execution was successfully completed.

In another embodiment, upon the reception of MAC CE indicating LTM cell switch (or LTM cell switch execution), the UE can apply the LTM candidate cell configuration and the indicators corresponding to the target cell (or indicated cell in MAC CE) to a UE configuration. This approach can avoid UE's early application and revert it back when it fails, which eases UE implementation. This approach can avoid UE's early application. As the UE cannot know the time when the network sends MAC CE indicating LTM cell switch, the UE can follow this approach to apply the configuration timely. The reception of MAC CE indicating LTM cell switch can implies LTM cell switch execution.
For example, upon the reception of MAC CE indicating LTM cell switch (or LTM cell switch execution), the UE performs MAC reset (or partial MAC reset) if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate MAC reset (or partial MAC reset) to MAC layer, if configured.
For example, upon the reception of MAC CE indicating LTM cell switch (or LTM cell switch execution), the UE performs RLC re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate RLC re-establishment to RLC layer, if configured.
For example, upon the reception of MAC CE indicating LTM cell switch (or LTM cell switch execution), the UE performs PDCP re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate PDCP re-establishment to PDCP layer, if configured.
For example, upon the reception of MAC CE indicating LTM cell switch (or LTM cell switch execution), UE performs PDCP data recovery if the indicator is configured in the stored configuration (e.g., LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with acknowledged mode (AM) mode). Upon the reception of MAC CE indicating LTM cell switch (or LTM cell switch execution), the MAC layer can indicate the successful completion of LTM cell switch to the RRC layer. The RRC layer can indicate PDCP data recovery to PDCP layer, if configured.
For example, upon the reception of MAC CE indicating LTM cell switch (or LTM cell switch execution), the UE performs SDU discard in PDCP entity (i.e., PDCP SDU discard) if the indicator is configured in the stored configuration (e.g., LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with AM mode). Upon the reception of MAC CE indicating LTM cell switch (or LTM cell switch execution), the MAC layer can indicate the successful completion of LTM cell switch to the RRC layer. The RRC layer can indicate SDU discard to PDCP layer, if configured. For SRBs, when upper layers (e.g., RRC layer) request a PDCP SDU discard, the PDCP entity may discard all stored PDCP SDUs and PDCP PDUs. It is beneficial to discard old RRC messages of SRBs to prevent unnecessary (re-)transmission to the target cell. The PDCP SDU discard for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to). The RLC re-establishment for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to).

In another embodiment, upon the reception of MAC CE indicating LTM cell switch (or LTM cell switch execution) or upon the reception of RRCReconfiguration message including the indicators (or the LTM cell candidate configuration is complete, i.e., if the LTM cell candidate configuration is indicated to be applied by an indicator), a UE can apply the LTM candidate cell configuration (e.g., complete LTM cell configuration) and the indicators corresponding to the target cell (or indicated cell in MAC CE) to a UE configuration. This approach can be efficiently performed by the network. For example, the network sends MAC CE indicating LTM cell switch and RRCReconfiguration message including indicators together (e.g., at a time or in the same MAC PDU) to make the UE performs the following actions.

For example, upon the reception of MAC CE indicating LTM cell switch (or LTM cell switch execution) or upon the reception of RRCReconfiguration message including the indicators, the UE performs MAC reset (or partial MAC reset) if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate MAC reset (or partial MAC reset) to MAC layer, if configured.

For example, upon the reception of RRCReconfiguration message including the indicators, the UE performs RLC re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of RRCReconfiguration message including the indicators, the MAC layer can indicate the successful completion of LTM cell switch to the RRC layer. The RRC layer can indicate RLC re-establishment to RLC layer, if configured.

For example, upon the reception of RRCReconfiguration message including the indicators, the UE performs PDCP re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of RRCReconfiguration message including the indicators, the MAC layer can indicate the successful completion of LTM cell switch to the RRC layer. The RRC layer can indicate PDCP re-establishment to PDCP layer, if configured.

For example, upon the reception of RRCReconfiguration message including the indicators, the UE performs PDCP data recovery if the indicator is configured in the stored configuration (e.g., LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with AM mode). Upon the reception of RRCReconfiguration message including the indicators, the MAC layer can indicate the successful completion of LTM cell switch to the RRC layer. The RRC layer can indicate PDCP data recovery to PDCP layer, if configured.

For example, upon the reception of RRCReconfiguration message including the indicators that the UE performs SDU discard in PDCP entity (i.e., PDCP SDU discard) if the indicator is configured in the stored configuration (e.g., LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with AM mode). Upon the reception of RRCReconfiguration message including the indicators, the MAC layer can indicate the successful completion of LTM cell switch to the RRC layer. The RRC layer can indicate SDU discard to PDCP layer, if configured. For SRBs, when upper layers (e.g., RRC layer) request a PDCP SDU discard, the PDCP entity may discard all stored PDCP SDUs and PDCP PDUs. It is beneficial to discard old RRC messages of SRBs to prevent unnecessary (re-)transmission to the target cell. The PDCP SDU discard for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to). The RLC re-establishment for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to).

NOTE: this delayed application of configuration is totally different from the legacy behaviour because the UE performs MAC reset/RLC/PDCP re-establishment, if configured, upon the reception of RRCReconfiguration in legacy procedure. In the above, the stored LTM candidate cell configuration can be regarded as reference configuration, which can be applied at a specific time as set out.

Security is not updated in LTM. In another embodiment, the network decides whether to update the security based on the type of mobility (e.g., to which cell UE is indicated to perform cell switch). For example, the security configuration for security update is not included in the LTM candidate cell configuration (RRCReconfiguration) for the case that this candidate cell belongs to intra-gNB-DU or intra-gNB-CU. However, the security configuration for security update is included in the LTM candidate cell configuration (RRCReconfiguration) for the case that this candidate cell belongs to inter-gNB-DU (i.e., inter-gNB-DU mobility case) When the condition for successful completion of LTM cell switch is met after triggering the LTM procedure (or cell switch) by a cell switch command through a MAC CE, the UE applies and updates the security configuration to the current configuration, if configured,

Subsequent LTM between LTM candidate cell configurations (i.e., the UE does not release other LTM candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario,
PCell change with SCell change(s) in CA scenario, including the following cases:
a) The target PCell/target SCell(s) is not a current serving cell (CA-to-CA scenario with PCell change);
b) The target PCell is a current SCell; and
c) The target SCell is the current PCell, and
Dual connectivity scenario, at least for the PSCell change without MN involvement case, i.e., intra-SN. When a UE is configured with dual connectivity (i.e., SCG and MCG, for SCG (or LTM procedure for SCG), the LTM candidate cell configuration of SCG can be configured in RRCReconfiguration message via SRB3, i.e., it can be configured after SRB3 establishment. For SCG (or LTM procedure for SCG), the LTM candidate cell configuration of SCG cannot be configured via SRB1. For MCG (or LTM procedure for MCG), the LTM candidate cell configuration of MCG can be configured in RRCReconfiguration message via SRB1, i.e., it can be configured after SRB1 establishment.

To support the above scenarios, additional procedures may be needed. For example, when the scenario, b) The target PCell is a current SCell, is considered in LTM configuration and LTM procedure (or execution or cell switch), the random access procedure for TA acquisition of LTM candidate cell can be performed on the SCell if the SCell is activated (or in activated state). However, if the SCell is deactivated (in deactivated state), the random access procedure for TA acquisition of LTM candidate cell cannot be performed on the SCell as the SCell is off. To support this scenario, one of the following options to easy UE and network implementation may be provided.

Option 1: as UE cannot perform the random access procedure (i.e., transmit on RACH or perform RACH) on the deactivated SCell, the network does not indicate LTM cell switch (or Random access procedure for TA acquisition) to the deactivated SCell as the target LTM candidate cell. The network does not send the first MAC CE (LTM command MAC CE) including the indicator (or identity) for LTM candidate configuration to a UE if the configuration corresponds to the deactivated SCell of UE. In other words, the UE does not expect the reception of the first MAC CE indicating LTM execution to the deactivated SCell of UE. In this option, (b) The target PCell is a current SCell″ can be restricted to the case that the target PCell is a current activated SCell, i.e., the network can indicate LTM cell switch to the activated SCell as the target LTM candidate cell. The network can send the first MAC CE (LTM command MAC CE) including the indicator (or identity) for LTM candidate configuration to a UE if the configuration corresponds to the activated SCell of UE.

Option 2: in this option, a UE may be allowed to perform the random access procedure on a deactivated (or an activated) SCell when the random access procedure (i.e., transmit on RACH or perform RACH) is triggered by PDCCH order to acquire TA of the SCell and the SCell is one of LTM candidate cells configured to UE. Except for this case, w a UE may not be allowed to perform RACH on the deactivated SCell. Therefore, the network can indicate LTM cell switch to the deactivated SCell (or activated SCell) as the target LTM candidate cell. The network can send the first MAC CE (LTM command MAC CE) including the indicator (or identity) for LTM candidate configuration to a UE regardless of SCell state. To enable this option (i.e., to support the scenario b)), the following procedure as illustrated in TABLE 1 is set out.

TABLE 1
1> if the SCell is deactivated:
2> not transmit SRS on the SCell;
2> not report CSI for the SCell;
2> not transmit on UL-SCH on the SCell;
2> not transmit on RACH on the SCell, except when the random access procedure
(i.e., RACH) is initiated by the PDCCH order for the LTM candidate cell (i.e., the SCell)
for TA acquisition of the SCell or when the SCell is configured as one of LTM candidate
cell or when the SCell is the LTM candidate cell;
2> not monitor the PDCCH on the SCell;
2> not monitor the PDCCH for the SCell;
2> not transmit PUCCH on the SCell.

Option 3: in this option, LTM supports both intra-gNB-DU and intra-gNB-CU inter-gNB-DU mobility. LTM also supports inter-frequency mobility, including mobility to inter-frequency cell that is not a current serving cell (i.e., PCell, PSCell or SCell). In other words, the network does not indicate LTM cell switch (or random access procedure for TA acquisition) to the current serving cell (i.e., PCell, PSCell or SCell) of the UE as the target LTM candidate cell. The network does not send the first MAC CE (LTM command MAC CE) including the indicator (or identity) for LTM candidate configuration to a UE if the configuration corresponds to the current serving cell of UE. In other words, the UE does not expect the reception of the first MAC CE indicating LTM execution to the current serving cell of UE. In another embodiment, the network does not configure LTM candidate configuration corresponding the current serving cell of a UE to the UE. This configuration restriction can work the same as the intention of this option, i.e., the network cannot indicate LTM cell switch (or random access procedure for TA acquisition) to the current serving cell (i.e., PCell, PSCell or SCell) of the UE as the target LTM candidate cell. The network can indicate LTM cell switch (or Random access procedure for TA acquisition) to a candidate cell except the current serving cell (i.e., PCell, PSCell or SCell) of the UE as the target LTM candidate cell. The network can send the first MAC CE (LTM command MAC CE) including the indicator (or identity) for LTM candidate configuration to a UE if the configuration does not correspond to the current serving cell of UE.

The following relates to C-plane handling (Control plane handling).

A cell switch trigger is conveyed in a MAC CE, which contains at least a candidate configuration index together with beam indication.

A UE may perform CBRA or CFRA at cell switch. The UE may also skip random access procedure (i.e., RACH-less solution) if the UE does not need to acquire TA for the target cell during cell switch.

The overall procedure for LTM is shown in FIG. 1. Subsequent LTM is done by repeating the early synchronization, LTM execution, and LTM completion steps without releasing other LTM candidate cell configurations after each LTM completion.

The procedure for LTM is as follows.
1. The UE sends a MeasurementReport message to the gNB. The gNB decides to use LTM and initiates candidate cell(s) preparation.
2. The gNB transmits an RRCReconfiguration message to the UE including the LTM candidate cell configurations of one or multiple candidate cells.
3. The UE stores the LTM candidate cell configurations and transmits a RRCReconfigurationComplete message to the gNB.
4a. The UE may perform DL synchronization with candidate cell(s) before receiving the cell switch command. DL synchronization for candidate cell(s) before cell switch command can be supported, at least based on SSB.
4b. The UE performs early TA acquisition with candidate cell(s) requested by the network before receiving the cell switch command. This is done via Random access procedure (i.e., contention-free random access procedure, CFRA) triggered by a PDCCH order from the source cell, following which the UE sends preamble towards the indicated candidate cell. In order to minimize the data interruption of the source cell due to CFRA towards the candidate cell(s), the UE does not receive RAR for the purpose of TA value acquisition and the TA value of the candidate cell is indicated in the cell switch command (i.e., the first MAC CE). The UE does not maintain the TA timer for the candidate cell and relies on network implementation to guarantee the TA validity.

Synchronization for candidate cell(s) before cell switch command is supported, at least based on SSB.

In this disclosure, TA acquisition of candidate cell(s) before LTM cell switch command is supported, at least based on PDCCH ordered RACH, where the PDCCH order is only triggered by source cell. The source cell can trigger UE's RACH (random access procedure) toward a candidate cell by PDCCH order to acquire timing advance (TA) or TA value for the candidate cell, which only performs preamble transmission and does not expect the reception of RAR (random access response) to ease network implementation and UE implementation. Specifically, the preamble transmission during this random access procedure (RACH) for TA acquisition (i.e., early RACH) can be considered as this random access procedure is successfully completed. To reduce the processing complexity, a UE may not calculate RA-radio network temporary identifier (RNTI) for random access response) before/when the preamble is transmitted, unlike normal random access procedure (RACH). To be more specific, the UE transmits preamble to a candidate cell as indicated by PDCCH order. The network (or distributed unit (DU) or the candidate cell) calculates the timing advance (TA). The source cell/DU can get the calculated TA from the candidate cell/DU. By doing this RACH (random access procedure) for TA acquisition (i.e., early RACH), the network can have the TA values for the candidate cells and knows whether these Tas are still valid or not, e.g., by maintaining a network side timer (i.e., TAT (timeAlignmentTimer) for each TA value or each candidate cell).

In this way, the source cell/DU gets to know the value and the validity of candidate cell TA. The source cell/DU needs to know whether a candidate cell TA is still valid because the source cell/DU needs to determine whether it can initiate a RACH-less solution for LTM cell switch and then determine whether it needs to include a beam indication (e.g., transmission configuration indication (TCI) state) and TA information in the LTM MAC CE. Therefore, the network can indicate a valid TA to the UE or indicate whether a TA is still valid in LTM MAC CE. The UE may not need to maintain a TA timer for candidate cells, which simplifies UE implementation. Upon the reception of the TA information indicated in LTM MAC CE, the UE can apply the TA value and start the TA timer for the target LTM candidate cell upon LTM execution (i.e., LTM cell switch) and the UE can perform LTM cell switch without Random access procedure (i.e., with RACH-less solution) if TAT for the target LTM candidate cell is running (i.e., TA value is valid) or if Beam failure is not detected for the target LTM candidate cell, which means that the UE can monitor PDCCH from the target LTM candidate cell or the UE can use configured grants the first UL data transmission to the target cell for RACH-less LTM execution (LTM cell switch).
5. The UE performs L1 measurements on the configured candidate cell(s), and transmits lower-layer measurement reports to the gNB.
6. The gNB decides to execute cell switch to a target cell, and transmits a MAC CE triggering cell switch by including the candidate configuration index of the target cell. The UE switches to the configuration of the target cell.
7. The UE performs random access procedure towards the target cell, if cell switch needs to include performing random access procedure.
8. The UE completes the LTM cell switch procedure by sending RRCReconfigurationComplete message to target cell. If the UE has performed a RA procedure in step 7, the UE considers that LTM execution is successfully completed when the random access procedure is successfully completed. For RACH-less LTM, the UE considers that LTM execution is successfully completed when the UE determines that the network has successfully received the first UL data.

The UE can perform the steps 4-8 multiple times for subsequent LTM cell switch based on the configuration provided in step 2.

The following relates to U-plane handling (User plane handling).

In LTM, whether the UE performs partial or full MAC reset, re-establishes RLC, performs data recovery with PDCP during cell switch is explicitly controlled by the network through RRC signalling.
MAC/RLC re-establishment/PDCP data recovery/PDCP re-establishment (when configured)
RF retuning (e.g., needed for inter-frequency), baseband retuning

The PDCP data recovery procedure can be applied to the RLC AM bearers for inter-DU LTM cell switch.

The following relates to Security Protection.

The following high-level principles may be applied. In this disclosure, the security protection implies ciphering or integrity protection. The ciphering means not only the ciphering operation but also the deciphering operation because the deciphering may be applied to the data at the receiver if a data is ciphered at the transmitter. Likewise, the integrity protection means the integrity verification operation as well as the integrity protection operation because the integrity verification may be applied to the data at the receiver if a data is integrity protected at the transmitter.

AS security comprises of the integrity protection and ciphering of RRC signalling (SRBs) and user data (DRBs).

RRC handles the configuration of the AS security parameters which are part of the AS configuration: the integrity protection algorithm, the ciphering algorithm, if integrity protection and/or ciphering is enabled for a DRB and two parameters, namely the keySetChangeIndicator and the nextHopChainingCount, which are used by the UE to determine the AS security keys upon reconfiguration with sync (with key change), connection re-establishment and/or connection resume.

The integrity protection algorithm is common for SRB1, SRB2, SRB3 (if configured), SRB4 (if configured), SRBx (if configured) and DRBs configured with integrity protection, with the same keyToUse value. The ciphering algorithm is common for SRB1, SRB2, SRB3 (if configured), SRB4 (if configured), SRBx (if configured) and DRBs configured with the same keyToUse value. Neither integrity protection nor ciphering applies for SRB0.

NOTE 0: All DRBs related to the same PDU session have the same enable/disable setting for ciphering and the same enable/disable setting for integrity protection.

RRC integrity protection and ciphering are always activated together, i.e., in one message/procedure. RRC integrity protection and ciphering for SRBs are never de-activated. However, it is possible to switch to a “NULL” ciphering algorithm (nea0).

For SRBx (if configured), RRC integrity protection and ciphering can be activated and deactivated based on configuration or indication by RRC messages (or MAC control element (CE) or PDCP control PDU), in order to reduce the UE processing burden. For SRBx (if configured), it is also possible to switch to a “NULL” ciphering algorithm (nea0) and the “NULL” integrity protection algorithm (nia0) can be used.

The “NULL” integrity protection algorithm (nia0) is used only for SRBs and for the UE in limited service mode and when used for SRBs, integrity protection is disabled for DRBs. In case the “NULL” integrity protection algorithm is used, “NULL” ciphering algorithm is also used.

NOTE 1: Lower layers discard RRC messages for which the integrity protection check has failed and indicate the integrity protection verification check failure to RRC.

The AS applies four different security keys: one for the integrity protection of RRC signalling (KRRCint), one for the ciphering of RRC signalling (KRRCenc), one for integrity protection of user data (KUPint) and one for the ciphering of user data (KUPenc). All four AS keys are derived from the KgNB key. The KgNB key is based on the KAMF key, which is handled by upper layers.

The integrity protection and ciphering algorithms can only be changed with reconfiguration with sync. The AS keys (KgNB, KRRCint, KRRCenc, KUPint and KUPenc) change upon reconfiguration with sync (if masterKeyUpdate is included), and upon connection re-establishment and connection resume.

For each radio bearer an independent counter (COUNT used in PDCP layer) is maintained for each direction. For each radio bearer, the COUNT is used as input for ciphering and integrity protection.

It is not allowed to use the same COUNT value more than once for a given security key. The network is responsible for avoiding reuse of the COUNT with the same RB identity and with the same key, e.g., due to the transfer of large volumes of data, release and establishment of new RBs, and multiple termination point changes for RLC-UM bearers and multiple termination point changes for RLC-AM bearer with SN terminated PDCP re-establishment (COUNT reset) due to SN only full configuration whilst the key stream inputs (i.e., bearer ID, security key) at MN have not been updated. In order to avoid such re-use, the network may e.g., use different RB identities for RB establishments, change the AS security key, or an RRC_CONNECTED to RRC_IDLE/RRC_INACTIVE and then to RRC_CONNECTED transition.

In order to limit the signalling overhead, individual messages/packets include a short sequence number (e.g., PDCP sequence number (SN)). In addition, an overflow counter mechanism is used: the hyper frame number (HFN used in PDCP layer). The HFN needs to be synchronized between the UE and the network.

For each SRB, the value provided by RRC to lower layers to derive the 5-bit BEARER parameter used as input for ciphering and for integrity protection is the value of the corresponding srb-Identity with the MSBs padded with zeroes.

For a UE provided with an sk-counter, keyToUse indicates whether the UE uses the master key (KgNB) or the secondary key (S-KeNB or S-KgNB) for a particular DRB. The secondary key is derived from the master key and sk-Counter. Whenever there is a need to refresh the secondary key, e.g., upon change of MN with KgNB change or to avoid COUNT reuse, the security key update is used. When the UE is in NR-DC, the network may provide a UE configured with an SCG with an sk-Counter even when no DRB is setup using the secondary key (S-KgNB) in order to allow the configuration of SRB3. The network can also provide the UE with an sk-Counter, even if no SCG is configured, when using SN terminated MCG bearers.

The following relates to RRC protocol.

A UE is either in RRC_CONNECTED state or in RRC_INACTIVE state when an RRC connection has been established. If this is not the case, i.e., no RRC connection is established, the UE is in RRC_IDLE state. The RRC states can further be characterised as follows:
RRC_IDLE:
A UE specific DRX may be configured by upper layers;
At lower layers, the UE may be configured with a DRX for PTM transmission of MBS broadcast;
UE controlled mobility based on a network configuration;
The UE:
Monitors Short Messages transmitted with P-RNTI over DCI;
Monitors a Paging channel for CN paging using 5G-S-TMSI, except if the UE is acting as a L2 U2N Remote UE;
If configured by upper layers for MBS multicast reception, monitors a Paging channel for CN paging using TMGI;
Performs neighbouring cell measurements and cell (re-)selection;
Acquires system information and can send SI request (if configured);
Performs logging of available measurements together with location and time for logged measurement configured UEs;
Performs idle/inactive measurements for idle/inactive measurement configured UEs;
Performs AI/ML functionality (e.g., collection of AI/ML data or measurements for AI/ML data or reporting AI/ML data) configured UEs; and/or
If configured by upper layers for MBS broadcast reception, acquires MCCH change notification and MBS broadcast control information and data.
RRC_INACTIVE:
A UE specific DRX may be configured by upper layers or by an RRC layer;
At lower layers, the UE may be configured with a DRX for PTM transmission of MBS broadcast;
UE controlled mobility based on a network configuration;
The UE stores the UE Inactive AS context;
A RAN-based notification area is configured by RRC layer; and/or
Transfer of unicast data and/or signalling to/from the UE over radio bearers configured for SDT.

### The UE:

Monitors short messages transmitted with P-RNTI over DCI;
During SDT procedure, monitors control channels associated with the shared data channel to determine if data is scheduled for it;
While SDT procedure is not ongoing, monitors a Paging channel for CN paging using 5G-S-TMSI and RAN paging using full I-RNTI, except if the UE is acting as a L2 U2N remote UE;
If configured by upper layers for MBS multicast reception, while SDT procedure is not ongoing, monitors a Paging channel for paging using TMGI;
Performs neighbouring cell measurements and cell (re-)selection;
Performs RAN-based notification area updates periodically and when moving outside the configured RAN-based notification area;
Acquires system information, while SDT procedure is not ongoing, and can send SI request (if configured);
While SDT procedure is not ongoing, performs logging of available measurements together with location and time for logged measurement configured UEs;
While SDT procedure is not ongoing, performs idle/inactive measurements for idle/inactive measurement configured UEs;
While SDT procedure is not ongoing, performs AI/ML functionality (e.g., collection of AI/ML data or measurements for AI/ML data or reporting AI/ML data) configured UEs;
If configured by upper layers for MBS broadcast reception, acquires MCCH change notification and MBS broadcast control information and data; and/or
Transmits SRS for Positioning.
RRC_CONNECTED:
The UE stores the AS context;
Transfer of unicast data to/from UE;
Transfer of MBS multicast data to UE;
At lower layers, the UE may be configured with a UE specific DRX;
At lower layers, the UE may be configured with a DRX for PTM transmission of MBS broadcast and/or a DRX for MBS multicast;
For UEs supporting CA, use of one or more Scells, aggregated with the SpCell, for increased bandwidth;
For UEs supporting DC, use of one SCG, aggregated with the MCG, for increased bandwidth;
Network controlled mobility within NR, to/from E-UTRA, and to UTRA-FDD; and/or
Network controlled mobility (path switch) between a serving cell and a L2 U2N relay UE, or vice versa.
The UE:
Monitors Short Messages transmitted with P-RNTI over DCI, if configured;
Monitors control channels associated with the shared data channel to determine if data is scheduled for it;
Provides channel quality and feedback information;
Performs neighbouring cell measurements and measurement reporting;
Performs AI/ML functionality (e.g., collection of AI/ML data or measurements for AI/ML data or reporting AI/ML data) configured UEs;
Acquires system information;
Performs immediate MDT measurement together with available location reporting; and/or
If configured by upper layers for MBS broadcast reception, acquires MCCH change notification and MBS broadcast control information and data.

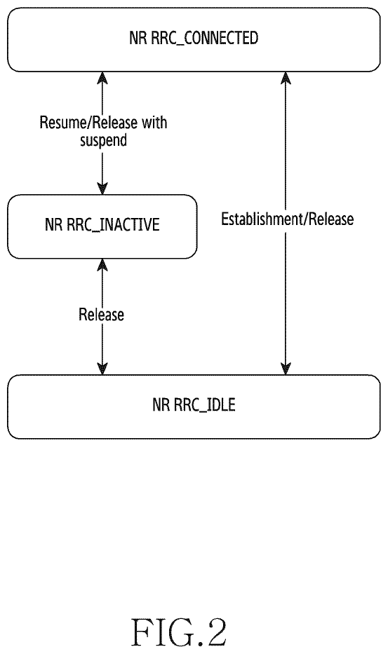

FIG. 2 illustrates an overview of UE RRC state machine and state transitions in NR. A UE has only one RRC state in NR at one time.

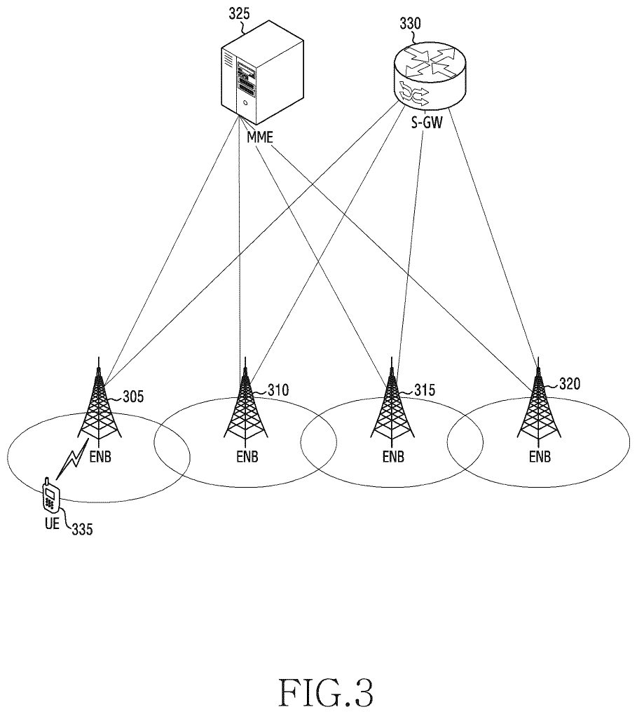

FIG. 3 illustrates the structure of an LTE system according to carious embodiments of the present disclosure.

Referring to FIG. 3, a radio access network of an LTE system includes next-generation base stations (also referred to as evolved node Bs, hereinafter eNBs, node Bs, or base stations) 305, 310, 315, and 320, a mobility management entity (MME) 325, and a serving gateway (S-GW) 330. A user equipment (hereinafter UE or terminal) 335 accesses an external network through the eNBs 305 to 320 and S-GW 330.

In FIG. 3, the eNBs 305 to 320 correspond to an existing node B of an UMTS system. The eNBs are connected to the UE 335 through a radio channel, and perform a more complicated role than the existing node B. In the LTE system, since all user traffic pertaining to real-time service, such as voice over IP (VoIP), via the Internet protocol, is serviced through a shared channel, a device that performs scheduling by collecting state information, such as buffer states, available transmit power states, and channel states of UEs, is required, and eNBs 305 to 320 are in charge of this function of the device. In general, one eNB controls multiple cells. For example, in order to implement a transmission rate of 100 Mbps, the LTE system uses orthogonal frequency division multiplexing (OFDM) as a radio access technology in the bandwidth of 20 MHz. In addition, the LTE system adopts an adaptive modulation & coding (hereinafter referred to as AMC) scheme for determining a modulation scheme and a channel coding rate based on the channel state of the UE. The S-GW 330 is a device for providing a data bearer and generating or removing a data bearer under the control of the MME 325. The MME is in charge of various control functions in addition to a mobility management function for the UE, and is connected to multiple base stations.

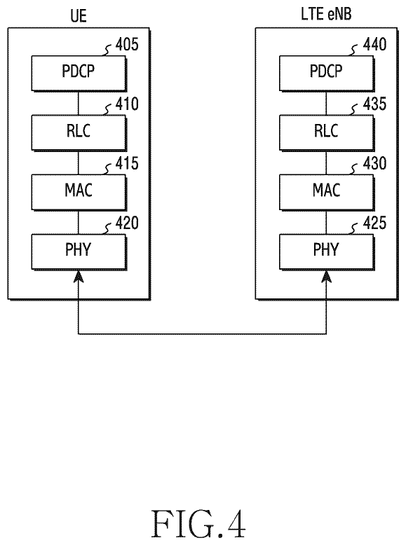

FIG. 4 illustrates a radio protocol structure in an LTE system according to various embodiments of the present disclosure.

Referring to FIG. 4, the radio protocol of the LTE system includes packet data convergence protocols (PDCPs) 405 and 440, radio link controls (RLCs) 410 and 435, and medium access controls (MACs) 415 and 430, in a UE and an eNB, respectively. The packet data convergence protocols (PDCPs) 405 and 440 are used to perform operations, such as IP header compression/restoration. The main functions of PDCPs are summarized as follows.
Header compression and decompression: ROHC only;
Transfer of user data;
In-sequence delivery of upper layer PDUs at PDCP re-establishment procedure for RLC acknowledged mode (AM);
Sequence reordering (for split bearers in DC (only support for RLC AM): PDCP PDU routing for transmission and PDCP PDU reordering for reception);
Duplicate detection of lower layer service data units (SDUs) in a PDCP re-establishment procedure for RLC AM;
Retransmission of PDCP SDUs at handover and, for split bearers in DC, of PDCP PDUs at PDCP data-recovery procedure, for RLC AM);
Ciphering and deciphering; and/or
Timer-based SDU discard in uplink.

The radio link control (hereinafter referred to as RLC) 410 and 435 performs ARQ operation by reconfiguring a PDCP protocol data unit (PDU) or RLC service data unit (SDU) to an appropriate size. The main functions of RLC are summarized below.
Transfer of upper layer PDUs;
ARQ function (Error correction through ARQ (only for AM data transfer));
Concatenation, segmentation and reassembly of RLC SDUs (only for unacknowledged mode (UM) and AM data transfer);
Re-segmentation of RLC data PDUs (only for AM data transfer);
Reordering of RLC data PDUs (only for UM and AM data transfer);
Duplicate detection (only for UM and AM data transfer);
Protocol error detection (only for AM data transfer);
RLC SDU discard (only for UM and AM data transfer); and/or
RLC re-establishment.

The MACs 415 and 430 are connected to multiple RLC layer devices configured in one UE, and may perform an operation of multiplexing RLC PDUs to MAC PDUs and demultiplexing RLC PDUs from MAC PDUs. The main functions of MACs are summarized as follows.
Mapping between logical channels and transport channels;
Multiplexing/de-multiplexing of MAC SDUs belonging to one or different logical channels into/from transport blocks (TB) transferred to/from the physical layer on transport channels;
Scheduling information reporting;
Error correction through hybrid automatic repeat request (HARQ);
Priority handling between logical channels of one UE;
Priority handling between UEs by means of dynamic scheduling;
MBMS service identification;
Transport format selection; and/or
Padding.

Physical layers 420 and 425 may perform operations of channel coding and modulating upper layer data, forming the upper layer data into an OFDM symbol, transmitting the OFDM symbol through a radio channel, or of demodulating an OFDM symbol received through a radio channel, channel-decoding the OFDM symbol, and transmitting the OFDM symbol to an upper layer.

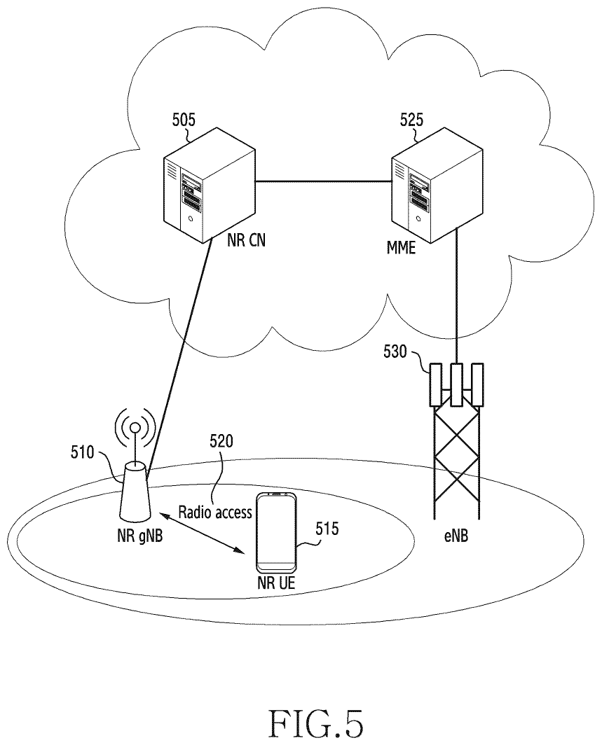

FIG. 5 illustrates the structure of a next-generation mobile communication system according to various embodiments of the present disclosure.

Referring to FIG. 5, a radio access network of a next-generation mobile communication system (hereinafter referred to as NR or 5G) includes a new radio node B (hereinafter referred to as an NR gNB, or NR base station) 510 and a new radio core network (NR CN) 505. A user terminal (a new radio user equipment, hereinafter referred to as NR UE or a UE) 515 accesses an external network via an NR gNB 510 and an NR CN 505.

In FIG. 5, the NR gNB 510 corresponds to an evolved node B (eNB) of the existing LTE system. The NR gNB is connected to the NR UE 515 via a radio channel, and may provide an excellent service as compared to the existing node B. In the next-generation mobile communication system, since all types of user traffics are serviced through a shared channel, there is a need for a device for performing scheduling by collecting state information, such as buffer states, available transmission power states, and channel states of UEs. Further, the NR NB 510 is in charge of this function of the device. In general, one NR gNB typically controls multiple cells. In order to implement ultra-high speed data transmission as compared to the existing LTE, the NR gNB may have the existing maximum bandwidth or more, and may additionally employ beamforming technology using orthogonal frequency division multiplexing (hereinafter referred to as OFDM) as a radio access technology. In addition, the NR gNB adopts an adaptive modulation & coding (AMC) scheme that determines a modulation scheme and a channel coding rate based on the channel state of a UE. The NR CN 505 performs functions, such as mobility support, bearer configuration, QoS configuration, and the like. The NR CN is a device that is in charge of various control functions in addition to a mobility management function for a UE, and is connected to multiple base stations. In addition, the next-generation mobile communication system may also operate in conjunction with the existing LTE system, and the NR CN may be connected to an MME 525 via a network interface. The MME is connected to an eNB 530, that is, to the existing base station.

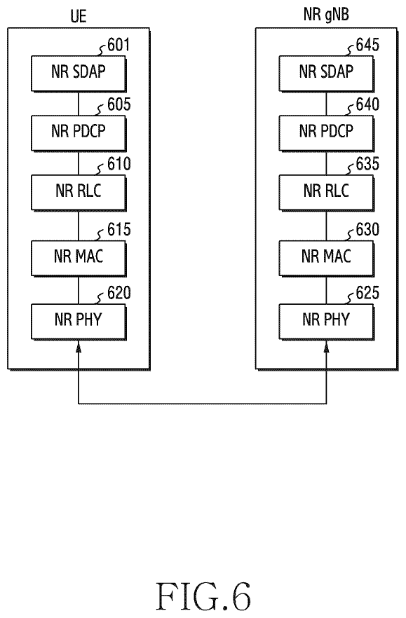

FIG. 6 illustrates a radio protocol structure of a next-generation mobile communication system according to various embodiments of the present disclosure.

Referring to FIG. 6, the radio protocol of the next-generation mobile communication system includes NR SDAPs 601 and 645, NR PDCPs 605 and 640, NR RLCs 610 and 635, and NR MACs 615 and 630, respectively, in a UE and an NR base station. The main functions of the NR SDAPs 601 and 645 may include some of the following functions:
Transfer of user plane data;
Mapping between a QoS flow and a data bearer (DRB) for both downlink (DL) and uplink (UL);
Marking QoS flow ID in both DL and UL packets; and/or
Mapping reflective QoS flow to DRB for the UL SDAP PDUs.

For the SDAP layer device, the UE may be configured as to whether or not use the header of the SDAP layer device (or new layer device) or the function of the SDAP layer device (or new layer device) for each PDCP layer device, for each bearer, and for each logical channel through an RRC message. When the SDAP header is configured, an NAS reflective QoS reflective configuration 1-bit indicator (NAS reflective QoS) and an AS QoS reflective configuration 1-bit indicator (AS reflective QoS) of the SDAP header are used to instruct the UE to enable updating or reconfiguration of the mapping information relating to the QoS flow of uplink and downlink and data bearer. The SDAP header may include QoS flow ID information indicating QoS. The QoS information may be used as data processing priority, scheduling information, etc., in order to support a smooth service.

The main functions of the NR PDCPs 605 and 640 may include some of the following functions:
Header compression and decompression (ROHC only);
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The reordering function of the NR PDCP device refers to a function of sequentially reordering PDCP PDUs, received from a lower layer, based on a PDCP sequence number (SN), and may include a function of transmitting data to an upper layer in the reordered sequence, a function of directly transmitting data to an upper layer without taking the sequence into consideration, a function of reordering the sequence and recording missing PDCP PDUs, a function of providing a state report on the missing PDCP PDUs to a transmission side, and a function of requesting retransmission of the missing PDCP PDUs. The main functions of the NR RLCs 610 and 635 may include some of the following functions:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

The in-sequence delivery function of the NR RLC device refers to a function of transmitting RLC SDUs, received from a lower layer, to an upper layer in a sequence of reception, and may include, if one RLC SDU is originally segmented into multiple RLC SDUs and received, a function of reassembling and transmitting the multiple RLC SDUs. The in-sequence delivery function may include a function of reordering the received RLC PDUs based on an RLC SN or PDCP SN, reordering the sequence and recording missing RLC PDUs, providing a state report on the missing RLC PDUs to a transmission side, and requesting retransmission of the missing RLC PDUs. Alternatively, the in-sequence delivery function of the NR RLC device may include a function of sequentially transmitting only RLC SDUs prior to the missing RLC SDU to an upper layer if an RLC SDU is missing, or sequentially transmitting all the RLC SDUs received before a timer starts to an upper layer if the timer expires even if there is a missing RLC SDU, or sequentially transmitting all RLC SDUs received so far to an upper layer if a predetermined timer expires even if there is a missing RLC SDU. In addition, the RLC PDUs may be processed in the sequence in which the RLC PDUS are received (in a sequence of arrival regardless of the serial number or sequence number), and may be transmitted to a PDCP device in out-of-sequence delivery. The in-sequence delivery function may include a function of receiving segments stored in a buffer or segments to be received later, reconfiguring the segments in one complete RLC PDU, processing the RLC PDU, and transmitting the RLC PDU to the PDCP device. The NR RLC layer may not include a concatenation function, and the concatenation function may be performed by the NR MAC layer, or may be replaced by a multiplexing function of the NR MAC layer.

The out-of-sequence delivery function of the NR RLC device refers to a function of directly transmitting the RLC SDUs, received from the lower layer, to an upper layer regardless of the order thereof, and may include, if one RLC SDU has been originally segmented into multiple RLC SDUs and received, a function of reassembling the multiple RLC SDUs and transmitting the same, and a function of storing the RLC SNs or PDCP SNs of the received RLC PDUs, reordering the sequence, and recording the missing RLC PDUs.

The NR MACs 615 and 630 may be connected to multiple NR RLC layer devices configured in one UE, and the main function of the NR MAC may include some of the following functions:
Mapping between logical channels and transport channels;
Multiplexing/de-multiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

The NR PHY layers 620 and 625 may perform operations of channel-coding and modulating upper layer data, forming the upper layer data into an OFDM symbol, transmitting the OFDM symbols via a radio channel or demodulating and channel decoding of the OFDM symbols received via the radio channel, and transferring the OFDM symbol to an upper layer.

The following relates to RRC Reconfiguration.

The purpose of this procedure is to modify an RRC connection, e.g., to establish/modify/release RBs/BH RLC channels/Uu relay RLC channels/PC5 relay RLC channels, to perform reconfiguration with sync, to setup/modify/release measurements, to add/modify/release Scells and cell groups, to add/modify/release conditional handover configuration, to add/modify/release conditional PSCell change or conditional PSCell addition configuration, to add/modify/LTM candidate cells. As part of the procedure, NAS dedicated information may be transferred from the network to the UE.

RRC reconfiguration to perform reconfiguration with sync includes, but is not limited to, the following cases:
reconfiguration with sync and security key refresh, involving RA to the Pcell/PSCell, MAC reset, refresh of security and re-establishment of RLC and PDCP triggered by explicit L2 indicators;
reconfiguration with sync but without security key refresh, involving RA to the Pcell/PSCell, MAC reset and RLC re-establishment and PDCP data recovery (for AM DRB or AM MRB) triggered by explicit L2 indicators;
reconfiguration with sync for DAPS and security key refresh, involving RA to the target Pcell, establishment of target MAC:
for non-DAPS bearer: refresh of security and re-establishment of RLC and PDCP triggered by explicit L2 indicators;
for DAPS bearer: establishment of RLC for the target Pcell, refresh of security and reconfiguration of PDCP to add the ciphering function, the integrity protection function and ROHC function of the target Pcell; and
for SRB: refresh of security and establishment of RLC and PDCP for the target Pcell;
reconfiguration with sync for DAPS but without security key refresh, involving RA to the target Pcell, establishment of target MAC:
for non-DAPS bearer: RLC re-establishment and PDCP data recovery (for AM DRB or AM MRB) triggered by explicit L2 indicators.
for DAPS bearer: establishment of RLC for target Pcell, reconfiguration of PDCP to add the ciphering function, the integrity protection function and ROHC function of the target Pcell; and
for SRB: establishment of RLC and PDCP for the target Pcell; And
reconfiguration with sync for direct-to-indirect path switch, not involving RA at target side, involving re-establishment of PDCP/PDCP data recovery (for AM DRB) triggered by explicit L2 indicators.

In (NG)EN-DC and NR-DC, SRB3 can be used for measurement configuration and reporting, for UE assistance (re-)configuration and reporting for power savings, for IP address (re-)configuration and reporting for IAB-nodes, to (re-)configure MAC, RLC, BAP, physical layer and RLF timers and constants of the SCG configuration, and to reconfigure PDCP for DRBs associated with the S-K_{gNB} or SRB3, and to reconfigure SDAP for DRBs associated with S-K_{gNB} in NGEN-DC and NR-DC, and to add/modify/release conditional PSCell change configuration, provided that the (re-)configuration does not require any MN involvement, and to transmit RRC messages between the MN and the UE during fast MCG link recovery. In (NG)EN-DC and NR-DC, only measConfig, radioBearerConfig, conditionalReconfiguration, bap-Config, iab-IP-AddressConfigurationList, otherConfig and/or secondaryCellGroup are included in RRCReconfiguration received via SRB3, except when RRCReconfiguration is received within DLInformationTransferMRDC.

### Initiation

The network may initiate the RRC reconfiguration procedure to a UE in RRC_CONNECTED. The network applies the procedure as follows:
the establishment of RBs (other than SRB1, that is established during RRC connection establishment) is performed only when AS security has been activated;
the establishment of BH RLC channels for IAB is performed only when AS security has been activated;
the establishment of Uu relay RLC channels and PC5 relay RLC channels (other than SL-RLC0 and SL-RLC1) for L2 U2N relay UE is performed only when AS security has been activated, and the establishment of PC5 relay RLC channels for L2 U2N Remote UE (other than SL-RLC0 and SL-RLC1) is performed only when AS security has been activated;
the addition of secondary cell group and Scells is performed only when AS security has been activated;
the reconfigurationWithSync is included in secondaryCellGroup only when at least one RLC bearer or BH RLC channel is setup in SCG;
the reconfigurationWithSync is included in masterCellGroup only when AS security has been activated, and SRB2 with at least one DRB or multicast MRB or, for IAB, SRB2, are setup and not suspended;
the conditionalReconfiguration for CPC is included only when at least one RLC bearer is setup in SCG;
the conditionalReconfiguration for CHO or CPA is included only when AS security has been activated, and SRB2 with at least one DRB or multicast MRB or, for IAB, SRB2, are setup and not suspended; and
the ltm-CandidateConfig (LTM candidate cell configuration) for LTM is included only when AS security has been activated, and SRB2 with at least one DRB are setup and not suspended.

### Reception of an RRCReconfiguration by the UE

The UE may perform the following actions upon reception of the RRCReconfiguration, or upon execution of the conditional reconfiguration (CHO, CPA or CPC):

For LTM cell switch, how to generate the RRCReconfigurationComplete message is set out in the following.

Option 1: the RRCReconfigurationComplete message is generated upon the reception of LTM triggering MAC CE (or LTM cell switch execution) and then is sent to the target cell during LTM cell switch procedure (e.g., by Message 3 if random access procedure is performed or uplink data transmission if random access procedure is skipped (or not performed, i.e., RACH-less case). This Option 1 makes UE implementation simple because the UE cannot know to which cell the UE may perform LTM cell switch in advance.

NOTE: to reduce the processing delay for generation of RRCReconfiguration complete, the UE may generate the RRCReconfigurationComplete message for each LTM candidate cell configuration upon the reception of RRCReconfiguration message including the ltm-CandidateConfig (LTM candidate cell configuration) in advance, i.e., the UE can decide to send one of RRCReconfiguationComplete messages based on the received LTM triggering MAC CE in MAC entity for LTM cell switch procedure as shown in TABLE 2.

TABLE 2
1> if the LTM cell switch is triggered from lower layers (e.g., by receiving the LTM triggering
MAC CE in MAC entity or LTM cell switch execution) or if the target LTM candidate cell
configuration is applied due to a LTM candidate cell execution (In another embodiment, the
second RRCReconfigurationComplete message can be generated when the LTM cell switch
(LTM execution) is successfully completed.):
2> set the content of the RRCReconfigurationComplete message as follows:
3> include the LTM candidate cell configuration/information (e.g., cell identity or UE
identity or configuration index or configuration identity) for the target cell indicated from lower
layers (e.g., as indicated by LTM triggering MAC CE)
NOTE: In case this procedure is initiated due to the generation of a complete LTM candidate
cell configuration, the UE may generate only one RRCReconfigurationComplete message even
if it processes the LTM reference configuration and a LTM candidate cell configuration. The
RRCReconfigurationComplete message includes the contents for the target cell indicated by
LTM triggering MAC CE.
1> if the RRCReconfiguration message includes the ltm-CandidateConfig (LTM candidate cell
configuration):
2> perform the LTM configuration procedure as specified in 3.3.1.3;
1> set the content of the RRCReconfigurationComplete message as follows if the
RRCReconfiguration message does not include the ltm-CandidateConfig (LTM candidate cell
configuration):

NOTE: In case this procedure is initiated due to the generation of a complete LTM candidate cell configuration, the UE may generate only one RRCReconfigurationComplete message even if it processes the LTM reference configuration and a LTM candidate cell configuration. The RRCReconfigurationComplete message includes the contents for the target cell indicated by LTM triggering MAC CE as shown in TABLE 3.

TABLE 3
2> if the RRCReconfiguration includes the masterCellGroup containing the
reportUplinkTxDirectCurrent:
3> include the uplinkTxDirectCurrentList for each MCG serving cell with UL;
3> include uplinkDirectCurrentBWP-SUL for each MCG serving cell configured with SUL
carrier, if any, within the uplinkTxDirectCurrentList;
2> if the RRCReconfiguration includes the masterCellGroup containing the
reportUplinkTxDirectCurrentTwoCarrier:
3> include in the uplinkTxDirectCurrentTwoCarrierList the list of uplink Tx DC locations
for the configured intra-band uplink carrier aggregation in the MCG;
2> if the RRCReconfiguration includes the masterCellGroup containing the
reportUplinkTxDirectCurrentMoreCarrier:
3> include in the uplinkTxDirectCurrentMoreCarrierList the list of uplink Tx DC
locations for the configured intra-band uplink carrier aggregation in the MCG;
2> if the RRCReconfiguration includes the secondaryCellGroup containing the
reportUplinkTxDirectCurrent:
3> include the uplinkTxDirectCurrentList for each SCG serving cell with UL;
3> include uplinkDirectCurrentBWP-SUL for each SCG serving cell configured with SUL
carrier, if any, within the uplinkTxDirectCurrentList;
2> if the RRCReconfiguration includes the secondaryCellGroup containing the
reportUplinkTxDirectCurrentTwoCarrier:
3> include in the uplinkTxDirectCurrentTwoCarrierList the list of uplink Tx DC locations
for the configured intra-band uplink carrier aggregation in the SCG;
2> if the RRCReconfiguration includes the secondaryCellGroup containing the
reportUplinkTxDirectCurrentMoreCarrier:
3> include in the uplinkTxDirectCurrentMoreCarrierList the list of uplink Tx DC
locations for the configured intra-band uplink carrier aggregation in the SCG;

NOTE 0b: The UE does not expect that the reportUplinkTxDirectCurrentTwo Carrier or reportUplinkTxDirectCurrentMore Carrier is received in both masterCellGroup and in secondaryCellGroup. Network only configures at most one of reportUplinkTxDirectCurrent, reportUplinkTxDirectCurrentTwo Carrier or reportUplinkTxDirectCurrentMoreCarrier in one RRC message as shown in TABLE 4.

TABLE 4
2> if the RRCReconfiguration message includes the mrdc-SecondaryCellGroupConfig
with mrdc-SecondaryCellGroup set to eutra-SCG:
3> include in the eutra-SCG-Response the E-UTRA
RRCConnectionReconfigurationComplete message;
2> if the RRCReconfiguration message includes the mrdc-SecondaryCellGroupConfig with
mrdc-SecondaryCellGroup set to nr-SCG:
3> include in the nr-SCG-Response the SCG RRCReconfigurationComplete message;
3> if the RRCReconfiguration message is applied due to conditional reconfiguration
execution and the RRCReconfiguration message does not include the reconfigurationWithSync
in the masterCellGroup:
4> include in the selectedCondRRCReconfig the condReconfigId for the selected cell of
conditional reconfiguration execution;
2> if the RRCReconfiguration includes the reconfigurationWithSync in spCellConfig of an
MCG:
3> if the UE has logged measurements available for NR and if the RPLMN is included in
plmn-IdentityList stored in VarLogMeasReport:
4> include the logMeasAvailable in the RRCReconfigurationComplete message;
4> if Bluetooth measurement results are included in the logged measurements the UE has
available for NR:
5> include the logMeasAvailableBT in the RRCReconfigurationComplete message;
4> if WLAN measurement results are included in the logged measurements the UE has
available for NR:
5> include the logMeasAvailableWLAN in the RRCReconfigurationComplete message;
3> if the sigLoggedMeasType in VarLogMeasReport is included:
4> if T330 timer is running and the logged measurements configuration is for NR:
5> set sigLogMeasConfigAvailable to true in the RRCReconfigurationComplete message;
4> else:
5> if the UE has logged measurements available for NR:
6> set sigLogMeasConfigAvailable to false in the RRCReconfigurationComplete message;
3> if the UE has connection establishment failure or connection resume failure information
available in VarConnEstFailReport or VarConnEstFailReportList and if the RPLMN is equal
to plmn-Identity stored in VarConnEstFailReport or in at least one of the entries of
VarConnEstFailReportList:
4> include connEstFailInfoAvailable in the RRCReconfigurationComplete message;
3> if the UE has radio link failure or handover failure information available in VarRLF-
Report and if the RPLMN is included in plmn-IdentityList stored in VarRLF-Report; or
3> if the UE has radio link failure or handover failure information available in VarRLF-
Report and if the UE is capable of cross-RAT RLF reporting and if the RPLMN is included in
plmn-IdentityList stored in VarRLF-Report:
4> include rlf-InfoAvailable in the RRCReconfigurationComplete message;
3> if the UE was configured with successHO-Config when connected to the source Pcell;
and
3> if the applied RRCReconfiguration is not due to a conditional reconfiguration execution
upon cell selection performed while timer T311 was running, as defined in 5.3.7.3:
4> perform the actions for the successful handover report determination, upon successfully
completing the random access procedure triggered for the reconfigurationWithSync in
spCellConfig of the MCG;
3> if the UE has successful handover information available in VarSuccessHO-Report and
if the RPLMN is included in plmn-IdentityList stored in VarSuccessHO-Report:
4> include successHO-InfoAvailable in the RRCReconfigurationComplete message;
2> if the RRCReconfiguration message was received via SRB1, but not within mrdc-
SecondaryCellGroup or E-UTRA RRCConnectionReconfiguration or E-UTRA
RRCConnectionResume:
3> if the UE is configured to provide the measurement gap requirement information of NR
target bands:
4> if the RRCReconfiguration message includes the needForGapsConfigNR; or
4> if the NeedForGapsInfoNR information is changed compared to last time the UE
reported this information:
5> include the NeedForGapsInfoNR and set the contents as follows:
6> include intraFreq-needForGap and set the gap requirement information of intra-
frequency measurement for each NR serving cell;
6> if requestedTargetBandFilterNR is configured:
7> for each supported NR band that is also included in requestedTargetBandFilterNR,
include an entry in interFreq-needForGap and set the gap requirement information for that
band;
6> else:
7> include an entry in interFreq-needForGap and set the corresponding gap requirement
information for each supported NR band;
3> if the UE is configured to provide the measurement gap and NCSG requirement
information of NR target bands:
4> if the RRCReconfiguration message includes the needForGapNCSG-ConfigNR; or
4> if the needForGapNCSG-InfoNR information is changed compared to last time the UE
reported this information:
5> include the NeedForGapNCSG-InfoNR and set the contents as follows:
6> include intraFreq-needForNCSG and set the gap and NCSG requirement information
of intra-frequency measurement for each NR serving cell;
6> if requestedTargetBandFilterNCSG-NR is configured:
7> for each supported NR band included in requestedTargetBandFilterNCSG-NR, include
an entry in interFreq-needForNCSG and set the NCSG requirement information for that band;
6> else:
7> include an entry for each supported NR band in interFreq-needForNCSG and set the
corresponding NCSG requirement information;
3> if the UE is configured to provide the measurement gap and NCSG requirement
information of E-UTRA target bands:
4> if the RRCReconfiguration message includes the needForGapNCSG-ConfigEUTRA; or
4> if the needForGapNCSG-InfoEUTRA information is changed compared to last time the
UE reported this information:
5> include the NeedForGapNCSG-InfoEUTRA and set the contents as follows:
6> if requestedTargetBandFilterNCSG-EUTRA is configured, for each supported E-
UTRA band included in requestedTargetBandFilterNCSG-EUTRA, include an entry in
needForNCSG-EUTRA and set the NCSG requirement information for that band; otherwise,
include an entry for each supported E-UTRA band in needForNCSG-EUTRA and set the
corresponding NCSG requirement information;
2> if this procedure is initiated due to the generation of a complete LTM candidate cell
configuration:
3> the procedure ends.

Option 2: upon the reception of RRCReconfiguation, RRCReconfiguationComplete is generated corresponding to the RRCReconfiguration, and sent to the source cell (serving cell or the current cell UE received the RRCReconfiguration from). Another RRCReconfigurationComplete message is generated upon the reception of LTM triggering MAC CE (or LTM cell switch execution) and then is sent to the target cell during LTM cell switch procedure (e.g., by Message 3 if random access procedure is performed or uplink data transmission if random access procedure is skipped (or not performed, i.e., RACH-less case). This Option 2 has the network know the successful delivery of RRCReconfiguration and makes UE implementation simple because the UE cannot know to which cell UE may perform LTM cell switch in advance.

NOTE: To reduce the processing delay for generation of RRCReconfiguration complete, the UE may generate the RRCReconfigurationComplete message for each LTM candidate cell configuration upon the reception of RRCReconfiguration message including the ltm-CandidateConfig (LTM candidate cell configuration) in advance, i.e., the UE can decide to send one of RRCReconfiguationComplete messages based on the received LTM triggering MAC CE in MAC entity for LTM cell switch procedure as shown in TABLE 5.

TABLE 5
1> if the LTM cell switch is triggered from lower layers (e.g., by receiving the LTM triggering
MAC CE in MAC entity or LTM cell switch execution) or if the target LTM candidate cell
configuration is applied due to a LTM candidate cell execution (In another embodiment, the
second RRCReconfigurationComplete message can be generated when the LTM cell switch
(LTM execution) is successfully completed.):
2> set the content of the RRCReconfigurationComplete message as follows:
3> include the LTM candidate cell configuration/information (e.g., cell identity or UE
identity or configuration index or configuration identity) for the target cell indicated from lower
layers (e.g., as indicated by LTM triggering MAC CE)
NOTE: In case this procedure is initiated due to the generation of a complete LTM candidate
cell configuration, the UE may generate only one RRCReconfigurationComplete message even
if it processes the LTM reference configuration and a LTM candidate cell configuration. The
RRCReconfigurationComplete message includes the contents for the target cell indicated by
LTM triggering MAC CE.
1> if the RRCReconfiguration message includes the ltm-CandidateConfig (LTM candidate cell
configuration):
2> perform the LTM configuration procedure as specified in 3.3.1.3;
1> set the content of the RRCReconfigurationComplete message as follows:

NOTE: In case this procedure is initiated due to the generation of a complete LTM candidate cell configuration, the UE may generate only one RRCReconfiguration Complete message even if it processes the LTM reference configuration and a LTM candidate cell configuration. The RRCReconfigurationComplete message includes the contents for the target cell indicated by LTM triggering MAC CE as shown in TABLE 6.

TABLE 6
2> if the RRCReconfiguration includes the masterCellGroup containing the
reportUplinkTxDirectCurrent:
3> include the uplinkTxDirectCurrentList for each MCG serving cell with UL;
3> include uplinkDirectCurrentBWP-SUL for each MCG serving cell configured with SUL
carrier, if any, within the uplinkTxDirectCurrentList;
2> if the RRCReconfiguration includes the masterCellGroup containing the
reportUplinkTxDirectCurrentTwoCarrier:
3> include in the uplinkTxDirectCurrentTwoCarrierList the list of uplink Tx DC locations
for the configured intra-band uplink carrier aggregation in the MCG;
2> if the RRCReconfiguration includes the masterCellGroup containing the
reportUplinkTxDirectCurrentMoreCarrier:
3> include in the uplinkTxDirectCurrentMoreCarrierList the list of uplink Tx DC
locations for the configured intra-band uplink carrier aggregation in the MCG;
2> if the RRCReconfiguration includes the secondaryCellGroup containing the
reportUplinkTxDirectCurrent:
3> include the uplinkTxDirectCurrentList for each SCG serving cell with UL;
3> include uplinkDirectCurrentBWP-SUL for each SCG serving cell configured with SUL
carrier, if any, within the uplinkTxDirectCurrentList;
2> if the RRCReconfiguration includes the secondaryCellGroup containing the
reportUplinkTxDirectCurrentTwoCarrier:
3> include in the uplinkTxDirectCurrentTwoCarrierList the list of uplink Tx DC locations
for the configured intra-band uplink carrier aggregation in the SCG;
2> if the RRCReconfiguration includes the secondaryCellGroup containing the
reportUplinkTxDirectCurrentMoreCarrier:
3> include in the uplinkTxDirectCurrentMoreCarrierList the list of uplink Tx DC
locations for the configured intra-band uplink carrier aggregation in the SCG;

NOTE 0b: The UE does not expect that the reportUplinkTxDirectCurrentTwoMCarrier or reportUplinkTxDirectCurrentMoreCarrier is received in both masterCellGroup and in secondaryCellGroup. Network only configures at most one of reportUplinkTxDirectCurrent, reportUplinkTxDirectCurrentTwoCarrier as shown in TABLE 7.

TABLE 7
reportUplinkTxDirectCurrentMoreCarrier in one RRC message.
2> if the RRCReconfiguration message includes the mrdc-SecondaryCellGroupConfig
with mrdc-SecondaryCellGroup set to eutra-SCG:
3> include in the eutra-SCG-Response the E-UTRA
RRCConnectionReconfigurationComplete message;
2> if the RRCReconfiguration message includes the mrdc-SecondaryCellGroupConfig with
mrdc-SecondaryCellGroup set to nr-SCG:
3> include in the nr-SCG-Response the SCG RRCReconfigurationComplete message;
3> if the RRCReconfiguration message is applied due to conditional reconfiguration
execution and the RRCReconfiguration message does not include the reconfigurationWithSync
in the masterCellGroup:
4> include in the selectedCondRRCReconfig the condReconfigId for the selected cell of
conditional reconfiguration execution;
2> if the RRCReconfiguration includes the reconfigurationWithSync in spCellConfig of an
MCG:
3> if the UE has logged measurements available for NR and if the RPLMN is included in
plmn-IdentityList stored in VarLogMeasReport:
4> include the logMeasAvailable in the RRCReconfigurationComplete message;
4> if Bluetooth measurement results are included in the logged measurements the UE has
available for NR:
5> include the logMeasAvailableBT in the RRCReconfigurationComplete message;
4> if WLAN measurement results are included in the logged measurements the UE has
available for NR:
5> include the logMeasAvailableWLAN in the RRCReconfigurationComplete message;
3> if the sigLoggedMeasType in VarLogMeasReport is included:
4> if T330 timer is running and the logged measurements configuration is for NR:
5> set sigLogMeasConfigAvailable to true in the RRCReconfigurationComplete message;
4> else:
5> if the UE has logged measurements available for NR:
6> set sigLogMeasConfigAvailable to false in the RRCReconfigurationComplete message;
3> if the UE has connection establishment failure or connection resume failure information
available in VarConnEstFailReport or VarConnEstFailReportList and if the RPLMN is equal
to plmn-Identity stored in VarConnEstFailReport or in at least one of the entries of
VarConnEstFailReportList:
4> include connEstFailInfoAvailable in the RRCReconfigurationComplete message;
3> if the UE has radio link failure or handover failure information available in VarRLF-
Report and if the RPLMN is included in plmn-IdentityList stored in VarRLF-Report; or
3> if the UE has radio link failure or handover failure information available in VarRLF-
Report and if the UE is capable of cross-RAT RLF reporting and if the RPLMN is included in
plmn-IdentityList stored in VarRLF-Report :
4> include rlf-InfoAvailable in the RRCReconfigurationComplete message;
3> if the UE was configured with successHO-Config when connected to the source Pcell;
and
3> if the applied RRCReconfiguration is not due to a conditional reconfiguration execution
upon cell selection performed while timer T311 was running:
4> perform the actions for the successful handover report determination, upon successfully
completing the random access procedure triggered for the reconfigurationWithSync in
spCellConfig of the MCG;
3> if the UE has successful handover information available in VarSuccessHO-Report and
if the RPLMN is included in plmn-IdentityList stored in VarSuccessHO-Report:
4> include successHO-InfoAvailable in the RRCReconfigurationComplete message;
2> if the RRCReconfiguration message was received via SRB1, but not within mrdc-
SecondaryCellGroup or E-UTRA RRCConnectionReconfiguration or E-UTRA
RRCConnectionResume:
3> if the UE is configured to provide the measurement gap requirement information of NR
target bands:
4> if the RRCReconfiguration message includes the needForGapsConfigNR; or
4> if the NeedForGapsInfoNR information is changed compared to last time the UE
reported this information:
5> include the NeedForGapsInfoNR and set the contents as follows:
6> include intraFreq-needForGap and set the gap requirement information of intra-
frequency measurement for each NR serving cell;
6> if requestedTargetBandFilterNR is configured:
7> for each supported NR band that is also included in requestedTargetBandFilterNR,
include an entry in interFreq-needForGap and set the gap requirement information for that
band;
6> else:
7> include an entry in interFreq-needForGap and set the corresponding gap requirement
information for each supported NR band;
3> if the UE is configured to provide the measurement gap and NCSG requirement
information of NR target bands:
4> if the RRCReconfiguration message includes the needForGapNCSG-ConfigNR; or
4> if the needForGapNCSG-InfoNR information is changed compared to last time the UE
reported this information:
5> include the NeedForGapNCSG-InfoNR and set the contents as follows:
6> include intraFreq-needForNCSG and set the gap and NCSG requirement information
of intra-frequency measurement for each NR serving cell;
6> if requestedTargetBandFilterNCSG-NR is configured:
7> for each supported NR band included in requestedTargetBandFilterNCSG-NR, include
an entry in interFreq-needForNCSG and set the NCSG requirement information for that band;
6> else:
7> include an entry for each supported NR band in interFreq-needForNCSG and set the
corresponding NCSG requirement information;
3> if the UE is configured to provide the measurement gap and NCSG requirement
information of E-UTRA target bands:
4> if the RRCReconfiguration message includes the needForGapNCSG-ConfigEUTRA; or
4> if the needForGapNCSG-InfoEUTRA information is changed compared to last time the
UE reported this information:
5> include the NeedForGapNCSG-InfoEUTRA and set the contents as follows:
6> if requestedTargetBandFilterNCSG-EUTRA is configured, for each supported E-
UTRA band included in requestedTargetBandFilterNCSG-EUTRA, include an entry in
needForNCSG-EUTRA and set the NCSG requirement information for that band; otherwise,
include an entry for each supported E-UTRA band in needForNCSG-EUTRA and set the
corresponding NCSG requirement information;
2> if this procedure is initiated due to the generation of a complete LTM candidate cell
configuration:
3> the procedure ends.

Option 3: upon the reception of RRCReconfiguation, RRCReconfiguationComplete is generated corresponding to the RRCReconfiguration, and sent to the source cell (serving cell or the current cell UE received the RRCReconfiguration from). A RRCReconfigurationComplete message is generated and sent to the target LTM cell if the random access procedure is triggered upon the reception of LTM triggering MAC CE (or LTM cell switch execution) (e.g., by Message 3). However, the RRCReconfigurationComplete message is not generated and not sent to the target LTM Cell if the random access procedure is not triggered or not performed (i.e., skipped (RACH-less case) upon the reception of LTM triggering MAC CE (or LTM cell switch execution). The UE can perform the uplink data transmission without RRCReconfigurationComplete message (i.e., only with user plane data). This Option 3 reduces the signalling overhead on top of the benefits of Option2.

NOTE: to reduce the processing delay for generation of RRCReconfiguration complete, the UE may generate the RRCReconfigurationComplete message for each LTM candidate cell configuration upon the reception of RRCReconfiguration message including the ltm-CandidateConfig (LTM candidate cell configuration) in advance, i.e., the UE can decide to send one of RRCReconfiguationComplete messages based on the received LTM triggering MAC CE in MAC entity for LTM cell switch procedure as shown in TABLE 8.

TABLE 8
1> if the LTM cell switch is triggered from lower layers (e.g., by receiving the LTM triggering
MAC CE in MAC entity or LTM cell switch execution) or if the target LTM candidate cell
configuration is applied due to a LTM candidate cell execution or the random access procedure
is triggered (or if lower layers (i.e., MAC layer) indicate that a random access procedure is
needed for LTM Cell execution or if BFI_COUNTER >= beamFailureInstanceMaxCount for
the target LTM candidate cell or the timeAlignmentTimer associated with the target LTM
candidate cell (or TAG that the target LTM cell belongs to) is not running or if the first MAC
CE does not include TA value (i.e., timing advance command) or if the first MAC CE indicates
that a Random access procedure is needed by indicator (e.g., special TA value)) (In another
embodiment, the second RRCReconfigurationComplete message can be generated when the
LTM cell switch (LTM execution) is successfully completed.):
2> set the content of the RRCReconfigurationComplete message as follows:
3> include the LTM candidate cell configuration/information (e.g., cell identity or UE
identity or configuration index or configuration identity) for the target cell indicated from lower
layers (e.g., as indicated by LTM triggering MAC CE)

NOTE: In case this procedure is initiated due to the generation of a complete LTM candidate cell configuration, the UE may generate only one RRCReconfiguration Complete message even if it processes the LTM reference configuration and a LTM candidate cell configuration. The RRCReconfigurationComplete message includes the contents for the target cell indicated by LTM triggering MAC CE as shown in TABLE 9.

TABLE 9
1> if the RRCReconfiguration message includes the ltm-CandidateConfig (LTM candidate cell
configuration):
2> perform the LTM configuration procedure as specified in 3.3.1.3;
1> set the content of the RRCReconfigurationComplete message as follows:

NOTE: In case this procedure is initiated due to the generation of a complete LTM candidate cell configuration, the UE may generate only one RRCReconfigurationComplete message even if it processes the LTM reference configuration and a LTM candidate cell configuration. The RRCReconfigurationComplete message includes the contents for the target cell indicated by LTM triggering MAC CE as shown in TABLE 10.

TABLE 10
2> if the RRCReconfiguration includes the masterCellGroup containing the
reportUplinkTxDirectCurrent:
3> include the uplinkTxDirectCurrentList for each MCG serving cell with UL;
3> include uplinkDirectCurrentBWP-SUL for each MCG serving cell configured with SUL
carrier, if any, within the uplinkTxDirectCurrentList;
2> if the RRCReconfiguration includes the masterCellGroup containing the
reportUplinkTxDirectCurrentTwoCarrier:
3> include in the uplinkTxDirectCurrentTwoCarrierList the list of uplink Tx DC locations
for the configured intra-band uplink carrier aggregation in the MCG;
2> if the RRCReconfiguration includes the masterCellGroup containing the
reportUplinkTxDirectCurrentMoreCarrier:
3> include in the uplinkTxDirectCurrentMoreCarrierList the list of uplink Tx DC
locations for the configured intra-band uplink carrier aggregation in the MCG;
2> if the RRCReconfiguration includes the secondaryCellGroup containing the
reportUplinkTxDirectCurrent:
3> include the uplinkTxDirectCurrentList for each SCG serving cell with UL;
3> include uplinkDirectCurrentBWP-SUL for each SCG serving cell configured with SUL
carrier, if any, within the uplinkTxDirectCurrentList;
2> if the RRCReconfiguration includes the secondaryCellGroup containing the
reportUplinkTxDirectCurrentTwoCarrier:
3> include in the uplinkTxDirectCurrentTwoCarrierList the list of uplink Tx DC locations
for the configured intra-band uplink carrier aggregation in the SCG;
2> if the RRCReconfiguration includes the secondaryCellGroup containing the
reportUplinkTxDirectCurrentMoreCarrier:
3> include in the uplinkTxDirectCurrentMoreCarrierList the list of uplink Tx DC
locations for the configured intra-band uplink carrier aggregation in the SCG;

NOTE 0b: The UE does not expect that the reportUplinkTxDirectCurrentTwo Carrier or reportUplinkTxDirectCurrentMore Carrier is received in both masterCellGroup and in secondaryCellGroup. Network only configures at most one of reportUplinkTxDirectCurrent, reportUplinkTxDirectCurrentTwo Carrier or reportUplinkTxDirectCurrentMoreCarrier in one RRC message as shown in TABLE 11.

TABLE 11
2> if the RRCReconfiguration message includes the mrdc-SecondaryCellGroupConfig
with mrdc-SecondaryCellGroup set to eutra-SCG:
3> include in the eutra-SCG-Response the E-UTRA
RRCConnectionReconfigurationComplete message;
2> if the RRCReconfiguration message includes the mrdc-SecondaryCellGroupConfig with
mrdc-SecondaryCellGroup set to nr-SCG:
3> include in the nr-SCG-Response the SCG RRCReconfigurationComplete message;
3> if the RRCReconfiguration message is applied due to conditional reconfiguration
execution and the RRCReconfiguration message does not include the reconfigurationWithSync
in the masterCellGroup:
4> include in the selectedCondRRCReconfig the condReconfigId for the selected cell of
conditional reconfiguration execution;
2> if the RRCReconfiguration includes the reconfigurationWithSync in spCellConfig of an
MCG:
3> if the UE has logged measurements available for NR and if the RPLMN is included in
plmn-IdentityList stored in VarLogMeasReport:
4> include the logMeasAvailable in the RRCReconfigurationComplete message;
4> if Bluetooth measurement results are included in the logged measurements the UE has
available for NR:
5> include the logMeasAvailableBT in the RRCReconfigurationComplete message;
4> if WLAN measurement results are included in the logged measurements the UE has
available for NR:
5> include the logMeasAvailableWLAN in the RRCReconfigurationComplete message;
3> if the sigLoggedMeasType in VarLogMeasReport is included:
4> if T330 timer is running and the logged measurements configuration is for NR:
5> set sigLogMeasConfigAvailable to true in the RRCReconfigurationComplete message;
4> else:
5> if the UE has logged measurements available for NR:
6> set sigLogMeasConfigAvailable to false in the RRCReconfigurationComplete message;
3> if the UE has connection establishment failure or connection resume failure information
available in VarConnEstFailReport or VarConnEstFailReportList and if the RPLMN is equal
to plmn-Identity stored in VarConnEstFailReport or in at least one of the entries of
VarConnEstFailReportList:
4> include connEstFailInfoAvailable in the RRCReconfigurationComplete message;
3> if the UE has radio link failure or handover failure information available in VarRLF-
Report and if the RPLMN is included in plmn-IdentityList stored in VarRLF-Report; or
3> if the UE has radio link failure or handover failure information available in VarRLF-
Report and if the UE is capable of cross-RAT RLF reporting and if the RPLMN is included in
plmn-IdentityList stored in VarRLF-Report:
4> include rlf-InfoAvailable in the RRCReconfigurationComplete message;
3> if the UE was configured with successHO-Config when connected to the source Pcell;
and
3> if the applied RRCReconfiguration is not due to a conditional reconfiguration execution
upon cell selection performed while timer T311 was running, as defined in 5.3.7.3:
4> perform the actions for the successful handover report determination, upon successfully
completing the random access procedure triggered for the reconfigurationWithSync in
spCellConfig of the MCG;
3> if the UE has successful handover information available in VarSuccessHO-Report and
if the RPLMN is included in plmn-IdentityList stored in VarSuccessHO-Report:
4> include successHO-InfoAvailable in the RRCReconfigurationComplete message;
2> if the RRCReconfiguration message was received via SRB1, but not within mrdc-
SecondaryCellGroup or E-UTRA RRCConnectionReconfiguration or E-UTRA
RRCConnectionResume:
3> if the UE is configured to provide the measurement gap requirement information of NR
target bands:
4> if the RRCReconfiguration message includes the needForGapsConfigNR; or
4> if the NeedForGapsInfoNR information is changed compared to last time the UE
reported this information:
5> include the NeedForGapsInfoNR and set the contents as follows:
6> include intraFreq-needForGap and set the gap requirement information of intra-
frequency measurement for each NR serving cell;
6> if requestedTargetBandFilterNR is configured:
7> for each supported NR band that is also included in requestedTargetBandFilterNR,
include an entry in interFreq-needForGap and set the gap requirement information for that
band;
6> else:
7> include an entry in interFreq-needForGap and set the corresponding gap requirement
information for each supported NR band;
3> if the UE is configured to provide the measurement gap and NCSG requirement
information of NR target bands:
4> if the RRCReconfiguration message includes the needForGapNCSG-ConfigNR; or
4> if the needForGapNCSG-InfoNR information is changed compared to last time the UE
reported this information:
5> include the NeedForGapNCSG-InfoNR and set the contents as follows:
6> include intraFreq-needForNCSG and set the gap and NCSG requirement information
of intra-frequency measurement for each NR serving cell;
6> if requestedTargetBandFilterNCSG-NR is configured:
7> for each supported NR band included in requestedTargetBandFilterNCSG-NR, include
an entry in interFreq-needForNCSG and set the NCSG requirement information for that band;
6> else:
7> include an entry for each supported NR band in interFreq-needForNCSG and set the
corresponding NCSG requirement information;
3> if the UE is configured to provide the measurement gap and NCSG requirement
information of E-UTRA target bands:
4> if the RRCReconfiguration message includes the needForGapNCSG-ConfigEUTRA; or
4> if the needForGapNCSG-InfoEUTRA information is changed compared to last time the
UE reported this information:
5> include the NeedForGapNCSG-InfoEUTRA and set the contents as follows:
6> if requestedTargetBandFilterNCSG-EUTRA is configured, for each supported E-
UTRA band included in requestedTargetBandFilterNCSG-EUTRA, include an entry in
needForNCSG-EUTRA and set the NCSG requirement information for that band; otherwise,
include an entry for each supported E-UTRA band in needForNCSG-EUTRA and set the
corresponding NCSG requirement information;
2> if this procedure is initiated due to the generation of a complete LTM candidate cell
configuration:
3> the procedure ends.

The following relates to the RRCReconfigurationComplete procedure.

As set out, RRCReconfigurationComplete message is generated and transmitted to the target LTM candidate cell during LTM execution procedure or when the target LTM cell configuration (indicated by the configuration Identity in the first MAC CE) is applied or upon the reception of the first MAC CE in Option 1, Option 2, or Option 3 (e.g., if the random access procedure (or RACH-less solution) is triggered upon the reception of LTM triggering MAC CE).

For Option 1, Option 2, or Option 3, how to submit the RRCReconfigurationComplete message via which SRB during LTM execution procedure, which is also extended to the dual connectivity scenario (e.g., for the UE configured with MCG and SCG) is set out. As described, the LTM candidate cell configurations can be configured via SRB1 or split SRB 1 or SRB3 by RRCReconfiguration message. The LTM candidate cell configurations for MCG or SCG can be configured via SRB1 or split SRB1 or SRB3 by RRCReconfiguration message. The RRCReconfiguration message including LTM candidate cell configurations does not include reconfigurationWithSync to avoid RRC message triggered handover.

The UE configured with single connectivity (i.e., MCG only) or not configured with dual connectivity (i.e., MCG and SCG or MCG) can be configured with LTM candidate cell configurations (e.g., for MCG) by the reception of a first RRCReconfiguration message via SRB1. Then, a first RRCReconfigurationComplete message corresponding to the first RRCReconfiguration can be generated and sent to the source serving cell (Master gNB, i.e., MCG) via SRB1 where sent the first RRCReconfiguration message to UE. When the UE receives the first MAC CE including the target LTM configuration ID (Identity) from the source serving cell, the UE can apply the corresponding target LTM configuration (e.g., for MCG) (or RRCReconfiguration for the target LTM cell of MCG) indicated by the configuration ID in the first MAC CE. Upon the reception of the first MAC CE or the application of the target LTM configuration, the UE generates a second RRCReconfigurationComplete corresponding the target LTM configuration with the contents (e.g., configuration ID or information for the target LTM configuration or reply or confirmation) and sends to the target cell (or gNB or MCG) via SRB1. In another embodiment, the second RRCReconfigurationComplete message can be generated when the LTM cell switch (LTM execution) is successfully completed.

Furthermore, the first RRCReconfigurationComplete is submitted as follows (which can be also applied to the UE configured with dual connectivity) as shown in TABLE 12.

TABLE 12
1> if the UE is configured with E-UTRA nr-SecondaryCellGroupConfig (UE in (NG)EN-
DC):
2> submit the first RRCReconfigurationComplete via E-UTRA;
1> else if the first RRCReconfiguration message was received via SRB3 (UE in NR-DC):
2> if the first RRCReconfiguration message was received within DLInformationTransferMRDC:
3> if the first RRCReconfiguration message was received within the nr-SCG within mrdc-
SecondaryCellGroup (NR SCG RRC Reconfiguration):
4> perform SCG reconfiguration accordingly:
3> else (e.g., first RRCReconfiguration message was received within master cell group
configuration (NR MCG RRCReconfiguration):
4> submit the first RRCReconfigurationComplete message via SRB1 to lower layers for
transmission using the new configuration;
2> else:
3> submit the first RRCReconfigurationComplete message via SRB3 to lower layers for
transmission using the new configuration;
1> else (the first RRCReconfiguration was received via SRB1):
2> submit the first RRCReconfigurationComplete message via SRB1 to lower layers for
transmission using the new configuration;

The UE configured with dual connectivity (i.e., MCG and SCG) can be configured with LTM candidate cell configurations (e.g., for MCG or SCG) by the reception of a first RRCReconfiguration message via SRB1 (or split SRB1) or SRB3. a first RRCReconfigurationComplete message corresponding to the first RRCReconfiguration can be generated and sent to the source serving cell.

For each case of dual connectivity, how to submit the second RRCReconfigurationComplete is as follows.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if the UE is configured with E-UTRA nr-SecondaryCellGroupConfig (UE in (NG)EN-DC), the UE submits the second RRCReconfigurationComplete via E-UTRA. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if the RRCReconfiguration message (or LTM candidate configuration for SCG) was received via SRB1 within the nr-SCG within mrdc-SecondaryCellGroup (UE in NR-DC, mrdc-SecondaryCellGroup was received in RRCReconfiguration or RRCResume via SRB1), the UE submits the second RRCReconfigurationComplete message (e.g., to SCG or MCG via SRB1 (or via split SRB1)) via the NR MCG embedded in NR RRC message ULInformationTransferMRDC. In another embodiment, the second RRCReconfigurationComplete message can be generated when the LTM cell switch (LTM execution) is successfully completed.

If a UE is configured with received via SRB3 (UE in NR-DC) and if the RRCReconfiguration message (or LTM candidate configuration for SCG) was received within DLInformationTransferMRDC and if the RRCReconfiguration message was not received within the nr-SCG within mrdc-SecondaryCellGroup (i.e., it's not NR SCG RRC reconfiguration, or if target LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if the RRCReconfiguration message (or LTM candidate configuration for SCG) was LTM candidate configuration was received within master cell group configuration (i.e., it's NR MCG RRCReconfiguration), the UE submits the second RRCReconfigurationComplete message via SRB1 to lower layers for transmission using the new configuration because DLInformationTransferMRDC includes the configuration from MCG, which need to be sent to MCG via SRB1. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if the RRCReconfiguration message (or LTM candidate configuration for SCG) was received via SRB3 (UE in NR-DC) and if the RRCReconfiguration message (or LTM candidate configuration for SCG) was not received within DLInformationTransferMRDC, the UE submits the second RRCReconfigurationComplete message via SRB3 to lower layers for transmission using the new configuration because the configuration corresponds to SCG, which need to be sent to SCG via SRB3. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if RRCReconfiguration (or LTM candidate configuration for SCG) was received via SRB1, the UE submits the RRCReconfigurationComplete message via SRB1 to lower layers for transmission using the new configuration. In another embodiment, the second RRCReconfigurationComplete message can be generated when the LTM cell switch (LTM execution) is successfully completed.

To implement the details described above, specifically, the UE may perform the following actions upon reception of the RRCReconfiguration, or upon execution of the conditional reconfiguration (CHO, CPA or CPC) or upon execution of LTM procedure (or LTM cell switch) as shown in TABLE 13.

TABLE 13
1> if the LTM cell switch is triggered from lower layers (e.g., by receiving the LTM triggering
MAC CE in MAC entity or LTM cell switch execution) or if the target LTM candidate cell
configuration is applied due to a LTM candidate cell execution:
2> set the content of the second RRCReconfigurationComplete message as follows:
3> include the LTM candidate cell configuration/information (e.g., cell identity or UE
identity or configuration index or configuration identity) for the target cell indicated from lower
layers (e.g., as indicated by LTM triggering MAC CE)
3> if the RRCReconfiguration message includes the mrdc-SecondaryCellGroupConfig with
mrdc-SecondaryCellGroup set to nr-SCG:
4> include in the nr-SCG-Response the SCG RRCReconfigurationComplete message;
4> if the RRCReconfiguration message is applied due to conditional reconfiguration
execution and the RRCReconfiguration message does not include the reconfigurationWithSync
in the masterCellGroup:
5> include in the selectedCondRRCReconfig the condReconfigId for the selected cell of
conditional reconfiguration execution;
4> if the RRCReconfiguration (or target LTM candidate configuration) is applied due to a
LTM candidate cell execution for LTM cell switch (e.g., triggered by the reception of the first
MAC CE) which can be configured via LTM candidate cell configuration contained in nr-SCG
within mrdc-SecondaryCellGroup:
5> include in the selected LTM candidate configuration the configuration ID (Identity) for
the selected LTM candidate cell of LTM execution. The configuration ID can be indicated by
the first MAC CE;

To ease the network implementation for handling of the second RRCReconfigurationComplete messages, that the second RRCReconfigurationComplete is submitted as shown in TABLE 14.

TABLE 14
1> if the UE is configured with E-UTRA nr-SecondaryCellGroupConfig (UE in (NG)EN-
DC):
2> submit the second RRCReconfigurationComplete via E-UTRA;
1> else if the RRCReconfiguration message (or target LTM candidate configuration) was
received via SRB1 within the nr-SCG within mrdc-SecondaryCellGroup (UE in NR-DC, mrdc-
SecondaryCellGroup was received in RRCReconfiguration or RRCResume via SRB1):
2> if the RRCReconfiguration is applied due to a conditional reconfiguration execution for
CPC which is configured via conditionalReconfiguration contained in nr-SCG within mrdc-
SecondaryCellGroup; or
2> if the RRCReconfiguration (or target LTM candidate configuration) is applied due to a
LTM candidate cell execution for LTM cell switch (e.g., triggered by the reception of the first
MAC CE) which can be configured via LTM candidate cell configuration contained in nr-SCG
within mrdc-SecondaryCellGroup:
3> submit the second RRCReconfigurationComplete message (e.g., to SCG or MCG via
SRB1 (or via split SRB1)) via the NR MCG embedded in NR RRC message
ULInformationTransferMRDC, e.g., The UE may set the contents of the
ULInformationTransferMRDC message as follows: if there is a need to transfer MR-DC
dedicated information related to NR, the UE sets the ul-DCCH-MessageNR to include the NR
MR-DC dedicated information to be transferred (e.g., NR RRC MeasurementReport,
UEAssistanceInformation, FailureInformation, RRCReconfigurationComplete,
MCGFailureInformation, or IABOtherInformation message.
1> else if the RRCReconfiguration message (or target LTM candidate configuration) was
received via SRB3 (UE in NR-DC):
2> if the RRCReconfiguration message (or target LTM candidate configuration) was
received within DLInformationTransferMRDC:
3> if the RRCReconfiguration message was received within the nr-SCG within mrdc-
SecondaryCellGroup (NR SCG RRC Reconfiguration):
4> perform SCG reconfiguration accordingly:
3> else (e.g., target LTM candidate configuration was received within master cell group
configuration (NR MCG RRCReconfiguration):
4> submit the second RRCReconfigurationComplete message via SRB1 to lower layers for
transmission using the new configuration;
2> else:
3> submit the second RRCReconfigurationComplete message via SRB3 to lower layers for
transmission using the new configuration;
1> else (RRCReconfiguration (or target LTM candidate configuration) was received via
SRB1):
2> submit the second RRCReconfigurationComplete message via SRB1 to lower layers for
transmission using the new configuration;

The DLInformationTransferMRDC message is used for the downlink transfer of RRC messages during fast MCG link recovery via SRB3 while the ULInformationTransferMRDC message is used for the uplink transfer of MR-DC dedicated information via SRB 1 or SRB3 (e.g., for transferring the NR or E-UTRA RRC MeasurementReport message, the FailureInformation message, the UEAssistanceInformation message, the RRCReconfigurationComplete message, the IABOtherInformation message or the NR or E-UTRA RRC MCGFailureInformation message).

In another embodiment, the UE configured with dual connectivity (i.e., MCG and SCG) can be configured with LTM candidate cell configurations (e.g., for MCG or SCG) by the reception of a first RRCReconfiguration message via SRB 1 (or split SRB 1) or SRB3. a first RRCReconfigurationComplete message corresponding to the first RRCReconfiguration can be generated and sent to the source serving cell.

For each case of dual connectivity, how to submit the second RRCReconfigurationComplete is as follows.

If a UE is configured with LTM candidate cell configuration for MCG or if the LTM cell switch is triggered from lower layers (e.g., by receiving the LTM triggering MAC CE from MCG in MAC entity of MCG or LTM cell switch execution in MCG) or if the target LTM candidate cell configuration for MCG is applied due to a LTM candidate cell execution, the UE generates the second RRCReconfigurationComplete message. And then, if RRCReconfiguration (or LTM candidate configuration for MCG) was received via SRB1, the UE submits the RRCReconfigurationComplete message via SRB1 to lower layers for transmission using the new configuration. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if the RRCReconfiguration message (or LTM candidate configuration for SCG) was received via SRB1 within the nr-SCG within mrdc-SecondaryCellGroup (UE in NR-DC, mrdc-SecondaryCellGroup was received in RRCReconfiguration or RRCResume via SRB1), the UE submits the second RRCReconfigurationComplete message (e.g., to SCG or MCG via SRB1 (or via split SRB1)) via the NR MCG embedded in NR RRC message ULInformationTransferMRDC. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if the RRCReconfiguration message (or LTM candidate configuration for SCG) was received via SRB3 (UE in NR-DC) and if the RRCReconfiguration message (or LTM candidate configuration for SCG) was not received within DLInformationTransferMRDC, the UE submits the second RRCReconfigurationComplete message via SRB3 to lower layers for transmission using the new configuration because the configuration corresponds to SCG, which need to be sent to SCG via SRB3 and the DLInformationTransferMRDC message is used for the downlink transfer of RRC messages during fast MCG link recovery. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, the UE generates the second RRCReconfigurationComplete message. And then, if RRCReconfiguration (or LTM candidate configuration for SCG) was received via SRB1, the UE submits the RRCReconfigurationComplete message via SRB1 to lower layers for transmission using the new configuration. In another embodiment, the second RRCReconfigurationComplete message can be generated when the LTM cell switch (LTM execution) is successfully completed.

The following relates to LTM configuration and execution.

In this disclosure, the LTM configuration for candidate cells can indicate the reference configuration for LTM candidate cells or the complete configuration for LTM candidate cells. The reference configuration can be the complete configuration or the reference configuration and a LTM candidate-cell specific configuration can be the complete configuration for the LTM candidate cell.

The UE may perform the following actions based on a received LTM-CandidateConfig IE as shown in TABLE 15.

TABLE 15
1> store the received ltm-ReferenceConfiguration in VarLTM-Config, if present;
1> if the LTM-CandidateConfig includes the ltm-CandidateToReleaseList:
2> perform the LTM candidate cell release;
1> if the LTM-CandidateConfig includes the ltm-CandidateToAddModList:
2> perform the LTM candidate cell addition or reconfiguration;
1> perform the actions to generate a complete LTM configuration;

NOTE X: It is up to the UE implementation to postpone the generation of a complete LTM configuration until the executing of an LTM cell switch.

In relation to LTM candidate cell release, The UE may, as shown in TABLE 16.

TABLE 16
1> for each ltm-CandidateId in the ltm-CandidateToReleaseList:
2> if the current VarLTM-Config includes an ltm-Candidate with the given ltm-
CandidateId:
3> release the ltm-Candidate from VarLTM-Config;

In relation to LTM candidate cell addition/modification, the UE may, as shown in TABLE 17.

TABLE 17
1> for each ltm-CandidateId in the ltm-CandidateToAddModList:
2> if the current VarLTM-Config includes an ltm-Candidate with the given ltm-
CandidateId:
3> modify the ltm-Candidate within VarLTM-Config in accordance with the received ltm-
Candidate;
2> else:
3> add the received ltm-Candidate to VarLTM-Config.

The following relates to Generation of UE LTM configuration.

The purpose of this procedure is for the UE to generate a complete LTM candidate cell configuration (or LTM candidate cell configuration) for each LTM candidate cell to be stored and the LTM candidate cell configuration for the target cell indicated by lower layers (i.e., as indicated by LTM triggering MAC CE) is applied only when an indication of an LTM cell switch is received by lower layers. During the generation of a complete LTM candidate cell configuration, the current UE configuration may not be modified.

The UE may, as shown in TABLE 18.

TABLE 18
1> for each ltm-Candidate in ltm-CandidateConfigList within VarLTM-Config;
2> store the ltm-CandidateId included in ltm-Candidate within VarLTM-UE-Config;
2> if ltm-Candidate includes ltm-ConfigComplete;
3> generate a complete LTM candidate cell configuration for the received ltm-Candidate
according to the actions and store it in ue-LTM-Config within VarLTM-UE-Config.
2> else:
3> generate a complete LTM candidate cell configuration by applying ltm-Candidate on top of
referenceConfiguration according to the actions and store it in ue-LTM-Config within VarLTM-
UE-Config.

The following relates to LTM cell switch execution.

Upon the indication by lower layers that an LTM cell switch procedure is triggered, the UE may, as shown in TABLE 19.

TABLE 19
1> release/clear all current dedicated radio configuration except for the following:
2> if the LTM cell switch is triggered on the MCG:

| | |
|---|---|
| - | the MCG C-RNTI; |
| - | the AS security configurations associated with the master key; |

2> else, if the LTM cell switch is triggered on the SCG:

| | |
|---|---|
| - | the SCG C-RNTI; |
| - | the AS security configurations associated with the secondary key; |
| - | the SRB1/SRB2 configurations and DRB configurations as configured by |

radioBearerConfig or radioBearerConfig2;

| | |
|---|---|
| - | the UE variables VarLTM-Config and VarLTM-UE-Config. |

1> release/clear all current common radio configuration;
1> use the default values specified in 9.2.3 for timers T310, T311 and constants N310, N311;

| | |
|---|---|
| 1> | apply the default L1 parameter values as specified in corresponding physical layer |

specifications except for the following:

| | |
|---|---|
| - | parameters for which values are provided in SIB1; |
| 1> | apply the value of the newUE-Identity as the C-RNTI for this cell group according to |

the LTM candidate cell configuration related to the LTM candidate cell configuration identity
as received by lower layers;

| | |
|---|---|
| 1> | configure lower layers in accordance with the received spCellConfigCommon according |

to the LTM candidate cell configuration indicated by lower layers;

| | |
|---|---|
| 1> | configure lower layers in accordance with the received rach-ConfigDedicated |

according to the LTM candidate cell configuration indicated by lower layers.
1> configure the PDCP entity for LTM candidate cell configuration indicated by lower layers
with state variables continuation for SRBs, and with the same security configuration as the
PDCP entity for the source cell group;

| | |
|---|---|
| 1> | stop timer T310 for the corresponding SpCell, if running; |
| 1> | if this procedure is executed for the MCG: |
| 2> | if timer T316 is running; |
| 3> | stop timer T316; |
| 1> | stop timer T312 for the corresponding SpCell, if running; |
| 1> | apply the specified BCCH configuration defined in 9.1.1.1 for the target LTM candidate |

cell configuration;

| | |
|---|---|
| 1> | acquire the MIB of the target SpCell as indicated in the LTM candidate cell |

configuration indicated by lower layers, if applicable;
1> apply the LTM configuration in UE-LTM-Config within VarLTM-UE-Config related to the
LTM candidate cell configuration identity as received by lower layers.
1> submit the RRCReconfigurationComplete message to lower layers for transmission using the
new configuration.

The following relates to RRC messages.

In RRCReconfiguration message, each LTM candidate cell configuration (e.g., in CellGroupConfig IE) can include one of the following information:
an indicator to indicate whether to perform DL synchronization to candidate/target cell before receiving the cell switch command (MAC CE); and
LTM cell switch indicator (or Cell identity), which can indicate the UE to perform LTM cell switch to the target cell (the candidate cell indicated by this indicator) upon the reception of RRCReconfiguration message. This can trigger LTM cell switch earlier than MAC CE based LTM Cell switch, i.e., it does not require the network to send MAC CE to UE in order to trigger LTM cell switch.

LTM candidate cell configuration index (or identity) or Cell identity

TCI state (s) or beam information (e.g., beam index, SSB index, etc.)

After LTM cell switch, the UE can keep the LTM candidate cell configuration, which allows subsequent LTM cell switch by MAC CE.

When the network triggers a L3-triggered handover (i.e., handover by RRCReconfiguration including reconfigurationWithSync) to the UE, the UE can release LTM candidate cell configurations automatically (or by RRCReconfiguration) if the handover or random access procedure to the target cell is successfully completed. As the PCell is changed after the handover and the LTM candidate cell configuration becomes not valid anymore, they may be released and can be updated. The embodiment is described below in TABLE 20.

TABLE 20
- LTM-CandidateConfig
The IE LTM-Candidate Config is used to provide LTM candidate cell configuration.
LTM-CandidateConfig information element
-- ASN1START
-- TAG-LTM-CANDIDATECONFIG-START
LTM-CandidateConfig-r18 ::= SEQUENCE {
lte-ReferenceConfiguration-r18 OCTET STRING (CONTAINING RRCReconfiguration),
OPTIONAL, -- Cond FirstLTM-Candidate

| | |
|---|---|
| ltm-CandidateToReleaseList-r18 LTM-CandidateToReleaseList-r18 | OPTIONAL, |

-- Need N

| | |
|---|---|
| ltm-CandidateToAddModList-r18 LTM-CandidateToAddModList-r18 | OPTIONAL, |

```
-- Need N
  ltm-CandidateResetL2-List-r18 SetupRelease { LTM-CandidateResetL2-List-r18 }
OPTIONAL -- Need M
  ...
}
LTM-CandidateToReleaseList-r18 ::= SEQUENCE (SIZE (1..maxNrofCellsLTM-r18)) OF
LTM-CandidateId-r18 OPTIONAL -- Need N
LTM-CandidateToAddModList-r18 ::= SEQUENCE (SIZE (1..maxNrofCellsLTM-r18)) OF
LTM-Candidate-r18
LTM-Candidate-r18 ::= SEQUENCE {
  ltm-CandidateId-r18 LTM-CandidateId-r18,
  ltm-Config-r18 OCTET STRING (CONTAINING RRCReconfiguration),
```

| | |
|---|---|
| ltm-ConfigComplete-r18 ENUMERATED {true} | OPTIONAL -- Need R |

```
  ...
}
LTM-CandidateResetL2-List-r18 ::= SEQUENCE (SIZE (1..maxNrofCellsLTM-r18)) OF LTM-
CandidateId-r18
-- TAG-LTM-CANDIDATECONFIG-STOP
-- ASN1STOP
  LTM-Candidate Config field descriptions
  ltm-Config
  This field includes an RRCReconfiguration message used to configure an LTM candidate cell.
  This field may include the CellGroupConfig IE, and it may also include the RadioBearerConfig
  IE, and MeasConfig IE.
  ltm-ConfigComplete
  This field indicates whether the LTM candidate cell configuration within ltm-Config is a
  complete configuration and thus the UE may not use the LTM reference configuration within
  the field lte-ReferenceConfiguration.
  ltm-Candidate NoResetL2-List
  This field includes a list of LTM candidate cell identifiers for which the full L2 reset is needed
  upon an LTM cell switch.
  ltm-ReferenceConfiguration
  This field includes an RRCReconfiguration message used to configure a reference
  configuration for LTM.
```

| Conditional Presence | Explanation |
|---|---|
| FirstLTM-Candidate | This field is mandatory present upon the first configuration of LTM- |
| | CandidateConfig. Otherwise, the field is optionally present, Need |
| | M. |

The following relates to Timer handling (i.e., Txxx or supervisor timer).

A supervisor timer can be used to detect failure of LTM cell switch procedure, wherein LTM procedure fails if the LTM supervision timer expires, upon which the UE initiates RRC connection re-establishment procedure. The behaviour for the supervision timer is as follows:
The LTM supervisor timer (e.g., Txx timer or T304 timer) can be managed for each cell group (e.g., MCG or SCG) in RRC layer;
The UE starts the LTM supervisor timer, upon reception of the LTM cell switch MAC CE. The UE can restart the LTM supervisor timer upon reception of the LTM cell switch MAC CE indicating subsequent LTM. For example, the UE can start or restart the LTM supervisor timer, upon reception of the LTM cell switch MAC CE;
The UE stops the LTM supervisor timer, upon successful completion of LTM cell switch (or when MAC of an NR cell group successfully completes a random access procedure triggered for LTM cell switch) or upon the detection of beam failure (i.e., if BFI_COUNTER>=beamFailureInstanceMaxCount for the target/indicated LTM candidate cell (or PTAG or the serving cell or the target cell)) or upon the reception of RRCReconfiguration including reconfigurationWithSync;
For MCG, a supervision timer can be used to detect failure of LTM cell switch procedure, wherein LTM procedure fails if the LTM supervision timer expires, upon which the UE initiates RRC connection re-establishment procedure to recover RRC connection (i.e., MCG connection or link); and
For SCG, a supervision timer can be used to detect failure of LTM cell switch procedure, wherein LTM procedure fails if the LTM supervision timer expires, upon which the UE initiates SCG failure information procedure to report SCG failure to the network.

While the UE has stored LTM candidate cell configurations the UE can also execute any L3 handover command sent by the network. It is up to the network to avoid any issue due to a collision between LTM execution and L3 handover execution, e.g., avoiding sending LTM cell switch command and L3 handover command simultaneously.

The following relates to MAC protocol.

MAC CE.

The first MAC CE is LTM triggering MAC CE that triggers cell switch to the target cell (i.e., one of LTM candidate cells configured by RRCReconfiguration message)

The contents of LTM triggering MAC CE (or LTM command MAC CE or LTM MAC CE) can includes one of the following information:
CFRA resources;
LTM candidate cell configuration index (or identity) or cell identity;
Cell identity;
TCI state (s) or beam information (e.g., beam index, SSB index, etc.); and/or
Timing advance value (TA value or timing advance command) Specifically, the first MAC CE (i.e., LTM command MAC CE) is identified by MAC subheader with eLCID. It has a variable size with one or more of the following fields:
   R: reserved bit, set to 0;
   target configuration ID (identity) (or Target LTM candidate cell identity (i.e., LTM target cell) or Serving cell identity): This field indicates the index (or identity) of target LTM candidate cell configuration (in RRC configuration) to apply for LTM cell switch, This field can be replaced by a bitmap set out in PDCCH DCI format of this disclosure to indicate the target LTM candidate cell; and/or
   Timing advance command: to make UE implementation efficient or save the radio resource, several options are set out for this field. One of the options can be implemented.

Option 1: in this option, the timing advance command field (or value) is optional in the first MAC CE (LTM command MAC CE), which saves the radio resource. This field indicates a value used to control the amount of timing adjustment that the MAC entity may apply (or it can indicate to use the same TA value of the current serving cell). The UE can skip the random access procedure for this LTM cell switch if this field indicates a value (i.e., this field is present or included) or if TAT (timeAlignmentTimer) for the target/indicated LTM candidate cell (or PTAG) is running (i.e., TA value is valid) or if Beam failure is not detected for the target LTM candidate cell (i.e., if BFI_COUNTER<beamFailureInstanceMaxCount for the target/indicated LTM candidate cell (the number of Beam failure Indication is smaller than the maximum number for beam failure detection). The UE can indicate to upper layers that a random access procedure is needed for this LTM cell switch or the target LTM candidate cell (or the indicated LTM candidate cell) if timing advance command value is absent (or not included or not present) or if TAT (timeAlignmentTimer) for the target/indicated LTM candidate cell (or PTAG) is not running (i.e., TA value is not valid) or if Beam failure is detected for the target/indicated LTM candidate cell (i.e., if BFI_COUNTER>=beamFailureInstanceMaxCount for the target/indicated LTM candidate cell (or PTAG) (the number of Beam failure Indication is larger than or equal to the maximum number for beam failure detection).

Option 2: in this option, the timing advance command field (or value) is always present in the first MAC CE (LTM command MAC CE), which eases UE implementation. This field indicates whether the TA is valid for the LTM target cell (i.e., the LTM candidate cell corresponding to the LTM candidate cell configuration (RRC configuration) indicated by target configuration ID field) (or whether to use the same TA value of the current serving cell). If the value of this field is set to a special value (e.g., all 0's or all 1's), this field indicates that no valid timing adjustment is available for the PTAG of the LTM target cell. The UE may perform random access to the LTM target cell if the value of this field is set to a special value (e.g., all 0's or all 1's); Otherwise, this field indicates a value used to control the amount of timing adjustment that the MAC entity may apply. The UE can skip the random access procedure for this LTM cell switch if this field indicates a value (i.e., this field does not indicate the special value) or if TAT (timeAlignmentTimer) for the target/indicated LTM candidate cell (or PTAG) is running (i.e., TA value is valid) or if beam failure is not detected for the target LTM candidate cell (i.e., if BFI_COUNTER<beamFailureInstanceMaxCount for the target/indicated LTM candidate cell (the number of Beam failure indication is smaller than the maximum number for beam failure detection).
TCI state ID: this field indicates or activates the TCI state for the LTM target cell (i.e., the cell (i.e., SpCell) of the target LTM candidate configuration indicated by the target configuration ID field). The TCI state is identified by TCI-StateId configured in the target LTM candidate configuration. If this field is absent (or not present or not included), the default TCI state (or the TCI state) configured in the target LTM candidate configuration is used or activated. This field can be replaced or absent by using the fourth MAC CE, i.e., in another embodiment, this field can be indicated/included in the fourth MAC CE.
UL TCI state ID: this field indicates and activates the uplink TCI state for the LTM target cell (i.e., the cell (i.e., SpCell) of the target LTM candidate configuration indicated by the target configuration ID field). If this field is absent (or not present or not included), the default TCI state (or the TCI state) configured in the target LTM candidate configuration is used or activated. This field can be replaced or absent by using the fourth MAC CE, i.e., in another embodiment, this field can be indicated/included in the fourth MAC CE.
DL BWP ID: this field indicates the DL BWP that a UE uses for the target LTM cell. If this field is present (or included), the MAC entity (or UE) activates the DL BWP indicated by this field for LTM execution or LTM cell switch. If this field is absent (not present or not included), the MAC entity (or UE) activates the DL BWP indicated by RRC configuration (i.e., firstActiveDownlinkBWP-Id in target LTM candidate configuration indicated by the target configuration ID) for LTM execution or LTM cell switch. In another embodiment, one common BWP ID (or the same BWP ID) can indicate both DL BWP ID and UL BWP ID or the BWP ID can be indicated/included in the fourth MAC CE.
UL BWP ID: this field indicates the UL BWP that the UE uses for the target LTM cell. If this field is present (or included), the MAC entity (or UE) activates the UL BWP indicated by this field for LTM execution or LTM cell switch. If this field is absent (not present or not included), the MAC entity (or UE) activates the UL BWP indicated by RRC configuration (i.e., firstActiveUplinkBWP-Id in target LTM candidate configuration indicated by the target configuration ID) for LTM execution or LTM cell switch. In another embodiment, one common BWP ID (or the same BWP ID) can indicate both DL BWP ID and UL BWP ID or the BWP ID can be indicated/included in the fourth MAC CE.

The fields other than target configuration ID in this first MAC CE refers to the (target LTM candidate configuration) RRC configuration indicated by the target configuration ID field, i.e., The fields are considered (or processed) after the UE has applied the complete (or reference) LTM candidate configuration indicated by target configuration ID in the first MAC CE. It does not refer to the RRC configuration in use before/upon reception of this MAC CE.

For the selection of Bandwidth Part (BWP) in an LTM cell switch procedure, a UE needs to identify the UL BWP of LTM candidate cell for random access preamble transmission (on PRACH or RACH). As an LTM candidate cell is a non serving cell and there is no active UL or DL BWP for non-serving cell. A UE needs to identify which UL BWP is used by the UE for random access preamble transmission. With this reason, the UE uses:
UL BWP indicated by BWP ID field in the first MAC CE that the UE received if the first MAC CE includes BWP ID (e.g., UL BWP ID). The BWP ID is not configured with the same ID as dormant BWP (i.e., dormantBWP-Id);
UL BWP indicated by firstActiveUplinkBWP field in configuration of indicated target LTM candidate cell if the first MAC CE does not include BWP ID (e.g., UL BWP ID). The BWP ID is not configured with the same ID as dormant BWP (i.e., dormantBWP-Id) or the LTM candidate cell configuration does not include dormant BWP configuration (i.e., dormantBWP-Config). In another embodiment, initialUplinkBWP field can be used instead of firstActiveUplinkBWP field;
DL BWP indicated by BWP ID field in the first MAC CE that the UE received if the first MAC CE includes BWP ID (e.g., DL BWP ID). The BWP ID is not configured with the same ID as dormant BWP (i.e., dormantBWP-Id); and/or
DL BWP indicated by firstActiveDownlinkBWP field in configuration of indicated target LTM candidate cell if the first MAC CE does not include BWP ID (e.g., DL BWP ID). The BWP ID is not configured with the same ID as dormant BWP (i.e., dormantBWP-Id) or the LTM candidate cell configuration does not include dormant BWP configuration (i.e., dormantBWP-Config). In another embodiment, initialDownlinkBWP field can be used instead of firstActiveUplinkBWP field.

Dormant BWP may not be configured for LTM candidate cell(s) as the PDCCH monitoring is required for LTM procedure, e.g., random access procedure and LTM Cell switch.

The second MAC CE is SCell activation/deactivation MAC CE.

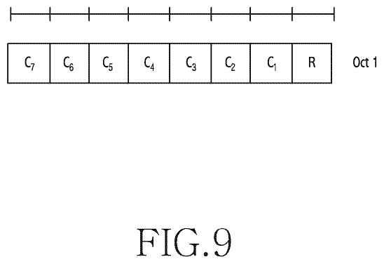

The Scell activation/deactivation MAC CE of one octet is identified by a MAC subheader with LCID. It has a fixed size and consists of a single octet containing seven C-fields and one R-field. The Scell activation/deactivation MAC CE with one octet is defined as follows (FIG. 9).

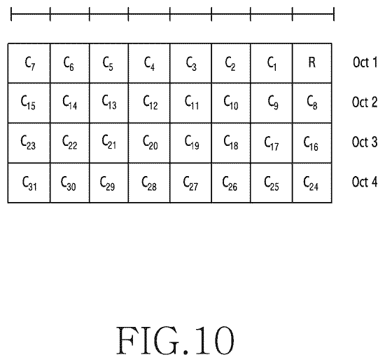

The Scell activation/deactivation MAC CE of four octets is identified by a MAC subheader with LCID. It has a fixed size and consists of four octets containing 31 C-fields and one R-field. The Scell activation/deactivation MAC CE of four octets is defined as follows (FIG. 10):
Cᵢ: if there is an SCell configured for the MAC entity with SCellIndex i as configured in RRC message, this field indicates the activation/deactivation status of the SCell with SCellIndex i, else the MAC entity may ignore the Cᵢ field. The Cᵢ field is set to 1 to indicate that the SCell with SCellIndex i may be activated. The Cᵢ field is set to 0 to indicate that the SCell with SCellIndex i may be deactivated; and
R: reserved bit, set to 0.

NOTE: If a UE receives the SCell activation/deactivation MAC CE for an SCell configured with TRS for fast activation of the SCell, such TRS is not used for the corresponding SCell.

The third MAC CE is enhanced SCell activation/deactivation MAC CE.

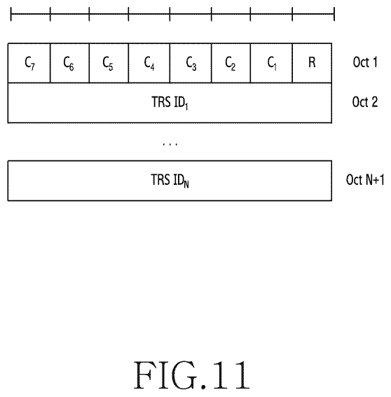

The enhanced SCell activation/deactivation MAC CE with one octet Cᵢ field is identified by a MAC subheader with eLCID. It has a variable size and consists of seven C-fields, one R-field and zero or more TRS IDⱼ fields in ascending order based on the ScellIndex for SCells indicated by the Cᵢ field(s) to be activated. The enhanced SCell activation/deactivation MAC CE of with one octet Cᵢ field is defined as follows (FIG. 11).

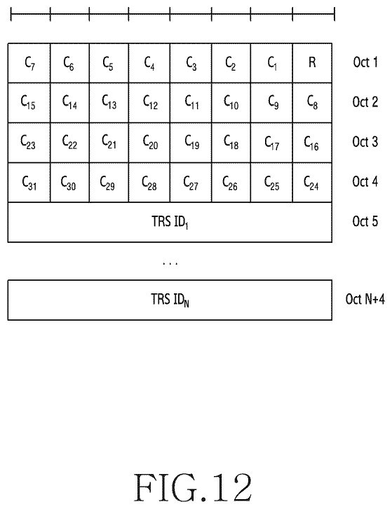

The enhanced SCell activation/deactivation MAC CE with four octet Cᵢ field is identified by a MAC subheader with eLCID. It has a variable size and consists of 31 C-fields, one R-field and zero or more TRS IDⱼ fields in ascending order based on the ScellIndex for SCells indicated by the Cᵢ field(s) to be activated. The enhanced SCell activation/deactivation MAC CE with four octet Cᵢ field is defined as follows (FIG. 12):
Ci: if there is an SCell configured for the MAC entity with SCellIndex i as configured in RRC message, this field indicates the activation/deactivation status of the SCell with SCellIndex i, else the MAC entity may ignore the Ci field. The Ci field is set to 1 to indicate that the SCell with SCellIndex i may be activated and that a TRS IDj field is included for the SCell. The Ci field is set to 0 to indicate that the SCell with SCellIndex i may be deactivated and that no TRS ID field is included for this SCell;
TRS IDj: if TRS IDj is set to a non-zero value, it indicates the corresponding TRS address by scellActivationRS-Id as configured in RRC message is activated. If TRS IDj is set to zero, it indicates that no TRS is used for the corresponding SCell; and/or
R: reserved bit, set to 0.

For the first, second, and third MAC CEs, the rules and restrictions to make the UE behaviour for LTM cell switch procedure simple and efficient are set out. As described, LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario,
PCell change with SCell change(s) in CA scenario, including the following cases:
a) The target PCell/target SCell(s) is not a current serving cell (CA-to-CA scenario with PCell change);
b) The target PCell is a current SCell; and/or
c) The target SCell is the current PCell.

To support these scenarios efficiently, some rules and restrictions for the MAC CEs may need to be defined because some scenarios cause complexity in UE implementation. For example, the current PCell can be indicated LTM cell switch to one of the current SCells and be indicated SCell activation/deactivation, which may be a sort of race conditions.

Option 1: in this option, the network may not send the first MAC CE together with the second MAC CE (or the third MAC CE) to UE. In other words, the network may not include the first MAC CE and the second MAC CE (or the third MAC CE) in the same MAC PDU. By having this restriction, the network can send the commands stage by stage. For example,
Step 1: the network can configure LTM candidate cell configuration to a UE by an RRC message. The network can activate or deactivate or configure (add/modify) or release SCells by RRC message or the second MAC CE or the third MAC CE to get Scells ready for LTM cell switch by activating/deactivating Scells, which may be done with LTM candidate cell configuration at the same time, i.e., by RRC message or MAC CE.
Step 2: the network can send the first MAC CE to a UE in order to trigger LTM cell switch to the target cell.
Step 3: the network can send the second MAC CE or the third MAC CE to a UE to activate or deactivate SCells (e.g., after the successful completion of LTM cell switch or when the condition is met).

Option 2. in this option, the network can send the first MAC CE together with the second MAC CE (or the third MAC CE) to UE. In other words, the network can include the first MAC CE and the second MAC CE (or the third MAC CE) in the same MAC PDU. By allowing this, the network can send the commands (LTM cell switch and SCell activation/deactivation) altogether, which can reduce the delay. Following examples of steps are provided.
Step 1: the network can configure LTM candidate cell configuration to a UE by an RRC message. The network may activate or deactivate or configure (add/modify) or release SCells by RRC message or the second MAC CE or the third MAC CE to get Scells ready for LTM cell switch by activating/deactivating Scells, which may be done with LTM candidate cell configuration at the same time, i.e., by RRC message or MAC CE. It can be also done by including the first MAC CE and the second MAC CE (or the third MAC CE) in the same MAC PDU in Step 2.
Step 2: the network can send the first MAC CE to the UE in order to trigger LTM cell switch to the target cell. Or the network can send the first MAC CE and the second MAC CE (or the third MAC CE) together to the UE in the same MAC PDU to trigger LTM cell switch and SCell activation/deactivation.

To ease UE implementation, a UE can automatically deactivate or de-configure SCells upon the reception of the first MAC CE (or upon LTM execution) or upon the reception of RRC reconfiguration including LTM candidate configurations or upon/after the application of the target LTM candidate configuration. In another embodiment, the UE can activate or deactivate or de-configure or configure SCells according to the target LTM candidate configuration (or by the second (or the third) MAC CE) for LTM execution procedure, i.e., the network can decide the state of SCells by RRC message or MAC CE. In another embodiment, the UE can automatically deactivate or de-configure SCells belonging to the PTAG (i.e., the SCells with the same TA value as SpCell (serving cell)) upon the reception of the first MAC CE (or upon LTM execution) or upon the reception of RRC reconfiguration including LTM candidate configurations or upon/after the application of the target LTM candidate configuration. In another embodiment, a UE can deactivate or de-configure SCells belonging to the PTAG (i.e., the SCells with the same TA value as SpCell (serving cell)) according to the target LTM candidate configuration (or by the second (or the third) MAC CE) for LTM execution procedure, i.e., the network can decide the state of SCells by RRC message or MAC CE. In another embodiment, a UE can activate or deactivate or de-configure or configure SCells according to the target LTM candidate configuration for LTM execution procedure upon the reception of the first MAC CE or upon the successful completion of LTM execution (or LTM cell switch) or upon/after the application of the target LTM candidate configuration, i.e., the network can decide the state of SCells by RRC message.

For Option 2, the network can construct MAC PDU for downlink as follows:

A MAC PDU consists of one or more MAC subPDUs. Each MAC subPDU consists of one of the following:
A MAC subheader only (including padding);
A MAC subheader and a MAC SDU;
A MAC subheader and a MAC CE; and/or
A MAC subheader and padding.

The MAC SDUs are of variable sizes.

Each MAC subheader corresponds to either a MAC SDU, a MAC CE, or padding.

A MAC subheader except for fixed sized MAC CE, padding, and a MAC SDU containing UL CCCH consists of the header fields R/F/LCID/(eLCID)/L. A MAC subheader for fixed sized MAC CE, padding, and a MAC SDU containing UL CCCH consists of the two header fields R/LCID/(eLCID).

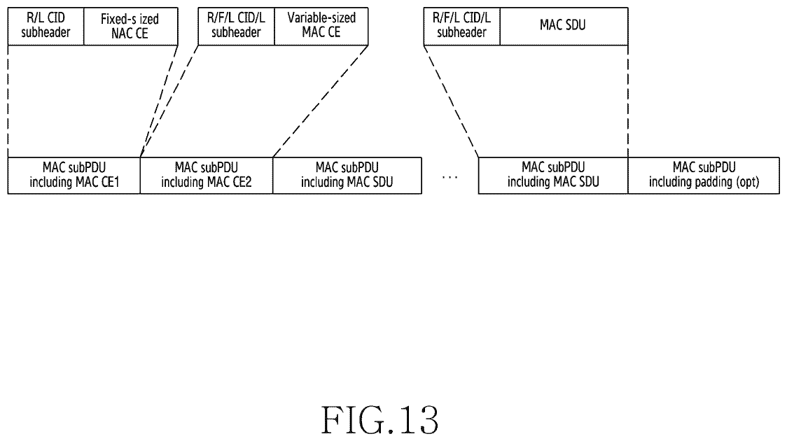

MAC CEs are placed together. DL MAC subPDU(s) with MAC CE(s) is placed before any MAC subPDU with MAC SDU and MAC subPDU with padding as depicted in FIG. 13.

Upon the reception of the second MAC CE (or the third MAC CE) and the first MAC CE, UE may first process (or read) the second MAC CE (or the third MAC CE) to get SCells ready for LTM cell switch by activating/deactivating SCells. And then, the UE can process (or read) the first MAC CE to trigger LTM cell switch. To make the UE processing easier, the order of MAC CEs is defined as the second MAC CE (or the third MAC CE) is placed before the first MAC CE.

In another embodiment, upon the reception of the first MAC CE and the second MAC CE (or the third MAC CE), the UE may first process (or read) the first MAC CE to trigger LTM cell switch. And then, the UE can process (or read) the second MAC CE (or third MAC CE) to activate/deactivate SCells (e.g., after the successfully completing LTM cell switch according to the above conditions). To make the UE processing easier, the order of MAC CEs is defined as the first MAC CE is placed before the second MAC CE (or the third MAC CE). The second MAC CE (or the third MAC CE) may be processed upon/after the successful completion of LTM cell switch (when the above condition is met).

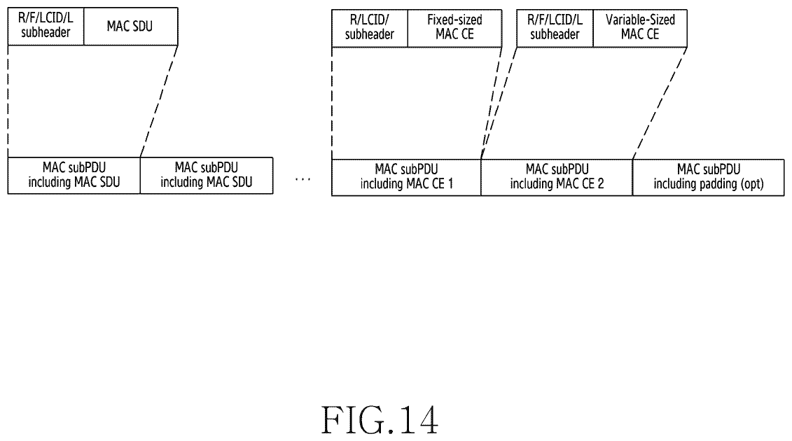

UL MAC subPDU(s) with MAC CE(s) is placed after all the MAC subPDU(s) with MAC SDU and before the MAC subPDU with padding in the MAC PDU as depicted in FIG. 14. The size of padding can be zero.

A maximum of one MAC PDU can be transmitted per TB per MAC entity.

With Option 1 or Option 2, LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario, and
PCell change with SCell change(s) in CA scenario, including the following cases:
a) The target PCell/target SCell(s) is not a current serving cell (CA-to-CA scenario with PCell change);
b) The target PCell is a current SCell; and/or
c) The target SCell is the current PCell.

The fourth MAC CE is LTM candidate cell TCI States activation/deactivation MAC CE.

The Candidate cell TCI states activation/deactivation MAC CE is identified by a MAC subheader with eLCID as specified in Table 6.2.1-1b. It has a variable size consisting of one or more of following fields:
LTM candidate Configuration ID or candidate cell ID: This field indicates the identity of an LTM candidate Cell or LTM candidate Configuration identity for which the MAC CE applies, corresponding to the LTM candidate configuration in RRC reconfiguration. In another embodiment, this field can be replaced (or absent) by target configuration ID in the first MAC CE. For example, the fields in the fourth MAC CE can be applied or processed when the first MAC CE is received and the target configuration ID is received:

Pᵢ: this field indicates whether each TCI codepoint has multiple TCI states or a single TCI state. If the Pᵢ field is set to 1, the i^{th} TCI codepoint includes the DL TCI state and the UL TCI state. If the Pᵢ field is set to 0, the i^{th} TCI codepoint includes only the DL/joint TCI state or the UL TCI state. The codepoint to which a TCI state is mapped is determined by the ordinal position among all the TCI state ID fields;
D/U: this field indicates whether the TCI state ID in the same octet is for a joint/downlink or an uplink TCI state. If this field is set to 1, the TCI state ID in the same octet is for joint/downlink. If this field is set to 0, the TCI state ID in the same octet is for uplink;
TCI state ID: this field indicates the TCI state identified by TCI-StateId or TCI-UL-StateId in target LTM candidate configuration. If D/U is set to 1, 7-bits length TCI state ID i.e., TCI-StateId configured in target LTM candidate configuration is used. If D/U is set to 0, the most significant bit of TCI state ID is considered as the reserved bit and remaining 6 bits indicate the TCI-UL-StateId configured in target LTM candidate configuration;
DL BWP ID: this field indicates the DL BWP that the UE uses for the target LTM cell. If this field is present (or included), the MAC entity (or UE) activates the DL BWP indicated by this field for LTM execution or LTM cell switch. If this field is absent (not present or not included), the MAC entity (or UE) activates the DL BWP indicated by RRC configuration (i.e., firstActiveDownlinkBWP-Id in target LTM candidate configuration indicated by the target configuration ID) for LTM execution or LTM cell switch. In another embodiment, one common BWP ID (or the same BWP ID) can indicate both DL BWP ID and UL BWP ID;
UL BWP ID: this field indicates the UL BWP that the UE uses for the target LTM cell. If this field is present (or included), the MAC entity (or UE) activates the DL BWP indicated by this field for LTM execution or LTM cell switch. If this field is absent (not present or not included), the MAC entity (or UE) activates the DL BWP indicated by RRC configuration (i.e., firstActiveUplinkBWP-Id in target LTM candidate configuration indicated by the target configuration ID) for LTM execution or LTM cell switch. In another embodiment, one common BWP ID (or the same BWP ID) can indicate both DL BWP ID and UL BWP ID; and/or
R: reserved bit, set to 0.

The fields in this fourth MAC CE refers to the (target LTM candidate configuration) RRC configuration indicated by the target configuration ID field in the first MAC CE, i.e., The fields are considered (or processed) after the UE has applied the complete (or reference) LTM candidate configuration indicated by target configuration ID in the first MAC CE. It does not refer to the RRC configuration in use before/upon reception of this MAC CE.

The fourth MAC CE can be placed before the first MAC CE when the MAC CEs are included in the same MAC PDU, which enables early TCI state processing. In another embodiment, the fourth MAC CE can be placed after the first MAC CE when the MAC CEs are included in the same MAC PDU, which enables fast application of the indicated LTM candidate cell configuration.

The following relates to random access (RA) procedure.

When a random access procedure is initiated, the UE selects a set of random access resources and initialises the following parameters for the random access procedure according to the values configured by RRC for the selected set of random access resources:
preambleReceivedTargetPower: initial random access preamble power for 4-step RA type;
powerRampingStep: the power-ramping factor;
msgA-PreamblePowerRampingStep: the power ramping factor for MSGA preamble;
ra-PreambleIndex: random access preamble;
ra-PreambleStartIndex: the starting index of random access preamble(s) for on-demand SI request;
startPreambleForThisPartition: the first preamble associated with the set of random access resources applicable to the random access procedure; and/or
preambleTransMax: the maximum number of random access preamble transmission, the random access procedure for TA acquisition of LTM candidate cell(s) (i.e., the random access procedure initiated by the PDCCH order for an LTM candidate cell) may not consider this variable. In another embodiment, this variable can be set to the minimum value, e.g., 1, in order to avoid autonomous preamble retransmission. For example, the variable (i.e., preambleTransMax) can be set to 1 when the random access procedure for TA acquisition of LTM candidate cell(s) is indicated or triggered or initiated (e.g., if the random access procedure is initiated by the PDCCH order for an LTM candidate cell). In another embodiment, the random access procedure for TA acquisition of LTM candidate cell(s) may consider (or set) this variable as infinity value (or zero value) in order to invalidate the variable. For example, the variable (i.e., preambleTransMax) can be set to infinity or zero value when the random access procedure for TA acquisition of LTM candidate cell(s) is indicated or triggered or initiated (e.g., if the random access procedure is initiated by the PDCCH order for an LTM candidate cell).

The following UE variables are used for the random access procedure:
PREAMBLE_INDEX;
PREAMBLE_TRANSMISSION_COUNTER;
PREAMBLE_TRANSMISSION_COUNTER_LTM;
PREAMBLE_POWER_RAMPING_COUNTER;
PREAMBLE_POWER_RAMPING_COUNTER_LTM;
PREAMBLE_POWER_RAMPING_STEP;
PREAMBLE_RECEIVED_TARGET_POWER;
POWER_OFFSET_2STEP_RA; and/or
MSGA_PREAMBLE_POWER_RAMPING_STEP.

The contents of PDCCH order are as following TABLE 21.

TABLE 21

| Field (Item) | Bits | Reference |
|---|---|---|
| Identifier for DCI | 1 | Always set to 1, meaning this is for DL |
| formats | | |
| Frequency | Variable | All ones |
| domain resource | | |
| assignment | | |
| Random access | 6 | 6 bits according to ra-PreambleIndex |
| preamble index | | |
| UL/SUL indicator | 1 | For CFRA, to indicate which UL carrier |
| | | in the cell to transmit the PRACH |
| SS/PBCH index | 6 | For CFRA, the field indicates the SSB |
| | | that may be used to determine the |
| | | RACH occasion for the PRACH |
| | | transmission |
| PRACH Mask | 4 | For CFRA, the field indicates the |
| index | | RACH PDCCH order occasion |
| | | associated with the SSB indicated by |
| | | SS/PBCH index for the PRACH |
| | | transmission |
| Indicators for | 1 or 2 | The field indicates whether to perform |
| Random access | | preamble transmission or re- |
| procedure for | | transmission for Random access |
| TA acquisition | | procedure for TA acquisition. |
| | | In another embodiment, the |
| | | indicates to perform preamble |
| | | transmission of Random access |
| | | procedure for TA acquisition (or |
| | | Random access procedure for TA |
| | | acquisition). |
| | | In another embodiment, the fields |
| | | indicate how many retransmission has |
| | | been performed so far. For example, it |
| | | can indicate the first transmission, the |
| | | second retransmission, the third |
| | | retransmission, or the fourth |
| | | retransmission, etc. |

In this disclosure, support RACH-less solution is supported (i.e., LTM cell switch without random access procedure) when the UE performs LTM procedure (e.g., LTM execution) by the first MAC CE (i.e., LTM triggering MAC CE described). In RACH-less procedure, the UE needs a valid TA to send the first UL message during LTM execution procedure (i.e., LTM cell switch). To provide the TA with early RACH procedure (i.e., PDCCH-ordered random access procedure before the first MAC CE), PDCCH-ordered random access procedure without RAR (random access response) is set out.

When the random access procedure for TA acquisition of LTM candidate cell(s) is triggered/indicated by PDCCH order (e.g., by an indication), the UE performs random access procedure, i.e., the UE transmits the preamble to PRACH (Physical random access channel) resource of the indicated LTM candidate cell(s) and complete the random access procedure, i.e., the preamble transmission during this random access procedure for TA acquisition (i.e., early RACH) can be considered as this random access procedure is successfully completed. The preamble or the PRACH resources can be indicated by PDCCH order or (pre-)configured by RRC message (e.g., RRCReconfiguration message). To reduce the processing complexity, the UE does not calculate RA-radio network temporary identifier (RNTI) for random access response) before/when the preamble is transmitted, unlike normal random access procedure (RACH). To enable this functionality, one of the following options can be implemented:

Option 1: in this option, the network can avoid another Random access procedure during the random access procedures for TA acquisition (i.e., before the successful completion of TA acquisition). The first preamble transmission for TA acquisition may not be successful and the network can request preamble retransmission for TA acquisition. In this case, the UE increments the first variable (PREAMBLE_POWER_RAMPING_COUNTER), calculates the preamble received target power, and retransmit the preamble with the higher power than the first preamble. For example, if the random access procedure is not initiated by the PDCCH order for an LTM candidate cell as preamble re-transmission (or if the normal random access procedure is initiated or if the random access procedure is initiated for LTM execution (i.e., LTM cell switch)), the UE sets the first variable to 1. In other words, if the random access procedure is initiated by the PDCCH order for an LTM candidate cell as preamble transmission, i.e., first transmission (or if the normal random access procedure is initiated or if the random access procedure is initiated for LTM execution (i.e., LTM cell switch)), the UE sets the first variable to 1. If the random access procedure is initiated by the PDCCH order for an LTM candidate cell as preamble re-transmission, the UE does not set the first variable to 1. If the random access procedure is initiated by the PDCCH order for an LTM candidate cell as preamble re-transmission, the UE increments the first variable by 1. Based on this, the UE can calculate the preamble received target power, and retransmit the preamble with the higher power than the first preamble. To achieve this, the following procedure can be implemented (the same principle can be applied to other variable (e.g., PREAMBLE_TRANSMISSION_COUNTER).

### (1) Random Access Procedure Initialization

When the random access procedure is initiated on a serving cell or to an LTM candidate cell (or if the random access procedure is initiated for LTM execution (i.e., LTM cell switch) or if the random access procedure is initiated for TA acquisition for an LTM candidate cell), the MAC entity may, as shown in TABLE 22.

TABLE 22
1> flush the Msg3 buffer;
1> flush the MSGA buffer;
1> set the PREAMBLE_TRANSMISSION_COUNTER to 1;
set the PREAMBLE_POWER_RAMPING_COUNTER
1> set the PREAMBLE_POWER_RAMPING_COUNTER to 1, if the random access
procedure is not initiated by the PDCCH order for an LTM candidate cell (i.e., for TA
acquisition of the cell) as preamble re-transmission ;

### (2) Random Access Preamble Transmission

The MAC entity may, for each random access preamble, as shown in TABLE 23.

TABLE 23
1> if PREAMBLE_TRANSMISSION_COUNTER is greater than one; and
1> if the notification of suspending power ramping counter has not been received from
lower layers; and
1> if LBT failure indication was not received from lower layers for the last random access
preamble transmission; and
1> if SSB or CSI-RS selected is not changed from the selection in the last random access
preamble transmission:
2> increment PREAMBLE_POWER_RAMPING_COUNTER by 1.
1> if the random access procedure is initiated by the PDCCH order for an LTM candidate
cell (i.e., for TA acquisition of the cell) as preamble re-transmission:
2> increment PREAMBLE_POWER_RAMPING_COUNTER by 1.
1> select the value of DELTA_PREAMBLE ;
1> set PREAMBLE_RECEIVED_TARGET_POWER to preambleReceivedTargetPower +
DELTA_PREAMBLE + (PREAMBLE_POWER_RAMPING_COUNTER − 1) ×
PREAMBLE_POWER_RAMPING_STEP + POWER_OFFSET_2STEP_RA;
1> except for contention-free random access preamble for beam failure recovery request
and random access preamble for an LTM candidate cell by the PDCCH-ordered random access
procedure (i.e., for TA acquisition of the cell), compute the RA-RNTI associated with the
PRACH occasion in which the random access preamble is transmitted; (UE may not compute
the RA-RNTI associated with the PRACH occasion in which the random access preamble is
transmitted if random access preamble is transmitted by PDCCH order for TA acquisition of the
LTM candidate cell because the reception of RAR is not expected. However, the UE computes
the RA-RNTI associated with the PRACH occasion in which the random access preamble is
transmitted, for normal random access procedure or random access procedure for LTM
execution (i.e., LTM cell switch).
1> instruct the physical layer to transmit the random access preamble using the selected
PRACH occasion, corresponding RA-RNTI (if available), PREAMBLE_INDEX, and
PREAMBLE_RECEIVED_TARGET_POWER.
1> if the random access procedure is triggered by a PDCCH order for a LTM candidate
cell (i.e., for TA acquisition of the cell): (The preamble transmission during this random access
procedure for TA acquisition (i.e., early RACH) can be considered as this random access
procedure is successfully completed)
2> consider this random access procedure successfully completed (or consider this random
access response reception successful);

Option 2: in this option, the network can allow another random access procedure during the random access procedures for TA acquisition (i.e., before the successful completion of TA acquisition) by introducing the second variable (PREAMBLE_POWER_RAMPING_COUNTER_LTM). It can be also extended to support TA acquisition for multiple LTM candidates by having the second variable per LTM candidate cell. The first preamble transmission for TA acquisition may not be successful and the network can request preamble retransmission for TA acquisition. In this case, the UE increments the second variable, calculates the preamble received target power, and retransmit the preamble with the higher power than the first preamble. For example, if the random access procedure is not initiated by the PDCCH order for an LTM candidate cell as preamble re-transmission, the UE sets the second variable to 1. In other words, if the random access procedure is initiated by the PDCCH order for an LTM candidate cell as preamble transmission, the UE sets the second variable to 1. If the random access procedure is initiated by the PDCCH order for an LTM candidate cell as preamble re-transmission, the UE does not set the second variable to 1. If the random access procedure is initiated by the PDCCH order for an LTM candidate cell as preamble re-transmission, UE increments the second variable by 1. Based on this, the UE can calculate the preamble received target power, and retransmit the preamble with the higher power than the first preamble. However, if the normal random access procedure is initiated or if the random access procedure is initiated for LTM execution (i.e., LTM cell switch), the UE sets the first variable to 1. In other words, if the normal random access procedure is initiated or if the random access procedure is initiated for LTM execution (i.e., LTM cell switch), the UE sets the first variable to 1. If the random access procedure is initiated by the PDCCH order for an LTM candidate cell as preamble re-transmission, the UE does not set the first variable to 1. If PREAMBLE_TRANSMISSION_COUNTER is greater than one; and if the notification of suspending power ramping counter has not been received from lower layers; and if LBT failure indication was not received from lower layers for the last random access preamble transmission and if SSB or CSI-RS selected is not changed from the selection in the last random access preamble transmission, the UE increments the first variable by 1. Based on this, the UE can calculate the preamble received target power, and retransmit the preamble with the higher power than the first preamble. To achieve this, the following procedure can be implemented (the same principle can be applied to other variables (e.g., PREAMBLE_TRANSMISSION_COUNTER).

### (1) Random Access Procedure Initialization

When the random access procedure is initiated on a serving cell (or when the random access procedure is initiated for LTM execution (i.e., LTM cell switch) (and if the random access procedure is not initiated on a serving cell towards an LTM candidate cell (for TA acquisition of the LTM candidate cell by a PDCCH order including indications), the MAC entity may, as shown in TABLE 24.

TABLE 24
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;

When the random access procedure is initiated on a serving cell towards an LTM candidate cell (for TA acquisition of the LTM candidate cell by a PDCCH order including indications, e.g., LTM candidate cell identity, TA acquisition, preamble, PRACH resource, etc.), the MAC entity may, as shown in TABLE 25.

TABLE 25
1> flush the Msg3 buffer;
1> flush the MSGA buffer;
1> set the PREAMBLE_TRANSMISSION_COUNTER_LTM to 1;
1> set the PREAMBLE_POWER_RAMPING_COUNTER_LTM to 1 (or set the
PREAMBLE_POWER_RAMPING_COUNTER_LTM for the LTM candidate cell to 1), if the
random access procedure is not initiated by the PDCCH order for an LTM candidate cell (i.e.,
for TA acquisition of the cell) as preamble re-transmission ;
(PREAMBLE_POWER_RAMPING_COUNTER_LTM can be set to 1 if the random access
procedure is initiated by the PDCCH order for an LTM candidate cell (i.e., for TA acquisition
of the cell) as preamble transmission (i.e., first transmission) or if LTM execution is successfully
completed or upon the reception of the first MAC CE (i.e., LTM triggered MAC CE).

### (2) Random Access Preamble Transmission

The MAC entity may, for each random access preamble, as shown in TABLE 26.

TABLE 26
1> if PREAMBLE_TRANSMISSION_COUNTER is greater than one; and
1> if the notification of suspending power ramping counter has not been received from
lower layers; and
1> if LBT failure indication was not received from lower layers for the last random access
preamble transmission; and
1> if SSB or CSI-RS selected is not changed from the selection in the last random access
preamble transmission:
2> increment PREAMBLE_POWER_RAMPING_COUNTER by 1.
1> if the random access procedure is initiated by the PDCCH order for an LTM candidate
cell (i.e., for TA acquisition of the cell) as preamble re-transmission:
2> increment PREAMBLE_POWER_RAMPING_COUNTER_LTM by 1 (or increment
PREAMBLE_POWER_RAMPING_COUNTER_LTM for the LTM candidate cell by 1.
1> select the value of DELTA_PREAMBLE ;
1> set PREAMBLE_RECEIVED_TARGET_POWER to preambleReceivedTargetPower +
DELTA_PREAMBLE + (PREAMBLE_POWER_RAMPING_COUNTER_LTM − 1) ×
PREAMBLE_POWER_RAMPING_STEP + POWER_OFFSET_2STEP_RA, if the random
access procedure is initiated by the PDCCH order for an LTM candidate cell (i.e., for TA
acquisition of the cell);
1> set PREAMBLE_RECEIVED_TARGET_POWER to preambleReceivedTargetPower +
DELTA_PREAMBLE + (PREAMBLE_POWER_RAMPING_COUNTER − 1) ×
PREAMBLE_POWER_RAMPING_STEP + POWER_OFFSET_2STEP_RA if the random
access procedure is not initiated by the PDCCH order for an LTM candidate cell (i.e., for TA
acquisition of the cell);
1> except for contention-free random access preamble for beam failure recovery request
and random access preamble for an LTM candiate cell by the PDCCH-ordered random access
procedure (i.e., for TA acquisition of the cell), compute the RA-RNTI associated with the
PRACH occasion in which the random access preamble is transmitted; (UE may not compute
the RA-RNTI associated with the PRACH occasion in which the random access preamble is
transmitted if random access preamble is transmitted by PDCCH order for TA acquisition of the
LTM candidate cell because the reception of RAR is not expected. However, the UE computes
the RA-RNTI associated with the PRACH occasion in which the random access preamble is
transmitted, for normal random access procedure or random access procedure for LTM
execution (i.e., LTM cell switch).
1> instruct the physical layer to transmit the random access preamble using the selected
PRACH occasion, corresponding RA-RNTI (if available), PREAMBLE_INDEX, and
PREAMBLE_RECEIVED_TARGET_POWER.
1> if the random access procedure is triggered by a PDCCH order for a LTM candidate
cell (i.e., for TA acquisition of the cell): (The preamble transmission during this random access
procedure for TA acquisition (i.e., early RACH) can be considered as this random access
procedure is successfully completed)
2> consider this random access procedure successfully completed (or consider this random
access response reception successful);

Option 3: in this option, introduce multiple bits in PDCCH can be introduced in order to explicitly indicate the number of preamble (re-)transmission to a UE. Specifically, when the UE receives PDCCH order indicating random access procedure for TA acquisition of LTM candidate cell(s), the multiple bits explicitly indicate a certain value (e.g., the number of preamble (re-)transmission. In this way, the UE can determine the COUNT values of variables for random access procedure (e.g., PREAMBLE_POWER_RAMPING_COUNTER or PREAMBLE_TRANSMISSION_COUNTER) from the multiple bits. For example, if the PDCCH has 2 bits for this way, 00 may indicate the first preamble retransmission (i.e., the COUNT value=2), 10 may indicate the third preamble transmission (i.e., the COUNT value=4), 11 may indicate the fourth preamble transmission (i.e., the COUNT value=5). If the PDDCH does not include these 2 bits, then it may indicate the first preamble transmission (i.e., not retransmission). It can be extended to the cases with more bits. Such COUNT value can be determined and set to the values of variables for random access procedure (e.g., PREAMBLE_POWER_RAMPING_COUNTER or PREAMBLE_TRANSMISSION_COUNTER).

The contents of the PDCCH order triggering/indicating the random access procedure for TA acquisition of LTM candidate cell(s) (i.e., a PRACH transmission on a LTM candidate cell) can be set out in details, e.g., how to use the bits in PDCCH DCI format to indicate the LTM candidate cell. The PDCCH order from the source cell contains the indication of candidate cell. The reserved bit(s) in downlink control information (DCI) format 1_0 for PDCCH order can be used for indication of cell identity. Specifically, for a PRACH transmission by a UE triggered by a PDCCH order, the PRACH mask index field, if the value of the random access preamble index field is not zero, indicates the PRACH occasion for the PRACH transmission where the PRACH occasions are associated with the SS/PBCH block index indicated by the SS/PBCH block index field of the PDCCH order and, if any, a cell indicator field indicates a cell for the PRACH transmission. The PDCCH DCI format also includes a 1-bit field in PDCCH order explicitly indicating initial transmission or retransmission of PRACH.

Several options for a cell indicator exist and follow one of the options to trigger a random access procedure on a LTM candidate cell by PDCCH order, which indicates one of LTM candidate cells configured to UE.
Option 1: in this option, the bits in PDCCH (i.e., in DCI format) indicates Cell identity or Configuration Identity configured for a LTM candidate cell in RRC configuration. It makes UE implementation very simple.
Option 2: in this option, a mapping scheme is provided between the bits in PDCCH and the Cell identity (or Configuration Identity) in RRC configuration (i.e., bitmap) to save bits in PDCCH.

For Option 2, the following bitmap structure in DCI format is presented.
A UE configured with (complete or reference) LTM configuration on the PCell or on the SpCell, the contents in PDCCH DCI format include:
a bit indicating preamble transmission or retransmission,
a field indicating the random access procedure for TA acquisition of LTM candidate cell(s) (i.e., a PRACH transmission (or retransmission) on a LTM candidate cell) is a bitmap with size equal to a number of configured LTM candidate cells (or configurations) by RRC configuration,
each bit of the bitmap corresponds to a configured LTM candidate cell (or configuration) from the number of configured LTM candidate cells (or configurations) in an ascending (or descending) order of the cell identity (or configuration identity). This mapping can be done from least significant bit (LSB) or most significant bit (MSB),
a bitmap, when the UE is provided a number of configured LTM candidate cells (or configurations) by RRC configuration, where:
the bitmap location is immediately after the bit location already used for their own purposes;
the bitmap size is equal to the number of configured LTM candidate cells (or configurations) where each bit of the bitmap corresponds to a configured LTM candidate cell (or configuration) from the number of configured LTM candidate cells (or configurations):
a “1” value (or “0” value) for a bit of the bitmap indicates a preamble transmission or re-transmission on the corresponding configured LTM candidate cell, and
a “0” value (or “1” value) for a bit of the bitmap indicates no preamble transmission or re-transmission on the corresponding configured LTM candidate cell. A UE can ignore this bit.
When a UE detects a “1” value for a bit of the bitmap, a UE is not required to detect the later bits to reduce the UE processing burden as they have “0” values, i.e., only one bit can have “1” value in the bitmap.
For preamble transmission or retransmission, the UE sets the active BWP (e.g., UL BWP) to the indicated active BWP (e.g., UL BWP) in PDCCH or the indicated active BWP (e.g., UL BWP) in RRC configuration (e.g., firstActiveBWP or firstActiveUplinkBWP or defaultBWP or defaultUplinkBWP or initialBWP or initialUplinkBWP)

A UE can be provided RRC configurations for PRACH transmission parameters, e.g., by LTM-CFRA-ToAddModList for LTM candidate cells. The UE can be triggered a PRACH transmission on a cell by a PDCCH order that the UE receives on a serving cell and includes an indication of the cell for the PRACH transmission. The UE transmits the PRACH on the cell. A UE can be provided by a MAC CE in a PDSCH reception on the serving cell, e.g., a TCI-State of uplink or downlink or both (i.e., joint UL/DL, a unified TCI state for applicable receptions or transmissions on a cell from the number of cells). The UE applies the TCI-State and/or TCI-UL-State and/or TCI-DL-State, if indicated by the MAC CE, from a first slot after the last symbol of a PUCCH or PUSCH with HARQ-ACK information for the PDSCH providing the MAC CE.

In this disclosure, the LTM procedures (e.g., LTM execution, random access procedure for TA acquisition of LTM candidate cell(s) (i.e., a PRACH transmission on a LTM candidate cell), etc.) are not applied (or not indicated or not performed) on dormant BWP, in order to ease UE implementation. The dormant BWP is one of downlink BWPs configured by the network via dedicated RRC signalling. In the dormant BWP, the UE stops monitoring PDCCH on/for the SCell, but continues performing CSI measurements, automatic gain control (AGC) and beam management, if configured. For each serving cell other than the SpCell or PUCCH SCell or LTM candidate cells, the network may configure one BWP as a dormant BWP. For example, the network does not configure one BWP (e.g., firstActiveDownlinkBWP or initialBWP or defaultBWP) as a dormant BWP for LTM candidate cells. For example, the dormant BWP is one of the UE's dedicated BWPs configured by a network via dedicated RRC signalling. The SpCell, PUCCH SCell, and LTM candidate cell cannot be configured with a dormant BWP.

It may be beneficial to have cross-layer interaction between MAC layer and RRC layer to make RRC layer perform RRC-specific behaviours (e.g., stop the supervisor timer for LTM execution procedure). For this reason, the following behaviours are set out:

Upon completion of the random access procedure, the MAC entity may, as shown in TABLE 27.

TABLE 27
1> discard any explicitly signalled contention-free random access Resources for 2-step RA
type and 4-step RA type except the 4-step RA type contention-free random access Resources
for beam failure recovery request, if any;
1> flush the HARQ buffer used for transmission of the MAC PDU in the Msg3 buffer and the
MSGA buffer.
Upon successful completion of the random access procedure initiated for DAPS handover, the
target MAC entity may:
1> indicate the successful completion of the random access procedure to the upper layers.
Upon successful completion of the random access procedure initiated for LTM execution (or
LTM cell switch or LTM execution procedure or by the reception of the first MAC CE), the
MAC entity may:
1> indicate the successful completion of the random access procedure (or the LTM
execution procedure) to the upper layers.
Upon successful completion of the LTM execution procedure initiated for LTM execution (or
LTM cell switch or by the reception of the first MAC CE), the MAC entity may:
1> indicate the successful completion of the LTM execution procedure to the upper layers.
For RACH-based LTM execution procedure (i.e., LTM execution procedure with random access
procedure), the UE considers that LTM execution procedure is successfully completed when the
RACH is successfully completed.

For RACH-less LTM execution procedure (i.e., LTM execution procedure without random access procedure), the UE considers that LTM execution procedure is successfully completed when the UE determines that the network has successfully received the first UL data (e.g., by checking HARQ ACK or RLC ACK for the first UL data or the reception of C-RNTI addressed PDCCH or upon the reception of UE contention resolution identify MAC CE).

The following relates to LTM Execution procedure (or LTM command).

In this disclosure, TA acquisition of candidate cell(s) before LTM cell switch command is supported as described. By this, as the source cell/DU gets to know the value and the validity of candidate cell TA, it can determine whether it can initiate a RACH-less solution for LTM cell switch and then determine whether it needs to include a beam indication (e.g., TCI state) and TA information in the first MAC CE (i.e., LTM command MAC CE) as described. Therefore, the network can indicate a valid TA to the UE or indicate whether a TA is still valid in the first MAC CE. Upon the reception of the TA information indicated in LTM MAC CE, the UE can apply the TA value and start the TA timer for the target LTM candidate cell upon LTM execution (i.e., LTM cell switch) and the UE can perform LTM cell switch without Random access procedure (i.e., with RACH-less solution) if TAT for the target LTM candidate cell is running (i.e., TA value is valid) or if Beam failure is not detected for the target LTM candidate cell, which means that the UE can monitor PDCCH from the target LTM candidate cell or the UE can use configured grants the first UL data transmission to the target cell for RACH-less LTM execution (LTM cell switch). Otherwise, the UE can perform LTM execution procedure with random access procedure.

In this disclosure, the first MAC CE to be sent to the UE can be generated by the source cell (or gNB), i.e., the MAC entity of the source cell (or gNB) generates the first MAC CE including the contents (e.g., TA value or BWP ID, Configuration Identity, etc. as described) and sends it to the UE in order to trigger LTM cell switch procedure.

In another embodiment, the first MAC CE to be sent to the UE can be generated by the target cell (or gNB or CU (Central Unit)), i.e., the MAC entity of the target cell (or gNB or CU (Central Unit)) generates the first MAC CE including the contents (e.g., TA value or BWP ID, Configuration Identity, etc. as described) and forwards it to the source cell (or DU (Distributed Unit)) (e.g., in Xn message via Xn interface or in RRC message or in F1-AP message), and the source cell (or DU) sends it to the UE in order to trigger LTM cell switch procedure.

To maintain Uplink time alignment efficiently, one of the following options for the behaviours of the MAC entity can be implemented:

RRC configures the following parameters for the maintenance of UL time alignment:
timeAlignmentTimer (per TAG) which controls how long the MAC entity considers the serving cells belonging to the associated TAG to be uplink time aligned.

Option 1: in this option, the timing advance command value (or field) is optional (i.e., can be either present or absent) in the first MAC CE (LTM command MAC CE). Upon the reception of the first MAC CE (LTM command MAC CE), the corresponding MAC behaviour is as follows:

The MAC entity may, as shown in TABLE 28.

TABLE 28
1> if the MAC entity receives an LTM command MAC CE on a serving cell:
2> indicate to upper layers that the LTM command MAC CE is received
(triggering the LTM cell switch procedure);
2> indicate to upper layers the target configuration ID (i.e., identifier for target
LTM candidate cell) included in the MAC CE;
2> if timing advance command value is present (or included) or if timing advance command
indicates that the timing advance value needs to be updated or is not valid anymore or if keeping
the timing advance or using the TA of the source cell(or Serving cell) is not indicated or if timing
advance command value is not set as a special value (e.g., 000..0 or 111...1):
3> process the received timing advance command. In another embodiment, the UE can
process the received timing advance command if timing advance command indicates that the
timing advance value needs to be updated or is not valid anymore or if keeping the timing
advance or using the TA of the source cell (or Serving cell) is not indicated, in order to avoid
unnecessary processing;
3> when an LTM command MAC CE including a timing advance command is received
(or if timing advance command indicates that the timing advance value needs to be updated or
is not valid anymore or if keeping the timing advance or using the TA of the source cell (or
Serving cell) is not indicated):
4> apply the timing advance command for the PTAG or the target LTM candidate cell (or
the indicated LTM candidate cell) (i.e., the UE can apply and store the timing advance value for
the PTAG or the target LTM candidate cell);
4> start or restart the timeAlignmentTimer associated with the PTAG or the target LTM
candidate cell(or the indicated LTM candidate cell); In another embodiment, the UE can start or
restart the timeAlignmentTimer associated with the PTAG or the target LTM candidate cell(or
the indicated LTM candidate cell) only if the timeAlignmentTimer associated with PTAG or the
target LTM candidate cell(or the indicated LTM candidate cell)is not running, in order to avoid
unnecessary update procedure.
3> indicate to upper layers to skip the random access procedure for this LTM cell switch
or the target LTM candidate cell (or the indicated LTM candidate cell). In another embodiment,
the UE can indicate to upper layers to skip the random access procedure for this LTM cell switch
or the target LTM candidate cell(or the indicated LTM candidate cell) if
TAT(timeAlignmentTimer) for the target/indicated LTM candidate cell (or PTAG) is running
(i.e., TA value is valid) or if Beam failure is not detected for the target LTM candidate cell (i.e.,
if BFI_COUNTER < beamFailureInstanceMaxCount for the target/indicated LTM candidate
cell (the number of Beam failure Indication is smaller than the maximum number for beam
failure detection).
2> else (if timing advance command value is absent (or not included) or if keeping the
timing advance or using the TA of the source cell (or Serving cell) is indicated or if timing
advance command value is set as a special value (e.g., 000..0 or 111...1):
3> indicate to upper layers that a random access procedure is needed for this LTM cell
switch or the target LTM candidate cell(or the indicated LTM candidate cell) or indicate to upper
layers to trigger the random access procedure for this LTM cell switch or the target LTM
candidate cell(or the indicated LTM candidate cell); In another embodiment, the UE can indicate
to upper layers that a random access procedure is needed for this LTM cell switch or the target
LTM candidate cell(or the indicated LTM candidate cell) if TAT(timeAlignmentTimer) for the
target/indicated LTM candidate cell (or PTAG) is not running (i.e., TA value is not valid) or if
Beam failure is detected for the target/indicated LTM candidate cell (i.e., if BFI_COUNTER >=
beamFailureInstanceMaxCount for the target/indicated LTM candidate cell(or PTAG) (the
number of Beam failure Indication is larger than or equal to the maximum number for beam
failure detection).
3> the UE can ignore the received timing advance command in order to avoid unnecessary
update procedure.
2> if TCI state information is included:
3> consider the SSB corresponding to the indicated TCI state as the selected SSB for the
initial uplink transmission towards the candidate cell;
3> indicate to lower layers the information regarding the TCI state information included in
the LTM command MAC CE.

Option 2: in this option, the timing advance command value (or field) is always present in the first MAC CE (LTM command MAC CE). Upon the reception of the first MAC CE (LTM command MAC CE), the corresponding MAC behaviour is as follows:

The MAC entity may, as shown in TABLE 29.

TABLE 29
1> if the MAC entity receives an LTM command MAC CE on a serving cell:
2> indicate to upper layers that the LTM command MAC CE is received
(triggering the LTM cell switch procedure);
2> indicate to upper layers the target configuration ID (i.e., identifier for target
LTM candidate cell) included in the MAC CE;
2> if timing advance command value is not set as a special value (e.g., 000..0 or 111...1) or if
timing advance command indicates that the timing advance value needs to be updated or is not
valid anymore:
3> process the received timing advance command;
3> when an LTM command MAC CE including a timing advance command is received:
4> apply the timing advance command for the PTAG or the target LTM candidate cell (or
the indicated LTM candidate cell) (i.e., the UE can apply and store the timing advance value for
the PTAG or the target LTM candidate cell);
4> start or restart the timeAlignmentTimer associated with the PTAG or the target LTM
candidate cell(or the indicated LTM candidate cell); In another embodiment, the UE can start or
restart the timeAlignmentTimer associated with the PTAG or the target LTM candidate cell(or
the indicated LTM candidate cell) only if the timeAlignmentTimer associated with PTAG or the
target LTM candidate cell(or the indicated LTM candidate cell)is not running, in order to avoid
unnecessary update procedure.
3> indicate to upper layers to skip the random access procedure for this LTM cell switch
or the target LTM candidate cell (or the indicated LTM candidate cell). In another embodiment,
the UE can indicate to upper layers to skip the random access procedure for this LTM cell switch
or the target LTM candidate cell(or the indicated LTM candidate cell) if
TAT(timeAlignmentTimer) for the target/indicated LTM candidate cell (or PTAG) is running
(i.e., TA value is valid) or if Beam failure is not detected for the target LTM candidate cell (i.e.,
if BFI_COUNTER < beamFailureInstanceMaxCount for the target/indicated LTM candidate
cell (the number of Beam failure Indication is smaller than the maximum number for beam
failure detection).
2> else (if timing advance command value is set as a special value (e.g., 000..0 or 111...1)):
3> indicate to upper layers that a random access procedure is needed for this LTM cell
switch or the target LTM candidate cell(or the indicated LTM candidate cell) or indicate to upper
layers to trigger the random access procedure for this LTM cell switch or the target LTM
candidate cell(or the indicated LTM candidate cell); In another embodiment, UE can indicate to
upper layers that a random access procedure is needed for this LTM cell switch or the target
LTM candidate cell(or the indicated LTM candidate cell) if TAT(timeAlignmentTimer) for the
target/indicated LTM candidate cell (or PTAG) is not running (i.e., TA value is not valid) or if
Beam failure is detected for the target/indicated LTM candidate cell (i.e., if BFI_COUNTER >=
beamFailureInstanceMaxCount for the target/indicated LTM candidate cell(or PTAG) (the
number of Beam failure Indication is larger than or equal to the maximum number for beam
failure detection).
3> the UE can ignore the received timing advance command in order to avoid unnecessary
update procedure.
2> if TCI state information is included:
3> consider the SSB corresponding to the indicated TCI state as the selected SSB for the
initial uplink transmission towards the candidate cell;
3> indicate to lower layers the information regarding the TCI state information included in
the LTM command MAC CE.

In this disclosure, alternatively, the TA value (e.g., timing advance command) can be configured in each LTM candidate cell configuration in an RRCReconfiguration message, and can be applied to the UE or the maintenance of TAT timers.

The network may activate and deactivate the TCI states of LTM candidate cell(s) configured in RRC configuration by sending the fourth MAC CE (i.e., LTM candidate cell TCI States activation/deactivation MAC CE described) To enable this, several options to activate and deactivate the TCI states upon LTM execution and one of the options can be implemented:
Option 1: in this option, the transmission for the fourth MAC CE to the transmission together with the first MAC CE (LTM command MAC CE described) may be restricted. For example, the network can send the fourth MAC CE together with the first MAC CE (i.e., both MAC CEs can be included in the same MAC PDU) to activate and deactivate the TCI states for LTM cell switch. If the MAC entity receives a candidate cell TCI States activation/deactivation MAC CE on a serving cell, it indicates to lower layers (i.e., PHY layer (Physical layer)) the information regarding the candidate cell TCI States activation/deactivation MAC CE for the indicated LTM candidate cell from the first MAC CE. If the fourth MAC CE is not received (e.g., with the first MAC CE), the MAC entity indicates to the lower layers the usage of the indicated (or configured) TCI by RRCReconfiguration for the indicated LTM candidate cell from the first MAC CE, or the lower layers uses the indicated (or configured) TCI by RRCReconfiguration for the indicated LTM candidate cell from the first MAC CE.
Option 2: in this option, the transmission for the fourth MAC CE may not be restricted, i.e., the network can send the fourth MAC CE before the transmission of the first MAC CE or regardless of the transmission of the first MAC CE (LTM command MAC CE described), in order to activate and deactivate the TCI states for LTM cell switch. However, even if the MAC entity receives a candidate cell TCI States activation/deactivation MAC CE on a serving cell, it indicates to lower layers (i.e., PHY layer (Physical layer)) the information regarding the candidate cell TCI States activation/deactivation MAC CE for the indicated LTM candidate cell from the first MAC CE upon the reception of the first MAC CE or upon LTM execution. If the fourth MAC CE was not received, the MAC entity indicates to the lower layers the usage of the indicated (or configured) TCI by RRCReconfiguration for the indicated LTM candidate cell from the first MAC CE or the lower layers uses the indicated (or configured) TCI by RRCReconfiguration for the indicated LTM candidate cell from the first MAC CE upon the reception of the first MAC CE or upon LTM execution.

The following relates to activation/deactivation of SCG.

RRC configures the following parameters in the beamFailureRecoveryConfig, beamFailureRecoverySpCellConfig, beamFailureRecoverySCellConfig and the radioLinkMonitoringConfig for the Beam Failure Detection and Recovery procedure:
beamFailureInstanceMaxCount for the beam failure detection (per serving cell or per BFD-RS set of serving cell configured with two BFD-RS sets);
beamFailureDetectionTimer for the beam failure detection (per serving cell or per BFD-RS set of serving cell configured with two BFD-RS sets); and/or
beamFailureRecoveryTimer for the beam failure recovery procedure for SpCell.

The following UE variables are used for the beam failure detection procedure:
BFI_COUNTER (per serving cell or per BFD-RS set of serving cell configured with two BFD-RS sets): counter for beam failure instance indication which is initially set to 0.

The network may activate and deactivate the configured SCG.

The MAC entity may for the configured SCG as shown in TABLE 30.

TABLE 30
1> if upper layers indicate that SCG is activated:
2> if BFI_COUNTER >= beamFailureInstanceMaxCount for the PSCell or the
timeAlignmentTimer associated with PTAG is not running:
3> indicate to upper layers that a random access procedure is needed for SCG activation.
2> activate the SCG according to the timing.
2> (re-)initialize any suspended configured uplink grants of configured grant Type 1
associated with this PSCell according to the stored configuration, if any, and to start in the
symbol according to rules;
2> apply normal SCG operation including:
3> SRS transmissions on the PSCell;
3> CSI reporting for the PSCell;
3> PDCCH monitoring on the PSCell;
3> PUCCH transmissions on the PSCell;
3> transmit on RACH on the PSCell;
3> initialize Bj for each logical channel to zero.
1> else if upper layers indicate that the SCG is deactivated:
2> deactivate all the SCells of the SCG;
2> deactivate SCG according to the timing;
2> clear any configured downlink assignment and any configured uplink grant Type 2
associated with the PSCell respectively;
2> suspend any configured uplink grant Type 1 associated with the PSCell;
2> reset MAC.
1> if the SCG is deactivated:
2> not transmit SRS on the PSCell;
2> not report CSI for the PSCell;
2> not transmit on UL-SCH on the PSCell;
2> not transmit PUCCH on the PSCell;
2> not transmit on RACH on the PSCell;
2> not monitor the PDCCH on the PSCell.

The network may activate and deactivate the configured SCG when a UE is configured with dual connectivity.

In relation to reconfiguration with sync, the UE may perform the following actions to execute a reconfiguration with sync as shown in TABLE 31.

TABLE 31
1> if the AS security is not activated, perform the actions upon going to RRC_IDLE as
specified in 5.3.11 with the release cause “other” upon which the procedure ends;
1> stop timer T430 if running;
1> start timer T430 with the timer value set to ntn-UlSyncValidityDuration from the
subframe indicated by epochTime, according to the target cell NTN-config;
1> if no DAPS bearer is configured:
2> stop timer T310 for the corresponding SpCell, if running;
1> if this procedure is executed for the MCG:
2> if timer T316 is running;
3> stop timer T316;
3> clear the information included in VarRLF-Report, if any;
2> resume MCG transmission, if suspended.
1> stop timer T312 for the corresponding SpCell, if running;
1> if sl-PathSwitchConfig is included:
2> consider the target L2 U2N relay UE to be the one indicated by the targetRelayUE-
Identity in the sl-PathSwitchConfig;
2> start timer T420 for the corresponding target L2 U2N relay UE with the timer value set
to T420, as included in the sl-PathSwitchConfig;
2> apply the value of the newUE-Identity as the C-RNTI;
2> indicate to upper layer (to trigger the PC5 unicast link establishment) with the target L2
U2N relay UE indicated by the targetRelayUE-Identity;
2> apply the default configuration of SL-RLC1 as defined in 9.2.4 for SRB1;
1> else (sl-PathSwitchConfig is not included):
2> if this procedure is executed for the MCG or if this procedure is executed for an SCG
not indicated as deactivated in the E-UTRA or NR RRC message in which the
RRCReconfiguration message is embedded:
3> start timer T304 for the corresponding SpCell with the timer value set to t304, as
included in the reconfigurationWithSync;
2> if the frequencyInfoDL is included:
3> consider the target SpCell to be one on the SSB frequency indicated by the
frequencyInfoDL with a physical cell identity indicated by the physCellId;
2> else:
3> consider the target SpCell to be one on the SSB frequency of the source SpCell with a
physical cell identity indicated by the physCellId;
2> start synchronising to the DL of the target SpCell;
2> apply the specified BCCH configuration defined in 9.1.1.1 for the target SpCell;
2> acquire the MIB of the target SpCell, which is scheduled;

In relation to T304 expiry (Reconfiguration with sync Failure) or T420 expiry (Path switch failure), the UE may, as shown in TABLE 32.

TABLE 32
1> if T304 of the MCG expires; or
1> if T420 expires; or,
1> if the target L2 U2N relay UE (i.e., the UE indicated by targetRelayUE-Identity in the
received RRCReconfiguration message containing reconfigurationWithSync indicating path
switch as specified in 5.3.5.5.2) changes its serving PCell before path switch:
2> release dedicated preambles provided in rach-ConfigDedicated if configured;
2> release dedicated msgA PUSCH resources provided in rach-ConfigDedicated if
configured;
2> if any DAPS bearer is configured, and radio link failure is not detected in the source
PCell:
3> reset MAC for the target PCell and release the MAC configuration for the target PCell;
3> for each DAPS bearer:
4> release the RLC entity or entities, and the associated logical channel for the target PCell;
4> reconfigure the PDCP entity to release DAPS;
3> for each SRB:
4> if the masterKeyUpdate was not received:
5> configure the PDCP entity for the source PCell with state variables continuation;
4> release the PDCP entity for the target PCell;
4> release the RLC entity, and the associated logical channel for the target PCell;
4> trigger the PDCP entity for the source PCell to perform SDU discard;
4> re-establish the RLC entity for the source PCell;
3> release the physical channel configuration for the target PCell;
3> discard the keys used in target PCell (the K_{gNB} key, the K_{RRCenc} key, the K_{RRCint} key, the
K_{UPint} key and the K_{UPenc} key), if any;
3> resume suspended SRBs in the source PCell;
3> for each non-DAPS bearer:
4> revert back to the UE configuration used for the DRB or multicast MRB in the source
PCell, includes PDCP, RLC states variables, the security configuration and the data stored in
transmission and reception buffers in PDCP and RLC entities;
3> revert back to the UE measurement configuration used in the source PCell;
3> store the handover failure information in VarRLF-Report;
3> initiate the failure information procedure to report DAPS handover failure.
2> else:
3> revert back to the UE configuration used in the source PCell;
3> if the associated T304 was not initiated upon cell selection performed while timer T311
was running:
4> store the handover failure information in VarRLF-Report;
3> initiate the connection re-establishment procedure.
NOTE 1: In the context above, “the UE configuration” includes state variables and
parameters of each radio bearer.
1> else if T304 of a secondary cell group expires:
2> if MCG transmission is not suspended:
3> release dedicated preambles provided in rach-ConfigDedicated, if configured;
3> release dedicated msgA PUSCH resources provided in rach-ConfigDedicated, if
configured;
3> initiate the SCG failure information procedure to report SCG reconfiguration with sync
failure, upon which the RRC reconfiguration procedure ends;
2> else:
3> if the UE is in NR-DC:
4> initiate the connection re-establishment procedure;
3> else (the UE is in (NG) EN-DC):
4> initiate the connection re-establishment procedure as specified;
1> else if T304 expires when RRCReconfiguration is received via other RAT (HO to NR
failure):
2> reset MAC;
2> perform the actions defined for this failure case as defined in the specifications
applicable for the other RAT.

NOTE 2: In this clause, the term “handover failure” has been used to refer to “reconfiguration with sync failure.”

The following relates to maintenance of uplink time alignment for MCG or SCG.

The section can be applied to either MCG MAC entity or SCG MAC entity. In embodiments of this disclosure, timeAlignmentTimer(s) for LTM candidate cells (or a new TAG (timing advance group, i.e., TAG which the LTM candidate cell (or the target LTM candidate cell) belong to) for LTM candidate cells) and its behaviours as follows:

In this disclosure, alternatively, the TA value (e.g., timing advance command) can be configured in each LTM candidate cell configuration in RRCReconfiguration message, and can be applied to the UE or the maintenance of TAT timers. The TA value (e.g., timing advance command) can be received or configured by the first MAC CE.

RRC configures the following parameters for the maintenance of UL time alignment:
TAT (timeAlignmentTimer) (per TAG) which controls how long the MAC entity considers the serving cells belonging to the associated TAG to be uplink time aligned;
inactivePosSRS-TimeAlignmentTimer which controls how long the MAC entity considers the Positioning SRS transmission in RRC_INACTIVE to be uplink time aligned; and/or
cg-SDT-TimeAlignmentTimer which controls how long the MAC entity considers the uplink transmission for CG-SDT to be uplink time aligned.

The MAC entity may, as shown in TABLE 33.

TABLE 33
1> when a timing advance command MAC CE is received, and if an N_{TA} (timing advance
value) has been maintained with the indicated TAG; or
1> when the first MAC CE is received or if an N_{TA} (timing advance value) has been
maintained with the indicated TAG (or indicated target LTM cell or TAG which the indicated
target LTM cell belong to);
2> apply the timing advance command for the indicated TAG;
2> if there is ongoing Positioning SRS Transmission in RRC_INACTIVE:
3> start or restart the inactivePosSRS-TimeAlignmentTimer associated with the indicated
TAG.
2> if CG-SDT procedure triggered is ongoing:
3> start or restart the cg-SDT-TimeAlignmentTimer associated with the indicated TAG.
2> else:
3> start or restart the timeAlignmentTimer associated with the indicated TAG (or indicated
target LTM cell or TAG which the indicated target LTM cell belong to).
In another embodiment, the MAC entity may:
1> when the first MAC CE is received or if an N_{TA} (timing advance value) has been
maintained with the indicated TAG (or indicated target LTM cell or TAG which the indicated
target LTM cell belong to);
2> apply the timing advance command for the indicated TAG (or indicated target LTM cell
or TAG which the indicated target LTM cell belong to);
2> start or restart the timeAlignmentTimer associated with the indicated TAG (or indicated
target LTM cell or TAG which the indicated target LTM cell belong to).
1> when a timing advance command MAC CE is received, and if an N_{TA} has been
maintained with the indicated TAG; or
2> apply the timing advance command for the indicated TAG;
2> if there is ongoing Positioning SRS Transmission in RRC_INACTIVE:
3> start or restart the inactivePosSRS-TimeAlignmentTimer associated with the indicated
TAG.
2> if CG-SDT procedure triggered is ongoing:
3> start or restart the cg-SDT-TimeAlignmentTimer associated with the indicated TAG.
2> else:
3> start or restart the timeAlignmentTimer associated with the indicated TAG.

For LTM cell switch procedure, the expiry of timeAlignmentTimer associated with the PTAG may be carefully handled. As the expiry of timeAlignmentTimer associated with the PTAG makes a UR to consider all running timeAlignmentTimers as expired, the network may be difficult to indicate subsequent LTM cell switch due to the invalidity of TA of LTM candidate cells. To maintain the validity of TA of LTM candidate cells, the UE can maintain the timeAlignmentTimer(s) for LTM candidate cells (or a new TAG (timing advance group, i.e., TAG which the LTM candidate cell (or the target LTM candidate cell) belong to) for LTM candidate cells) or keep them running. How to handle the expiry of timeAlignmentTimer can be managed as follows (which can be applied to MCG MAC entity or SCG MAC entity) as shown in TABLE 34.

TABLE 34
1> when a timeAlignmentTimer expires:
2> if the timeAlignmentTimer is associated with the PTAG:
3> flush all HARQ buffers for all serving cells;
3> notify RRC to release PUCCH for all serving cells, if configured;
3> notify RRC to release SRS for all serving cells, if configured;
3> clear any configured downlink assignments and configured uplink grants;
3> clear any PUSCH resource for semi-persistent CSI reporting;
3> consider all running timeAlignmentTimers except timeAlignmentTimer(s) for LTM
candidate cells (or a new TAG (timing advance group, i.e., TAG which the LTM candidate cells
(or the target LTM candidate cell) belong to) for LTM candidate cells) (or if LTM candidate
cell configuration is configured) as expired;
3> maintain N_{TA} (timing advance value) of all TAGs.
2> else if the timeAlignmentTimer is associated with an STAG, then for all serving cells
belonging to this TAG:
3> flush all HARQ buffers;
3> notify RRC to release PUCCH, if configured;
3> notify RRC to release SRS, if configured;
3> clear any configured downlink assignments and configured uplink grants;
3> clear any PUSCH resource for semi-persistent CSI reporting;
3> maintain N_{TA} (timing advance value) of this TAG.

The following relates to MAC reset.

As described, the MAC reset can be requested or indicated by upper layer (e.g., RRC layer) upon the LTM execution or the reception of the first MAC CE or when the condition for successful completion of LTM cell switch (LTM execution) is met. If the MAC reset is requested before the successful completion of LTM cell switch, the subsequent LTM cell switch or LTM execution failure (i.e., LTM cell switch failure) may be difficult to be handled because the beam failure detection or maintenance of uplink time alignment (i.e., TAT or TA value) for the PCell or LTM candidate cells or the source serving cell may be stopped by stopping all timers at MAC reset. To resolve this issue, the UE can stop (if running) all timers except beamFailureDetectionTimer associated with PCell (or the source cell or serving cell or LTM candidate cells) or timeAlignmentTimers or (e.g., timeAlignmentTimer(s) for LTM candidate cell(s) or PCell or the source cell or serving cell or LTM candidate cells) in the MAC reset procedures as described below.

If a reset of the MAC entity is requested by upper layers or the reset of the MAC entity is triggered due to SCG deactivation as described, the MAC entity may, as shown in TABLE 35.

TABLE 35
1> if the MAC reset is not due to SCG deactivation:
2> initialize Bj for each logical channel to zero;
1> initialize SBj for each logical channel to zero if Sidelink resource allocation mode 1 is
configured by RRC;
1> if upper layers indicate SCG deactivation and bfd-and-RLM with value true is
configured for the deactivated SCG:
2> stop (if running) all timers except beamFailureDetectionTimer associated with PSCell
and timeAlignmentTimers.
1> else if LTM execution has been triggered or LTM execution has been successfully
completed or MAC rest is triggered due to LTM execution (or LTM cell switch) or LTM
candidate cell configuration is configured:
2> stop (if running) all timers except beamFailureDetectionTimer associated with PCell
(or SpCell or the source cell or serving cell or LTM candidate cells) or timeAlignmentTimers or
(e.g., timeAlignmentTimer(s) for LTM candidate cell(s) or PCell or SpCell or the source cell or
serving cell or LTM candidate cells).
1> else:
2> stop (if running) all timers, except MBS broadcast DRX timers;
2> consider all timeAlignmentTimers, inactivePosSRS-TimeAlignmentTimer, and cg-SDT-
TimeAlignmentTimer, if configured, as expired and perform the corresponding actions;
1> set the NDIs for all uplink HARQ processes to the value 0;
1> sets the NDIs for all HARQ process IDs to the value 0 for monitoring PDCCH in
Sidelink resource allocation mode 1;
1> stop, if any, ongoing random access procedure;
1> discard explicitly signalled contention-free random access Resources for 4-step RA type
and 2-step RA type, if any;
1> flush Msg3 buffer;
1> flush MSGA buffer;
1> cancel, if any, triggered Scheduling Request procedure;
1> cancel, if any, triggered Buffer Status Reporting procedure;
1> cancel, if any, triggered Power Headroom Reporting procedure;
1> cancel, if any, triggered consistent LBT failure;
1> cancel, if any, triggered BFR;
1> cancel, if any, triggered Sidelink Buffer Status Reporting procedure;
1> cancel, if any, triggered Pre-emptive Buffer Status Reporting procedure;
1> cancel, if any, triggered timing advance Reporting procedure;
1> cancel, if any, triggered Recommended bit rate query procedure;
1> cancel, if any, triggered Configured uplink grant confirmation;
1> cancel, if any, triggered configured sidelink grant confirmation;
1> cancel, if any, triggered Desired Guard Symbol query;
1> cancel, if any, triggered Positioning Measurement Gap activation/deactivation Request
procedure;
1> cancel, if any, triggered SDT procedure;
1> flush the soft buffers for all DL HARQ processes, except for the DL HARQ process
being used for MBS broadcast;
1> for each DL HARQ process, except for the DL HARQ process being used for MBS
broadcast, consider the next received transmission for a TB as the very first transmission;
1> release, if any, Temporary C-RNTI;
1> if upper layers indicate SCG deactivation and bfd-and-RLM with value true is not
configured; or
1> if the MAC reset is not due to SCG deactivation:
2> reset all BFI_COUNTERs;
1> reset all LBT_COUNTERs.

In another embodiment, the following procedures to implement that the U can stop (if running) all timers except beamFailureDetectionTimer associated with PCell (or SpCell or the source cell or serving cell or LTM candidate cells) or timeAlignmentTimers or (e.g., timeAlignmentTimer(s) for LTM candidate cell(s) or SpCell or PCell or the source cell or serving cell or LTM candidate cells) in the MAC reset procedures.

If a reset of the MAC entity is requested by upper layers or the reset of the MAC entity is triggered due to SCG deactivation as defined, the MAC entity may, as shown in TABLE 36.

TABLE 36
1> if the MAC reset is not due to SCG deactivation:
2> initialize Bj for each logical channel to zero;
1> initialize SBj for each logical channel to zero if Sidelink resource allocation mode 1 is
configured by RRC;
1> if upper layers indicate SCG deactivation and bfd-and-RLM with value true is
configured for the deactivated SCG:
2> stop (if running) all timers except beamFailureDetectionTimer associated with PSCell
and timeAlignmentTimers.
1> else:
2> stop (if running) all timers, except MBS broadcast DRX timers or
beamFailureDetectionTimer associated with PCell (or SpCell or the source cell or serving cell
or LTM candidate cells) or timeAlignmentTimers or (e.g., timeAlignmentTimer(s) for LTM
candidate cell(s) or PCell or SpCell or the source cell or serving cell or LTM candidate cells).;
2> consider all timeAlignmentTimers, inactivePosSRS-TimeAlignmentTimer, and cg-SDT-
TimeAlignmentTimer, if configured, as expired and perform the corresponding actions;
1> set the NDIs for all uplink HARQ processes to the value 0;
1> sets the NDIs for all HARQ process IDs to the value 0 for monitoring PDCCH in
Sidelink resource allocation mode 1;
1> stop, if any, ongoing random access procedure;
1> discard explicitly signalled contention-free random access Resources for 4-step RA type
and 2-step RA type, if any;
1> flush Msg3 buffer;
1> flush MSGA buffer;
1> cancel, if any, triggered Scheduling Request procedure;
1> cancel, if any, triggered Buffer Status Reporting procedure;
1> cancel, if any, triggered Power Headroom Reporting procedure;
1> cancel, if any, triggered consistent LBT failure;
1> cancel, if any, triggered BFR;
1> cancel, if any, triggered Sidelink Buffer Status Reporting procedure;
1> cancel, if any, triggered Pre-emptive Buffer Status Reporting procedure;
1> cancel, if any, triggered timing advance Reporting procedure;
1> cancel, if any, triggered Recommended bit rate query procedure;
1> cancel, if any, triggered Configured uplink grant confirmation;
1> cancel, if any, triggered configured sidelink grant confirmation;
1> cancel, if any, triggered Desired Guard Symbol query;
1> cancel, if any, triggered Positioning Measurement Gap activation/deactivation Request
procedure;
1> cancel, if any, triggered SDT procedure;
1> flush the soft buffers for all DL HARQ processes, except for the DL HARQ process
being used for MBS broadcast;
1> for each DL HARQ process, except for the DL HARQ process being used for MBS
broadcast, consider the next received transmission for a TB as the very first transmission;
1> release, if any, Temporary C-RNTI;
1> if upper layers indicate SCG deactivation and bfd-and-RLM with value true is not
configured; or
1> if the MAC reset is not due to SCG deactivation:
2> reset all BFI_COUNTERs;
1> reset all LBT_COUNTERs.

This procedure can be extended to the UE configured with dual connectivity (i.e., MCG and SCG) in order to ease subsequent LTM execution in SCG. For example, if the MAC reset is requested by upper layers (i.e., RRC layer) due to the successful completion of handover for SCG (e.g., if reconfigurationWithSync was included in spCellConfig of an SCG and when MAC of an NR cell group successfully completes a random access procedure triggered or the successful completion of SCG activation) or LTM execution for SCG or the successful completion of LTM execution for SCG, the UE stops (if running) all timers, except MBS broadcast DRX timers or beamFailureDetectionTimer associated with PCell (or SpCell or the source cell or serving cell or LTM candidate cells) or timeAlignmentTimers or (e.g., timeAlignmentTimer(s) for LTM candidate cell(s) or PCell or SpCell or the source cell or serving cell or LTM candidate cells). However, if the MAC reset is requested by upper layers (i.e., RRC layer) due to SCG deactivation, the UE stops (if running) all timers except beamFailureDetectionTimer associated with PSCell and timeAlignmentTimers, in order to monitor Radio link for the PSCell. The detailed procedures are as follows.

If a reset of the MAC entity is requested by upper layers or the reset of the MAC entity is triggered due to SCG deactivation as defined, the MAC entity may, as shown in TABLE 37.

TABLE 37
1> if the MAC reset is not due to SCG deactivation:
2> initialize Bj for each logical channel to zero;
1> initialize SBj for each logical channel to zero if Sidelink resource allocation mode 1 is
configured by RRC;
1> if upper layers indicate SCG deactivation and bfd-and-RLM (indicator to maintain
Beam failure detection (BFD) and radio link monitoring (RLM)) with value true is configured
for the deactivated SCG:
2> stop (if running) all timers except beamFailureDetectionTimer associated with PSCell
and timeAlignmentTimers.
1> else (e.g., if reconfigurationWithSync was included in spCellConfig of an SCG and
when MAC of an NR cell group successfully completes a random access procedure triggered or
the successful completion of SCG activation) or LTM execution for SCG or the successful
completion of LTM execution for SCG):
2> stop (if running) all timers, except MBS broadcast DRX timers or
beamFailureDetectionTimer associated with PCell (or SpCell or the source cell or serving cell
or LTM candidate cells) or timeAlignmentTimers or (e.g., timeAlignmentTimer(s) for LTM
candidate cell(s) or PCell or SpCell or the source cell or serving cell or LTM candidate cells).;
2> consider all timeAlignmentTimers, inactivePosSRS-TimeAlignmentTimer, and cg-SDT-
TimeAlignmentTimer, if configured, as expired and perform the corresponding actions;
1> set the NDIs for all uplink HARQ processes to the value 0;
1> sets the NDIs for all HARQ process IDs to the value 0 for monitoring PDCCH in
Sidelink resource allocation mode 1;
1> stop, if any, ongoing random access procedure;
1> discard explicitly signalled contention-free random access Resources for 4-step RA type
and 2-step RA type, if any;
1> flush Msg3 buffer;
1> flush MSGA buffer;
1> cancel, if any, triggered Scheduling Request procedure;
1> cancel, if any, triggered Buffer Status Reporting procedure;
1> cancel, if any, triggered Power Headroom Reporting procedure;
1> cancel, if any, triggered consistent LBT failure;
1> cancel, if any, triggered BFR;
1> cancel, if any, triggered Sidelink Buffer Status Reporting procedure;
1> cancel, if any, triggered Pre-emptive Buffer Status Reporting procedure;
1> cancel, if any, triggered timing advance Reporting procedure;
1> cancel, if any, triggered Recommended bit rate query procedure;
1> cancel, if any, triggered Configured uplink grant confirmation;
1> cancel, if any, triggered configured sidelink grant confirmation;
1> cancel, if any, triggered Desired Guard Symbol query;
1> cancel, if any, triggered Positioning Measurement Gap activation/deactivation Request
procedure;
1> cancel, if any, triggered SDT procedure;
1> flush the soft buffers for all DL HARQ processes, except for the DL HARQ process
being used for MBS broadcast;
1> for each DL HARQ process, except for the DL HARQ process being used for MBS
broadcast, consider the next received transmission for a TB as the very first transmission;
1> release, if any, Temporary C-RNTI;
1> if upper layers indicate SCG deactivation and bfd-and-RLM with value true is not
configured; or
1> if the MAC reset is not due to SCG deactivation:
2> reset all BFI_COUNTERs;
1> reset all LBT_COUNTERs.

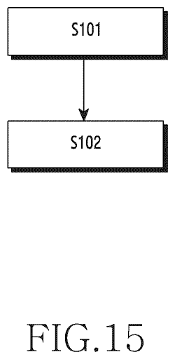

For the sake of completeness, FIG. 15 shows a flowchart illustrating an embodiment of the present disclosure.

At step S101, the UE receives RRCReconfiguration containing LTM target cell information and RRCReconfigurationComplete is sent to a source cell.

At S102, upon receipt of a MAC control element (CE) from the source cell, the target cell information is applied, a handover is performed, and a further RRCReconfigurationComplete is generated and sent to the target cell upon completion of the handover.

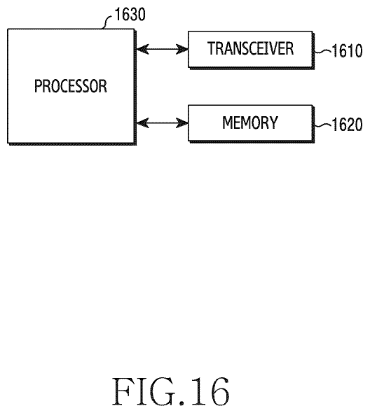

FIG. 16 illustrates a terminal (or a user equipment (UE)) according to various embodiments of the present disclosure.

As shown in FIG. 16, a terminal according to an embodiment may include a transceiver 1610, a memory 1620, and a processor (or a controller) 1630. The transceiver 1610, the memory 1620, and the processor (or controller) 1630 of the terminal may operate according to a communication method of the terminal described above. However, the components of the terminal are not limited thereto. For example, the terminal may include more or fewer components than those described in FIG. 16. In addition, the processor (or controller) 1630, the transceiver 1610, and the memory 1620 may be implemented as a single chip. Also, the processor (or controller) 1630 may include at least one processor.

The transceiver 1610 collectively refers to a terminal station receiver and a terminal transmitter, and may transmit/receive a signal to/from a base station or another terminal. The signal transmitted or received to or from the terminal may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor (or controller) 1630, a signal through a wireless channel, and transmit a signal output from the processor (or controller) 1630 through the wireless channel.

The memory 1620 may store a program and data required for operations of the terminal. Also, the memory 1620 may store control information or data included in a signal obtained by the terminal. The memory 1620 may be a storage medium, such as read-only memory (ROM), random access memory (RAM), a hard disk, a CD-ROM, and a DVD, or a combination of storage media.

The processor (or controller) 1630 may control a series of processes such that the terminal operates as described above. For example, the processor (or controller) 1630 may receive a data signal and/or a control signal, and the processor (or controller) 1630 may determine a result of receiving the signal transmitted by the base station and/or the other terminal.

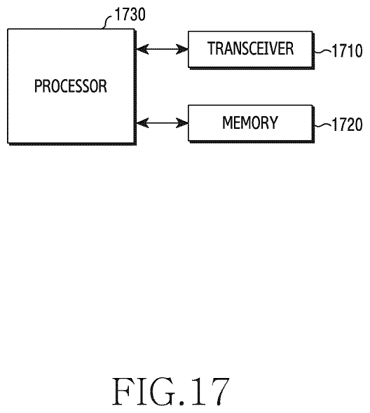

FIG. 17 illustrates a base station according to various embodiments of the present disclosure.

As shown in FIG. 17, the base station of the present disclosure may include a transceiver 1710, a memory 1720, and a processor (or, a controller) 1730. The transceiver 1710, the memory 1720, and the processor (or controller) 1730 of the base station may operate according to a communication method of the base station described above. However, the components of the base station are not limited thereto. For example, the base station may include more or fewer components than those described in FIG. 17. In addition, the processor (or controller) 1730, the transceiver 1710, and the memory 1720 may be implemented as a single chip. Also, the processor (or controller) 1730 may include at least one processor.

The transceiver 1710 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 1710 may include a RF transmitter for up-converting and amplifying a frequency of a transmitted signal, and a RF receiver for amplifying low-noise and down-converting a frequency of a received signal. However, this is only an example of the transceiver 1710 and components of the transceiver 1710 are not limited to the RF transmitter and the RF receiver.

Also, the transceiver 1710 may receive and output, to the processor (or controller) 1730, a signal through a wireless channel, and transmit a signal output from the processor (or controller) 1730 through the wireless channel.

The memory 1720 may store a program and data required for operations of the base station. Also, the memory 1720 may store control information or data included in a signal obtained by the base station. The memory 1720 may be a storage medium, such as ROM, RAM, a hard disk, a CD-ROM, and a DVD, or a combination of storage media.

The processor (or controller) 1730 may control a series of processes such that the base station operates as described above. For example, the processor (or controller) 1730 may receive a data signal and/or a control signal, and the processor (or controller) 1730 may determine a result of receiving the signal transmitted by the terminal and/or the core network function.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

According to an embodiment of the disclosure, a method of performing L1/L2 triggered mobility, LTM, in a user equipment (UE) communicatively coupled to a telecommunication network is provided. Wherein if the UE receives RRCReconfiguration containing LTM target cell information, RRCReconfigurationComplete is sent to a source cell, and upon receipt of a MAC control element (CE) from the source cell, the target cell information is applied, a handover is performed, and a further RRCReconfigurationComplete is generated and sent to the target cell upon completion of the handover.

According to an embodiment of the disclosure, wherein if dual connectivity (DC) is enabled for the UE, then LTM configuration information can be set for either master cell group (MCG) or secondary cell group (SCG), respectively, and can be set to signaling radio bearer 1 (SRB1) or signaling radio bearer 3 (SRB3).

According to an embodiment of the disclosure, wherein if an LTM cell change is instructed for SCG, and if SRB1 is included in nr-SCG and instructed to set LTM for the SCG, a second RRCReconfigurationComplete message is generated after LTM is executed, SCG LTM settings are applied, and sent to SRB1 as part of the ULInformationTransferMRDC message or if the LTM settings for the SCG are instructed by SRB3, and if it is not received as a DLInformationTransferMRDC message, a second RRCReconfigurationComplete message is generated after LTM is executed, the SCG LTM settings are applied, and sent to SRB3.

According to an embodiment of the disclosure, an apparatus arranged to perform the method of any preceding claim is provided.

Attention is directed to all papers and documents which are filed concurrently with or previous to this disclosure in connection with this application and which are open to public inspection with this disclosure, and the contents of all such papers and documents are incorporated herein by reference.

All of the features disclosed in this disclosure (including any accompanying claims, abstract and drawings), and/or all of the steps of any method or process so disclosed, may be combined in any combination, except combinations where at least some of such features and/or steps are mutually exclusive.

Each feature disclosed in this disclosure (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this disclosure (including any accompanying claims, abstract and drawings), or to any novel one, or any novel combination, of the steps of any method or process so disclosed.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a radio resource control (RRC) reconfiguration message including layer 1/layer2 triggered mobility (LTM) configuration information on an LTM candidate cell;
transmitting, to the base station, a first RRC reconfiguration complete message based on the RRC reconfiguration message;
receiving, from the base station, a cell switch command medium access control (MAC) control element (CE) for triggering a cell switch to the LTM candidate cell; and
transmitting, to the base station, a second RRC reconfiguration complete message after the cell switch to the LTM candidate cell.

2. The method of claim 1, wherein the RRC reconfiguration message is received via a signaling radio bearer 1 (SRB1) or a signaling radio bearer 3 (SRB3).

3. The method of claim 1, wherein the LTM configuration information includes a first LTM configuration associated with a master cell group (MCG) and a second LTM configuration associated with a secondary cell group (SCG).

4. The method of claim 1, wherein, in case that the RRC reconfiguration message is received via an SRB1 and the LTM configuration information includes a third LTM configuration associated with an SCG, the second RRC reconfiguration complete message is transmitted in an uplink information transfer multi radio dual connectivity (ULInformationTransferMRDC) message.

5. The method of claim 1, wherein, in case that the RRC reconfiguration message is received via an SRB3, the RRC reconfiguration message is not received in a downlink information transfer multi radio dual connectivity (DLInformationTransferMRDC) message, and the LTM configuration information includes a fourth LTM configuration associated with an SCG, the second RRC reconfiguration complete message is transmitted via the SRB3.

6. A method performed by a base station in a wireless communication system, the method comprising:
transmitting, to a terminal, a radio resource control (RRC) reconfiguration message including layer 1/layer2 triggered mobility (LTM) configuration information on an LTM candidate cell;
receiving, from the terminal, a first RRC reconfiguration complete message based on the RRC reconfiguration message;
transmitting, to the terminal, a cell switch command medium access control (MAC) control element (CE) for triggering a cell switch to the LTM candidate cell; and
receiving, from the terminal, a second RRC reconfiguration complete message after the cell switch to the LTM candidate cell.

7. The method of claim 6, wherein the RRC reconfiguration message is transmitted via a signaling radio bearer 1 (SRB1) or a signaling radio bearer 3 (SRB3).

8. The method of claim 6, wherein the LTM configuration information includes a first LTM configuration associated with a master cell group (MCG) and a second LTM configuration associated with a secondary cell group (SCG).

9. The method of claim 6, wherein, in case that the RRC reconfiguration message is transmitted via an SRB1 and the LTM configuration information includes a third LTM configuration associated with an SCG, the second RRC reconfiguration complete message is received in an uplink information transfer multi radio dual connectivity (ULInformationTransferMRDC) message.

10. The method of claim 6, wherein, in case that the RRC reconfiguration message is transmitted via an SRB3, the RRC reconfiguration message is not transmitted in a downlink information transfer multi radio dual connectivity (DLInformationTransferMRDC) message, and the LTM configuration information includes a fourth LTM configuration associated with an SCG, the second RRC reconfiguration complete message is received via the SRB3.

11. A terminal in a wireless communication system, the terminal comprising:
a transceiver; and
a controller coupled with the transceiver and configured to:
receive, from a base station, a radio resource control (RRC) reconfiguration message including layer 1/layer2 triggered mobility (LTM) configuration information on an LTM candidate cell,
transmit, to the base station, a first RRC reconfiguration complete message based on the RRC reconfiguration message,
receive, from the base station, a cell switch command medium access control (MAC) control element (CE) for triggering a cell switch to the LTM candidate cell, and
transmit, to the base station, a second RRC reconfiguration complete message after the cell switch to the LTM candidate cell.

12. The terminal of claim 11, wherein the RRC reconfiguration message is received via a signaling radio bearer 1 (SRB1) or a signaling radio bearer 3 (SRB3).

13. The terminal of claim 11, wherein the LTM configuration information includes a first LTM configuration associated with a master cell group (MCG) and a second LTM configuration associated with a secondary cell group (SCG).

14. The terminal of claim 11, wherein, in case that the RRC reconfiguration message is received via an SRB1 and the LTM configuration information includes a third LTM configuration associated with an SCG, the second RRC reconfiguration complete message is transmitted in an uplink information transfer multi radio dual connectivity (ULInformationTransferMRDC) message.

15. The terminal of claim 11, wherein, in case that the RRC reconfiguration message is received via an SRB3, the RRC reconfiguration message is not received in a downlink information transfer multi radio dual connectivity (DLInformationTransferMRDC) message, and the LTM configuration information includes a fourth LTM configuration associated with an SCG, the second RRC reconfiguration complete message is transmitted via the SRB3.

16. A base station in a wireless communication system, the base station comprising:
a transceiver; and
a controller coupled with the transceiver and configured to:
transmit, to a terminal, a radio resource control (RRC) reconfiguration message including layer 1/layer2 triggered mobility (LTM) configuration information on an LTM candidate cell,
receive, from the terminal, a first RRC reconfiguration complete message based on the RRC reconfiguration message,
transmit, to the terminal, a cell switch command medium access control (MAC) control element (CE) for triggering a cell switch to the LTM candidate cell, and
receive, from the terminal, a second RRC reconfiguration complete message after the cell switch to the LTM candidate cell.

17. The base station of claim 16, wherein the RRC reconfiguration message is transmitted via a signaling radio bearer 1 (SRB1) or a signaling radio bearer 3 (SRB3).

18. The base station of claim 16, wherein the LTM configuration information includes a first LTM configuration associated with a master cell group (MCG) and a second LTM configuration associated with a secondary cell group (SCG).

19. The base station of claim 16, wherein, in case that the RRC reconfiguration message is transmitted via an SRB1 and the LTM configuration information includes a third LTM configuration associated with an SCG, the second RRC reconfiguration complete message is received in an uplink information transfer multi radio dual connectivity (ULInformationTransferMRDC) message.

20. The base station of claim 16, wherein, in case that the RRC reconfiguration message is transmitted via an SRB3, the RRC reconfiguration message is not transmitted in a downlink information transfer multi radio dual connectivity (DLInformationTransferMRDC) message, and the LTM configuration information includes a fourth LTM configuration associated with an SCG, the second RRC reconfiguration complete message is received via the SRB3.
